(19) United States
(12) Patent Application Publication
(10) Pub. No.: US 2025/0376335 A1
(43) Pub. Date: Dec. 11, 2025

(54) SYSTEMS AND METHODS FOR CARRIER HANDLING

(71) Applicant: Savoye North America, Inc., Aurora, IL (US)

(72) Inventors: Ricardo Robles, Oak Lawn, IL (US); James D Froehlich, Standwood, MI (US)

(21) Appl. No.: 19/227,347

(22) Filed: Jun. 3, 2025

Related U.S. Application Data
(60) Provisional application No. 63/656,719, filed on Jun. 6, 2024.

(51) Int. Cl. B65G 43/08; B65G 1/137

(52) U.S. Cl. CPC B65G 43/08; B65G 1/1378; B65G 2203/042

(57) ABSTRACT

A method comprising method comprising receiving a first load disposed in a first carrier at a first position on a first conveyor, receiving a second load disposed in a second carrier at a second position on the first conveyor, receiving, from a sensor, sensor data indicative of a humidity level near the second position, determining, based on the sensor data, that a leak associated with the second load has occurred, responsive in part to determining that the leak has occurred, transferring the first load disposed in the first carrier to a staging area, and transporting, via a second conveyor, the second load away from the first conveyor while the second load remains disposed in the second carrier.

### CROSS-REFERENCE TO RELATED APPLICATION

This application claims the benefit of U.S. Provisional Patent Application No. 63/656,719, filed Jun. 6, 2024, the entire contents of which are incorporated by reference.

### FIELD

The present disclosure relates to material handling systems, and more specifically, to systems and methods for carrier handling.

### BACKGROUND

Automated storage and retrieval systems, or AS/RS systems, are adapted to control the storage, transport, and/or retrieval of products in environments such as, but not limited to, warehouses, distribution centers, and manufacturing facilities. As used herein, the term product can refer to any products, goods, and/or materials, whether packaged or unpackaged, that can be stored and/or retrieved via an AS/RS system. In that regard, an AS/RS system can be implemented in a variety of industries to store, transport, and/or retrieve products such as, without limitation, food and beverage products (e.g., canned beverages, bottled beverages, meats, etc.), pharmaceutical products, consumer products, manufacturing materials, and various other types of products.

An AS/RS system generally comprises a combination of software-controlled transport devices, such as but not limited to conveyors, lifts, and shuttles, that operate in coordination to store product in and/or retrieve product from one or more storage racks. In some conventional AS/RS systems, product is loaded into one or more carriers (e.g., bins, container, totes, pallets, etc.) before the product is transported for storage in a storage rack. Then, when the product is later retrieved from the storage rack, the product is unloaded from the one or more carriers before the product is shipped and/or processed further.

Typically, conventional AS/RS systems include one or more articulated robotic arms that can be controlled to load product into a carrier and/or unload product from a carrier. However, at least one drawback to using an articulated robotic arm to load product in a carrier and/or unload product from a carrier is that the precise movement of an articulated robotic needed to safely handle product during unloading and/or loading may require relatively large amounts of time. In that regard, the rate at which an AS/RS system that implements an articulated robotic arm can store and/or retrieve product is inefficient.

At least another drawback to using an articulated robotic arm to load product in and/or unload product from a carrier is that articulated robotic arms often comprise highly specialized designs that are tailored to the specific application in which the articulated robotic arms are being used. For example, the design of an articulated robotic arm installed in an AS/RS system that handles food and beverage products may be quite different than the design of an articulated robotic arm that is installed in an AS/RS system that handles construction materials. In that regard, articulate robotic arms are generally not well-equipped at handling products of various types, sizes, and/or weights, thereby limiting the functionality of the AS/RS system. Moreover, technicians that are trained to maintain and repair generalized components (e.g., motors, chains, conveyors, etc.) included in an AS/RS system often lack the expertise necessary to troubleshoot and fix a highly specialized articulated robotic arm. In that regard, the cost of training and/or hiring technicians with enough skill to maintain and repair an articulated robotic arm is often quite substantial.

Therefore, it would be beneficial to have an alternative system and method for carrier handling.

### SUMMARY

The present teachings directed to a carrier handling system (CHS) adapted to perform an inbound case-to-carrier process, an outbound carrier-to-case process, and one or more leak detection techniques. With the inbound case-to-carrier process, the CHS is adapted to receive product, or cases, from an inbound conveyor system, place the cases into respective carriers (e.g., a tray, a bin, a container, a tote, a pallet, etc.), and pass the containerized cases into storage. With the outbound carrier-to-case process, the CHS is adapted to receive containerized cases pulled from storage, remove the cases from the carriers, and release the cases to the outbound conveyor system. The empty carriers remaining after removal of the cases transfer onto the empty carrier stacking device, which is adapted to discharge the empty carriers onto a carrier staging conveyor for use with inbound cases. As described herein, the terms product(s) and case(s) may be used interchangeably.

Moreover, the CHS is adapted to detect and handle leaks during the inbound case-to-carrier process and/or the outbound carrier-to-case process. For instance, with the disclosed techniques, the CHS can detect when a case travelling in a carrier during the outbound carrier-to-case process is experiencing a leak (e.g., beverages and/other liquid products in a case are leaking liquid), and responsive to detecting a leak, can implement one or more control steps to remove the leaking case together with the corresponding carrier without disrupting the outbound carrier-to-case process for other cases leaving the CHS.

When compared to conventional AS/RS that implement articulated robotic arms to load product in carriers and/or unload product from carriers, the carrier handling system CHS described herein offers a variety of technical advantages. For example, at least one technical advantage of the disclosed CHS is that the CHS can achieve a higher throughput (e.g., faster rate with which cases and/or carriers can be handled) because the CHS does not require the use of robots that make complex articulated arm motions to maneuver cases and/or carriers. Moreover, because the CHS described herein does not implement robots that make complex end-of-arm tooling used in conventional AS/RS systems, the CHs described herein can handle cases and/or carriers of much larger and widely varying size and/or weight.

At least another technical advantage of the disclosed CHS is that the CHS described herein does not require a model specific, certified maintenance mechanic to maintain and troubleshoot. Rather, a typical industrial mechanic can service and support the equipment included in the CHS described herein, thereby reducing the costs and difficulty associated with maintaining and operating the CHS.

At least another technical advantage of the disclosed CHS is that the disclosed CHS is adapted to detect and handle leaks associated with cases of product being processed by the CHS. In that regard, damage to the CHS and/or other cases that may otherwise be caused by an undetected leak can be mitigated or even prevented.

In one independent aspect, a method comprising receiving a first load disposed in a first carrier at a first position on a first conveyor, receiving a second load disposed in a second carrier at a second position on the first conveyor, receiving, from a sensor, sensor data indicative of a humidity level near the second position, determining, based on the sensor data, that a leak associated with the second load has occurred, responsive in part to determining that the leak has occurred, transferring the first load disposed in the first carrier to a staging area, and transporting, via a second conveyor, the second load away from the first conveyor while the second load remains disposed in the second carrier.

In another independent aspect, a system comprising a first conveyor, a sensor disposed proximate the first conveyor and adapted to generate sensor data, a staging area, a second conveyor, and a controller in electronic communication with the first conveyor, the sensor, and the second conveyor. The controller is adapted to control operation of the system to move, via the first conveyor, a first load disposed in a first carrier to a first position on the first conveyor, move, via the first conveyor, a second load disposed in a second carrier to a second position on the first conveyor, receive, from the sensor, sensor data, determine, based on the sensor data, that a leak associated with the second load has occurred, responsive in part to determining that the leak has occurred, transfer, via the first conveyor, the first load disposed in the first carrier to a staging area, and transport, via a second conveyor, the second load away from the first conveyor while the second load remains disposed in the second carrier.

In another independent aspect, a controller including a non-transitory computer readable medium, a processor, and a computer executable instructions stored in the computer readable medium for controlling operation of a system to move, via a first conveyor, a first load disposed in a first carrier to a first position on the first conveyor, move, via the first conveyor, a second load disposed in a second carrier to a second position on the first conveyor, receive, from a sensor, sensor data indicative of a humidity level near the second position, determine, based on the sensor data, that a leak associated with the second load has occurred, responsive in part to determining that the leak has occurred, transfer, via the first conveyor, the first load disposed in the first carrier to a staging area, and transport, via a second conveyor, the second load away from the first conveyor while the second load remains disposed in the second carrier.

Other aspects will become apparent by consideration of the detailed description and accompanying drawings.

### BRIEF DESCRIPTION OF THE DRAWINGS

In the accompanying drawings, which form a part of the specification and are to be read in conjunction therewith in which like reference numerals are used to indicate like or similar parts in the various views:

FIG. 1 illustrates a perspective view of a carrier handling system (CHS), according to the present teachings.

FIG. 2 illustrates an example computing system that can be implemented in conjunction with the CHS of FIG. 1, according to the present teachings.

FIG. 3 is a block diagram of a warehouse execution system (WES) server that may be implemented in conjunction with the computing system of FIG. 2, according to the present teachings.

FIG. 4 is a block diagram of carrier handling system controller, according to the present teachings.

FIG. 5 is a first perspective view of an inbound system included in the CHS of FIG. 1, according to the present teachings.

FIG. 6 is a second perspective view of an inbound system included in the CHS of FIG. 1, according to the present teachings.

FIGS. 7A-7H illustrate an example case-to-carrier process, according to the present teachings.

FIGS. 8A-8H illustrate another example case-to-carrier process, according to the present teachings.

FIG. 9 is a flow diagram of method steps for an example case-to-carrier process, according to the present teachings.

FIG. 10 is a first perspective view of an outbound system included in the CHS of FIG. 1, according to the present teachings.

FIG. 11 is a second perspective view of an outbound system included in the CHS of FIG. 1, according to the present teachings.

FIGS. 12A-12H illustrate an example carrier-to-case process, according to the present teachings.

FIGS. 13A-13H illustrate another example carrier-to-case process, according to the present teachings.

FIG. 14 is a flow diagram of method steps for an example carrier-to-case process, according to the present teachings.

FIGS. 15A-15J illustrate an example leak detection process, according to the present teachings.

FIG. 16 is a flow diagram of method steps for an example leak detection process, according to the present teachings.

FIGS. 17A-17G illustrate another example leak detection process, according to the present teachings.

FIG. 18 is a flow diagram of method steps for another example leak detection process, according to the present teachings.

FIGS. 19A-19D illustrate another example leak detection process, according to the present teachings.

FIGS. 20A-20D illustrate another example leak detection process, according to the present teachings.

FIGS. 21A-21C illustrate various perspective views of a carrier transfer system, according to the present teachings.

FIG. 22 is a flow diagram of method steps for an example carrier transfer process, according to the present teachings.

FIGS. 23A-27B illustrate an example destacking process implemented by a destacking system, according to the present teachings.

FIG. 28 is a flow diagram of method steps for an example destacking process, according to the present teachings.

FIG. 29 illustrates an example vacuum system that can be implemented in conjunction with the CHS of FIG. 1, according to the present teachings.

FIG. 30 illustrates a profile view in which the vacuum system of FIG. 29 is implemented in conjunction with the CHS of FIG. 1, according to the present teachings.

FIG. 31 illustrates an example in which the vacuum system of FIG. 29 is expanded to operate in conjunction with four carrier handling systems, according to the present teachings.

FIG. 32 illustrates a profile view in which the vacuum system of FIG. 29 is expanded to operate in conjunction with four carrier handling systems, according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Moreover, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

To aid the Patent Office and any readers of a patent issued on this application in interpreting the claims appended hereto, it is noted that none of the appended claims or claim elements are intended to invoke 35 U.S.C. 112(f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

### Carrier Handling System

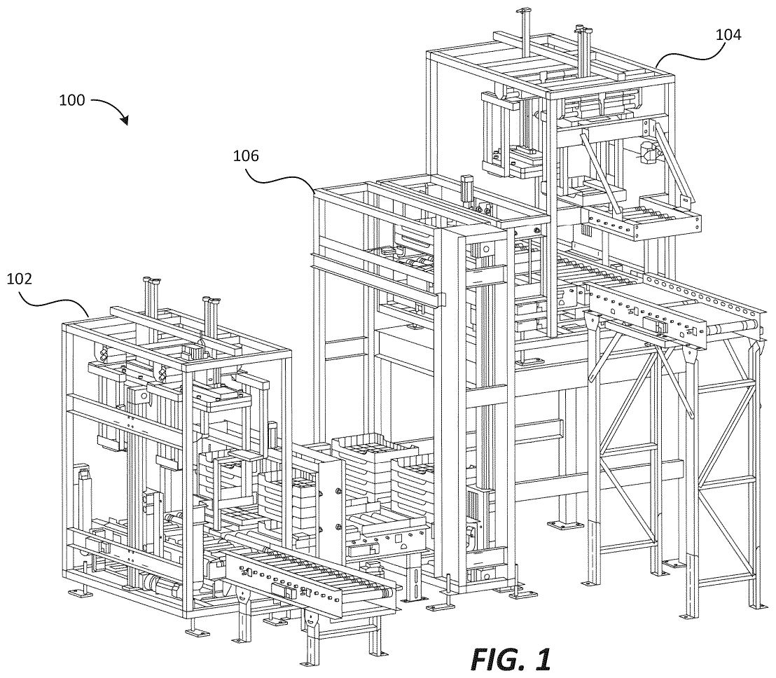

Referring now to FIG. 1, shown is a perspective view of a carrier handling system (CHS) 100, according to the present teachings. The CHS 100 includes an inbound system 102, an outbound system 104, and a carrier transfer system 106. As will be described in more detail herein, the inbound system 102 is adapted to implement one or more case-to-carrier processes in which the inbound system 102 receives cases (e.g., products) from an inbound conveyor system, inserts the cases into respective carriers, and transports the cases inserted in the carriers to storage. Conversely, the outbound system 104 is adapted to implement one or carrier-to-case processes in which the outbound system 104 receives cases inserted in respective carriers from storage, removes the cases from the respective carriers, and transports the removed cases for further handling via an outbound conveyor system.

In some examples, the inbound system 102 and/or the outbound system 104 are further adapted to implement one or more leak detection processes. For example, the inbound system 102 can include one or more leak sensors adapted to detect whether a case is leaking a liquid (e.g., beverage, chemical, etc.) prior to inserting the case into a carrier. Responsive to detecting a leak associated with a case, the inbound system 102 can then perform one or more responsive actions such as, but not limited to, activating one or more alarms. Similarly, the outbound system 104 can include one or more leak sensors adapted to detect whether liquid is leaking from a case inserted in a carrier (e.g., beverage, chemical, etc.) prior to removing the case from the carrier. Responsive to detecting a leak associated with a case, the outbound system 104 can then perform one or more responsive actions that will be described in more detail herein.

Moreover, as will be described in more detail herein, the carrier transfer system 106 is adapted to transfer carriers from the outbound system 104 to the inbound system 102 for reuse. For example, after removing a case from a carrier, the outbound system 104 can provide the empty carrier to the carrier transfer system 106. The carrier transfer system 106 can then stack the received carrier with other emptied carriers received from the outbound system 104 and transfer the stack of empty carriers to the inbound system 102. The inbound system 102 can use the stack of empty carriers to insert cases into carriers via one or more case-to-carrier processes described herein.

In the illustrated example of FIG. 1, the outbound system 104 is disposed at a raised, or higher, elevation relative to the inbound system 102. Notably, this elevation difference in elevation between the in inbound and outbound systems 102, 104 helps to facilitate the recycling of empty carriers by the carrier transfer system 106. In some examples, the inbound system 102 is disposed at a higher elevation than the outbound system 104. In other examples, the inbound system 102 and the outbound system 104 can be disposed at the same elevation.

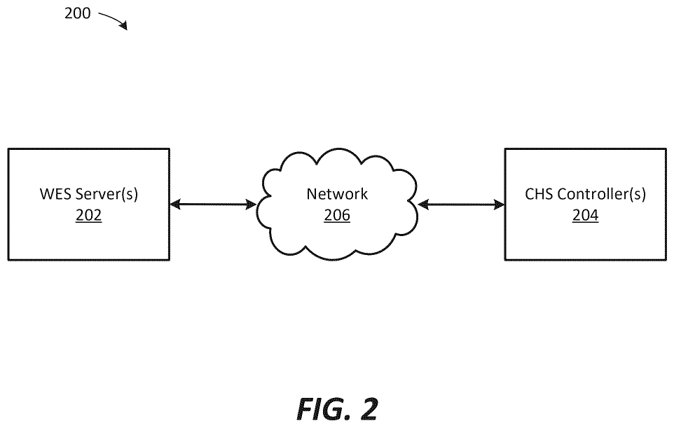

FIG. 2 illustrates an example computing system 200 that can be implemented in conjunction with the CHS 100 of FIG. 1, according to the present teachings. The computing system 200 is adapted to, for example, control operation of the CHS 100. As described herein, controlling operation of the CHS 100 can include controlling operation of the inbound system 102, controlling operation of the outbound system 104, controlling operation of the carrier transfer system 106, and/or controlling operation of a vacuum system that can be implemented in conjunction with the CHS 100.

As shown, the computing system 200 includes one or more warehouse execution system (WES) servers 202 that are connected to one or more CHS controllers 204 via network 206. The network 206 can be, for example, a combination of one or more of a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.), a local area network (LAN), a neighborhood area network (NAN), a home area network (HAN), and/or a personal area network (PAN) employing any of a variety of communications protocols, such as Wi-Fi, Bluetooth, ZigBee, etc. In some examples, one or more other types of networks can be used to implement the network 206.

In the following description, the one or more WES servers 202 may simply be referred to as the WES server 202. Likewise, in the following description, the one or more CHS controllers 204 may simply be referred to as the CHS controller 204. In some examples, the WES server 202 and the CHS controller 204 can be implemented using and/or integrated within one or more computing devices. In some examples, functionality described herein with respect to the WES server 202 can also be performed by the CHS controller 204. Likewise, in some examples, functionality described herein as being performed by the CHS controller 204 can also be performed by the WES server 202. In that regard, in some examples, the WES server 202 can be adapted to perform one or more of the functions described herein as being performed by the CHS controller 204. Moreover, in some examples, the CHS controller 204 can be adapted to perform one or more of the functions described herein as being performed by the WES server 202.

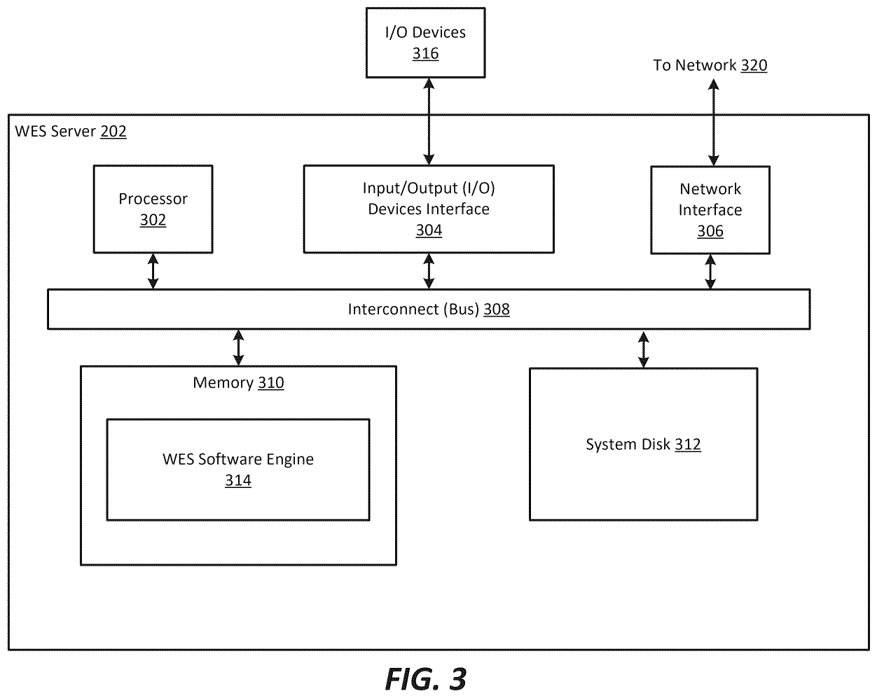

FIG. 3 is a block diagram of a WES server 202 that may be implemented in conjunction with the computing system 200, according to the present teachings. The WES server 202 can be implemented using one or more of a local server, a remote server, a cloud server, a cloud-based computing system, and/or any other suitable computing device. As shown in FIG. 3, the WES server 202 includes, without limitation, a processor 302, an input/output (I/O) devices interface 304, a network interface 306, an interconnect 308, a system memory 310, and a system disk 312. The interconnect, or bus, 308 can include one or more wires, cables, traces, contacts, analog components, digital components, wireless connection components, and/or other suitable means for interconnecting hardware components of the WES server 202.

The processor 302 is adapted to retrieve and execute programming instructions, such as the WES software engine 314. Similarly, the processor 302 is adapted to store application data (e.g., software libraries) in and retrieve application data from the system memory 310. The interconnect 308 is adapted to facilitate transmission of data, such as programming instructions and application data, between the processor 302, the I/O devices interface 304, the network interface 306, the system memory 310, and the system disk 312. The I/O devices interface 304 is adapted to receive input data from I/O devices 316 and transmit the input data to the processor 302 via the interconnect 308. For example, I/O devices 316 may include one or more buttons, a keyboard, a mouse, one or more automation devices, and/or other input devices. The I/O devices interface 304 is further adapted to receive output data from the processor 302 via the interconnect 308 and transmit the output data to the I/O devices 316.

The system disk 312 may include one or more hard disk drives, solid state storage devices, or similar storage devices. The system disk 312 is adapted to store non-volatile data such as files (e.g., audio files, video files, subtitles, application files, software libraries, etc.). For example, the system disk 312 is adapted to store one or more software components for controlling operation of automation devices (e.g., shuttles, cranes, etc.) and/or automation systems (e.g., the CHS 100).

As shown, the system memory 310 includes the WES software engine 314. The WES software engine 314, which may be implemented as one or more of an operating system, application software, firmware, database software, etc., comprises the core logic and functionality of a warehouse execution system. In that regard, the processor 302 executes the WES software engine 314 to receive requests (e.g., orders received from business logic, requests received from remote computing devices, etc.) and fulfill the received requests by controlling one or more pieces of automation equipment (e.g., the CHS 100, shuttles, cranes, etc.). In some examples, the WES software engine 314 controls and/or coordinates operation of one or more of the inbound case-to-carrier processes, outbound carrier-to-case processes, and/or vacuum cycling operations described herein. In some examples, the WES software engine 314 communicates with the CHS controller 204 to control and/or monitor operation of one or more of the inbound system 102, the outbound system 104, and/or the carrier transfer system 106. In some examples, the WES software engine 314 can perform one or more of the functions described herein with respect to the CHS controller 204. In some examples, the WES software engine 314 can be stored on and/or executed by the CHS controller 204.

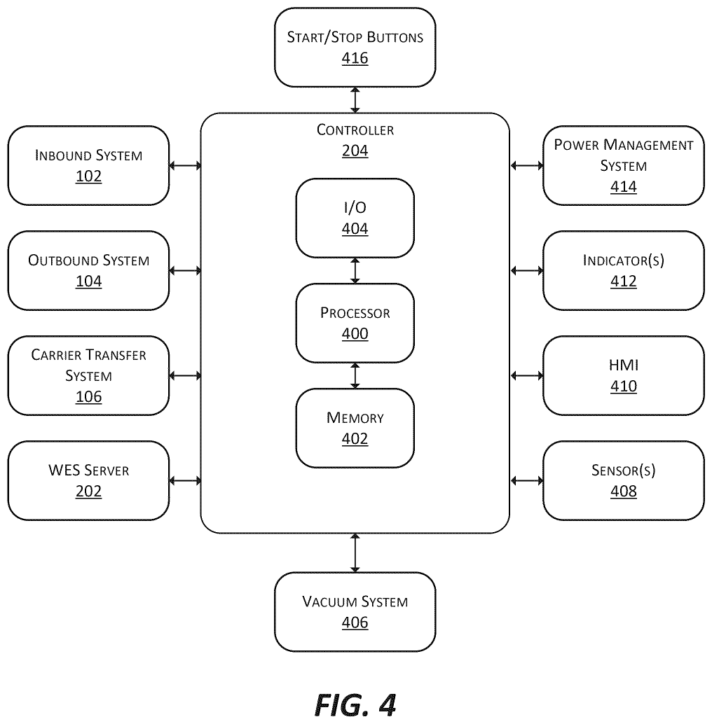

FIG. 4 is a block diagram of the CHS controller 204, according to various embodiments. As will be described in more detail herein the CHS controller 204 is adapted to control operation of the CHS 100. In that regard, the CHS controller 204 can control operation of the inbound system 102, the outbound system 104, the carrier transfer system 106, and/or a vacuum system implemented in conjunction with the CHS 100. In some examples, the CHS controller 204 can control operation of the CHS 100 independent of the WES server 202. In other examples, the CHS controller 204 can control operation of the CHS 100 in coordination with the WES server 202 and/or responsive to control instructions received from the WES server 202. Hereinafter, the CHS controller 204 can simply be referred to as the controller 204.

As shown, the controller 204 includes a processor 400 (e.g., a microprocessor, a microcontroller, or another suitable programmable device), a memory 402, and an input/output (“I/O”) system 404 that are interconnected by a bus. In some examples, the controller 204 is implemented using a programmable logic controller (PLC), a PLC cabinet, and/or some other type of industrial control device and/or computing device. In some examples, the controller 204 is implemented using a desktop computer, a laptop computer, a tablet, a smartphone, a wearable computing device, and/or any other suitable computing device.

The I/O system 404 includes routines for transferring information between components within the controller 204 and components of the CHS 100. In some examples, the I/O system 404 also includes routines for transferring information between components within the controller 204 and components within the computing system 200 (e.g., the WES server 202). In some examples, the I/O system 404 further includes a communication interface and/or a network interface that is configured to provide communication between the CHS 100 and the WES server 202, one or more automation devices (e.g., shuttles, cranes, conveyors, etc.) controlled by and/or operated in accordance with the WES server 202, and/or one or more other external communication devices (e.g., a smart phone, a tablet, a laptop, etc.). In some examples, the controller 204 can communicate with one or more devices over the network 206. In some examples, the controller 204 can communicate with one or more devices via one or more local wireless and/or wired connections. In some examples, the I/O system 404 includes one or more Ethernet drops.

The memory 402 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The memory 402 stores software, such as but not limited to firmware, one or more applications, program data, one or more program modules, and/or other executable instructions, for controlling operation of one or more components and systems of the CHS 100. In some examples, the memory 402 can store the WES software engine 314. In some examples, the memory 402 stores one or more leak detection thresholds that can be used by the processor 400 to execute one or more leak detection process and methods described herein.

In operation, the processor 400 retrieves from the memory 402 and executes software instructions for controlling operation of one or more components and systems of the CHS 100. For example, in operation, the processor 400 retrieves from memory 402 and executes, among other things, software instructions associated with the inbound case-to-carrier processes, the outbound carrier-to-case processes, the leak detection processes, the carrier stacking and/or transferring processes, the vacuum system control processes, and/or other processes and methods described herein. Hereinafter, functions and/or actions performed by components of the controller 204 (e.g., processor 400, memory 402, and I/O system 404) can collectively be referred to as being performed by the controller 204.

Referring back to FIG. 4, the controller 204 is coupled to and adapted to control various components and/or systems of the CHS 100. For example, the controller 204 is coupled to (e.g., in electronic communication with) the inbound system 102, the outbound system 104, and the carrier transfer system 106.

With respect to the inbound system 102, the controller 204 is coupled to and adapted to control one or more of the components included in the inbound system 102 for implementing a case-to-carrier process. In that regard, the controller 204 is in electronic communication with components included in the inbound system 102, such as but not limited case grip assemblies, conveyors, lifts, motors, drives, actuators, servos, encoders, sensors (e.g., leak sensors, photoeyes, etc.), pneumatic actuators, and/or other devices, that can be used to insert cases into carriers and transport the cases inserted in the carriers for storage.

With respect to the outbound system 104, the controller 204 is coupled to and adapted to control one or more of the components included in the outbound system 104 for implementing a carrier-to-case process. In that regard, the controller 204 is in electronic communication with components included in the outbound system 104, such as but not limited to case grip assemblies, conveyors, lifts, motors, drives, actuators, servos, encoders, sensors (e.g., leak sensors, photoeyes, etc.), pneumatic actuators, and/or other devices, that can be used to remove cases from carriers and transport the cases for further handling.

With respect to the carrier transfer system 106, the controller 204 is coupled to and adapted to control one or more of the components included in the carrier transfer system 106 for transferring empty carriers from the outbound system 104 to the inbound system 102 for reuse. In that regard, the controller 204 is in electronic communication with components included in the carrier transfer system 106, such as blade stops, swing arms, conveyors, lifts, motors, drives, actuators, servos, encoders, sensors, pneumatic actuators, and/or other devices, that can be used to transfer empty carriers from the outbound system 104 to the inbound system 102.

As further shown in FIG. 4, the controller 204 is coupled to and adapted to control a vacuum system 406. For example, the controller 204 is coupled to, or in electronic communication with, one or more pumps, motors, sensors, and/or other components that can be used to control operation of the vacuum system 406. As will be described in more detail herein, the vacuum system 406 can be integrated within and/or operated in coordination with the CHS 100 to perform an inbound case-to-carrier process and/or an outbound carrier-to-case process. In some examples, the vacuum system 406 is included in the CHS 100. In other examples, the vacuum system 406 is separate from the CHS 100.

As further shown in FIG. 4, the controller 204 is coupled to a plurality of sensors 408. The plurality of sensors 408 can include leak sensors used for detecting leaks in and/or associated with cases, photoeye sensors used for detecting positional information associated with cases, carriers, and/or components of the CHS 100, voltage sensors, torque sensors, temperature sensors, contact sensors, magnetic sensors, and/or one or more other types of sensors. During operation of the CHS 100, the controller 204 receives data from the plurality of sensors 408 and can control one or more components of the CHS 100 based on the received data. In some examples, the controller 204 can detect one or more fault conditions based on the received sensor data. For example, the controller 204 can detect one or more of a motor starter fault (e.g., the starter is not responding to instructions/communications from the controller 204), a motor disconnect fault, a motor overload fault (e.g., tripped thermal or magnetic setpoint), a variable frequency drive (VFD) fault, a servo fault, a low air pressure fault, an encoder fault, a moisture fault (e.g., detected leak), a clamp not closed fault, a conveyor lift over travel fault, a conveyor lift position lost fault, a missing carrier fault (e.g., no carriers available for case-to-carrier process), an infeed conveyor system fault, a jam fault, and/or one or more other types of faults.

As further shown in FIG. 4, the controller 204 includes and/or is coupled to a user-interface, or human machine interface (HMI), 410, one or more indicators 412, a power management system 414, and/or one or more start/stop buttons 416.

The HMI 410 provides a user-interface through which a user can interact with the controller 204 and/or one or more components of the CHS 100. The HMI 410 is adapted to receive input from an operator of the CHS 100 and/or output information to the operator of the CHS 100. In some examples, the HMI 410 includes a display (e.g., a primary display, a secondary display, etc.) and/or input devices (e.g., touchscreen displays, a plurality of knobs, dials, switches, buttons, levers, joysticks, etc.). The display may be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In some examples, the HMI 410 includes one or more audio indicators (e.g., speakers, horns, buzzers, etc.) and/or visual indicators such as LEDs. In some examples, the HMI 410 can be used to display status information associated with the CHS 100, control one or more components of the CHS 100, and/or indicate the occurrence of one or more of the above-described faults to a user.

The one or more indicators 412 can include, for example, a stack light, one or more other types of lights, one or more alarms, and/or one or more speakers. The controller 412 can activate one or more of the indicators 412 to indicate the occurrence of a fault, to indicate a status (e.g., running, stopped, faulted, etc.) of the CHS 100, to indicate an emergency stop has occurred, and/or other information associated with the CHS 100.

The power management system 414 can include one or more alternating current (AC) power supplies, one or more direct current (DC) power supplies, one or more inverters, one or more rectifiers, one or more transformers, power switching equipment, and/or one or more other power devices. In some examples, the power management system 414 includes one or more 20 A, 120V AC power supplies, one or more 24V DC power supplies, one or more 480V AC power supplies, and/or one or more other types of power supplies. In some examples, the power management system 424 includes a 100 A, 480V AC power drop.

The one or more start/stop buttons 416 can include buttons for starting and/or stopping the CHS 100. For example, the one or more start/stop buttons 416 can include a green start pushbutton, a red stop pushbutton, a pushbutton for requesting access to the CHS 100, and/or one or more emergency stop pushbuttons.

### Inbound System

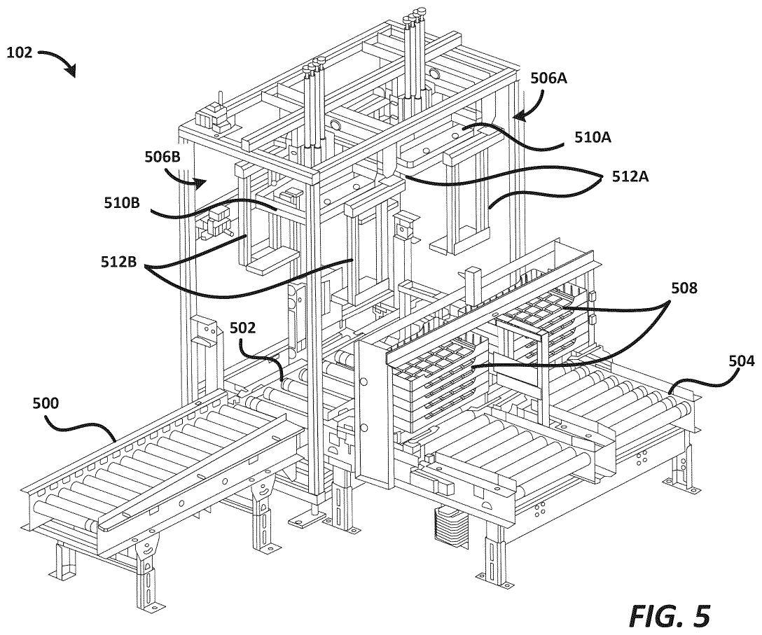

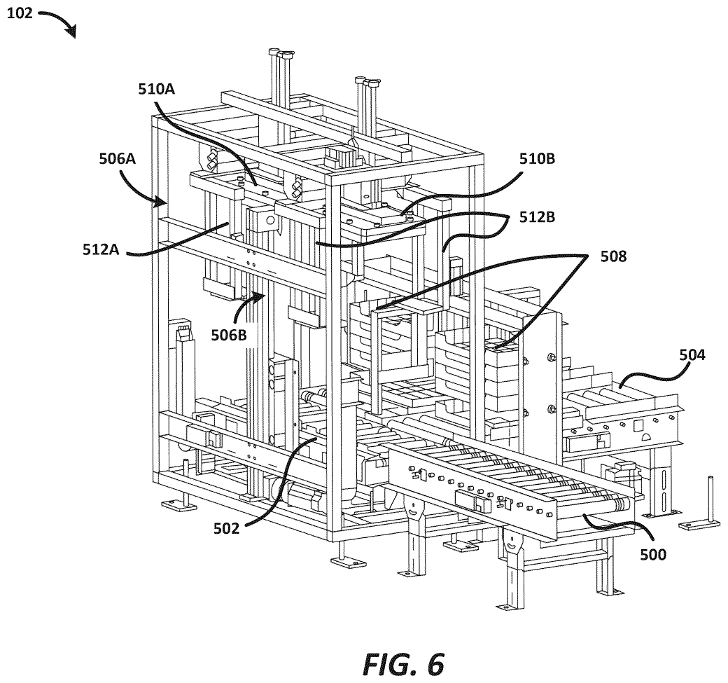

FIGS. 5 and 6 illustrate first and second perspective views of the inbound system 102 included in the CHS 100, according to the present teachings. As described herein, the inbound system 102 is adapted to perform one or more case-to-carrier processes in which cases of product are inserted into carriers and transported away to storage. As shown in FIGS. 5 and 6, the inbound system 102 includes an inbound conveyor 500, a lift conveyor 502, a carrier infeed conveyor 504, a first grip assembly 506A, and a second grip assembly 506B.

As will be described in more detail herein, the inbound conveyor 500 is adapted to transport cases onto the lift conveyor 502. In some examples, the lift conveyor 502 is adapted to be raised and lowered (e.g., via one or more motors, actuators, etc.). In such examples, the lift conveyor 502 can be lowered to receive cases from the inbound conveyor 500, raised to bring the cases up to the grip assemblies 506A, 506B, lowered to receive empty carriers 508 from the carrier infeed conveyor 504, and/or raised to bring empty carriers 508 up towards cases engaged with the grip assemblies 506A, 506B. In some examples, the lift conveyor 502 cannot raise and lower. The lift conveyor 502 is further adapted to convey, or transport, cases away to storage once the cases have been inserted into carriers 508. The carrier infeed conveyor 504 is adapted to convey, or transfer, empty carriers 508 onto the lift conveyor 502.

The first grip assembly 506A is adapted to engage and grip a case positioned on the lift conveyor 502, hold the case above the lift conveyor 502, and insert the case into an empty carrier 508 positioned on the lift conveyor 502. In the illustrated example of FIGS. 5 and 6, the first grip assembly 506A is shown to include a vacuum pad 510A and clamps 512A. The vacuum pad 510A is adapted to provide a suction force to the top of the case and the clamps 512A are adapted to apply a gripping force to the sides and/or the bottom of the case. In some examples, the first grip assembly 506A can be lowered towards the lift conveyor 502 to grip a case and raised back above the lift conveyor 502 to hold the case above the lift conveyor 502. In other examples, the first grip assembly 506A remains at a fixed height above the lift conveyor 502.

In some examples, the first grip assembly 506A does not include the vacuum pad 510A and instead only includes the clamps 512A. In some examples, the first grip assembly 506A does not include the clamps 512A and instead only includes the vacuum pad 510A. In some examples, the first grip assembly 506A can include one or more other types of gripping devices in lieu of and/or in addition to the vacuum pad 510A and/or the clamps 512A. In such examples, the one or more other types of gripping devices can be adapted to grip and hold a case above the lift conveyor 502 in conjunction with and/or in lieu of the vacuum pad 510A and the clamps 512A. The one or more other types of gripping devices can include, for example, one or more additional clamps, one or more belts, one or more robotic arms, one or more suction devices, one or more magnets, and/or one or more other types of gripping devices.

Similarly, the second grip assembly 506B is adapted to engage and grip a case positioned on the lift conveyor, hold the case above the lift conveyor 502, and insert the case into an empty carrier 508 positioned the lift conveyor 502. In the illustrated example of FIGS. 5 and 6, the second grip assembly 506B is shown to include a vacuum pad 510B and clamps 512B. The vacuum pad 510B is adapted to provide a suction force to the top of the case and the clamps 512B are adapted to apply a gripping force to the sides and/or the bottom of the case. In some examples, the second grip assembly 506B can be lowered towards the lift conveyor 502 to grip a case and raised back above the lift conveyor 502 to hold the case above the lift conveyor 502. In other examples, the second grip assembly 506B remains at a fixed height above the lift conveyor 502.

In some examples, the second grip assembly 506B does not include the vacuum pad 510B and instead only includes the clamps 512B. In some examples, the second grip assembly 506B does not include the clamps 512B and instead only includes the vacuum pad 510B. In some examples, the second grip assembly 506B can include one or more other types of gripping devices in lieu of and/or in addition to the vacuum pad 510B and/or the clamps 512B. In such examples, the one or more other types of gripping devices can be adapted to grip and hold a case above the lift conveyor 502 in conjunction with and/or in lieu of the vacuum pad 510B and the clamps 512B. The one or more other types of gripping devices can include, for example, one or more additional clamps, one or more belts, one or more robotic arms, one or more suction devices, one or more magnets, and/or one or more other types of gripping devices.

Although two grip assemblies 506A, 506B are shown to be included in the inbound system 102 in the illustrated examples of FIGS. 5 and 6, persons skilled in the art should understand that in other examples, more or less than two grip assemblies 506 can be included in the inbound system 102. For example, the inbound system 102 may only include a single grip assembly 506 or can include three, four, five, six, or more grip assemblies 506. Furthermore, although not shown, in some examples, the inbound system 102 can also include one or more leak sensors adapted to detect the occurrence of a leak associated with a case. In such examples, the controller 204 can activate one or more indicators 412 in response to determining, based on sensor data generated by the one or more leak sensors, that a leak associated with a case has occurred.

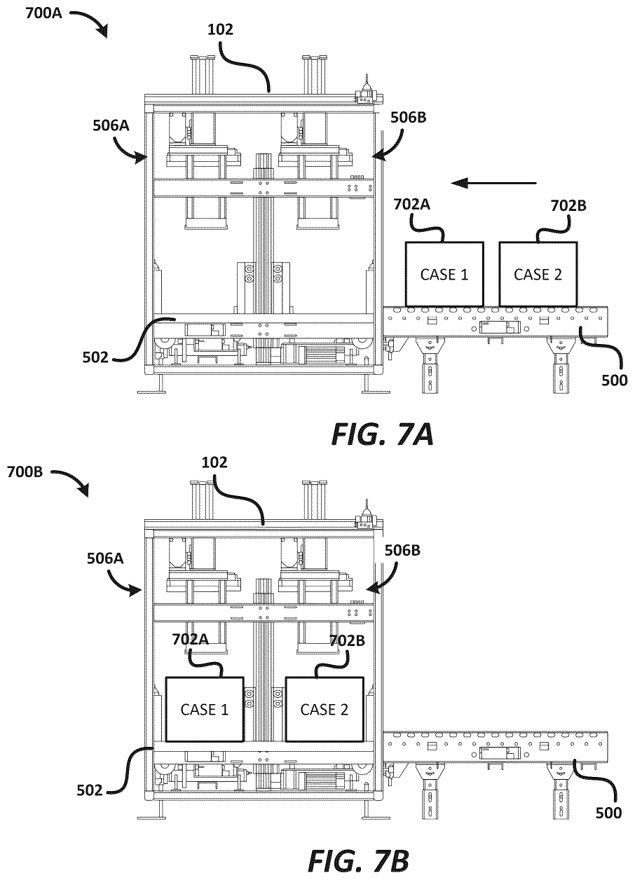

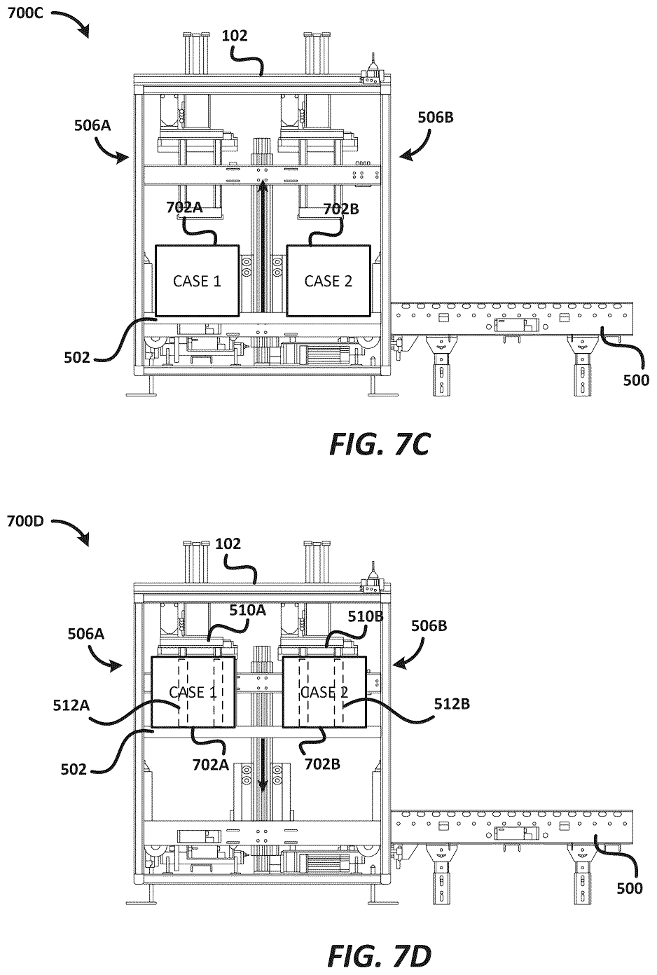

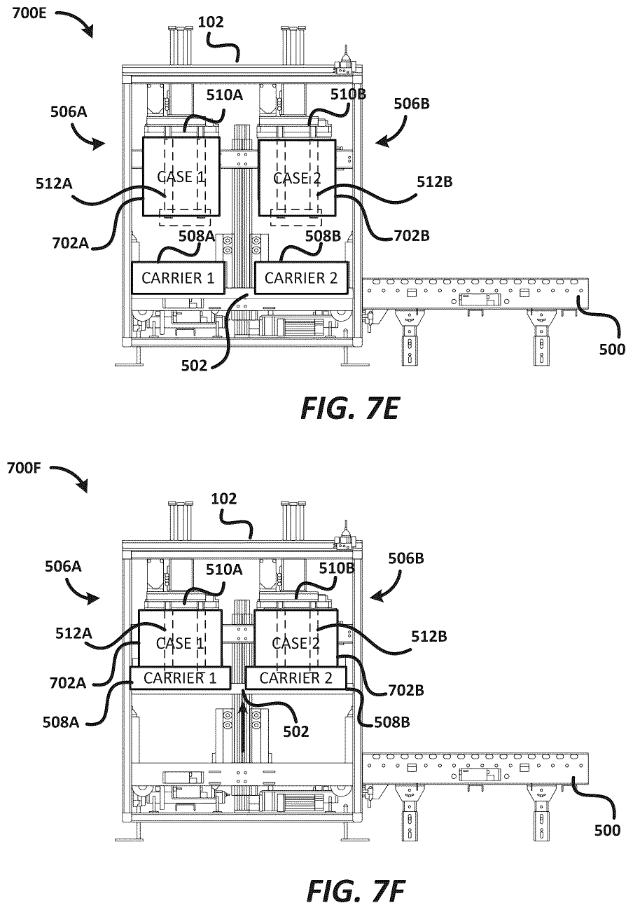

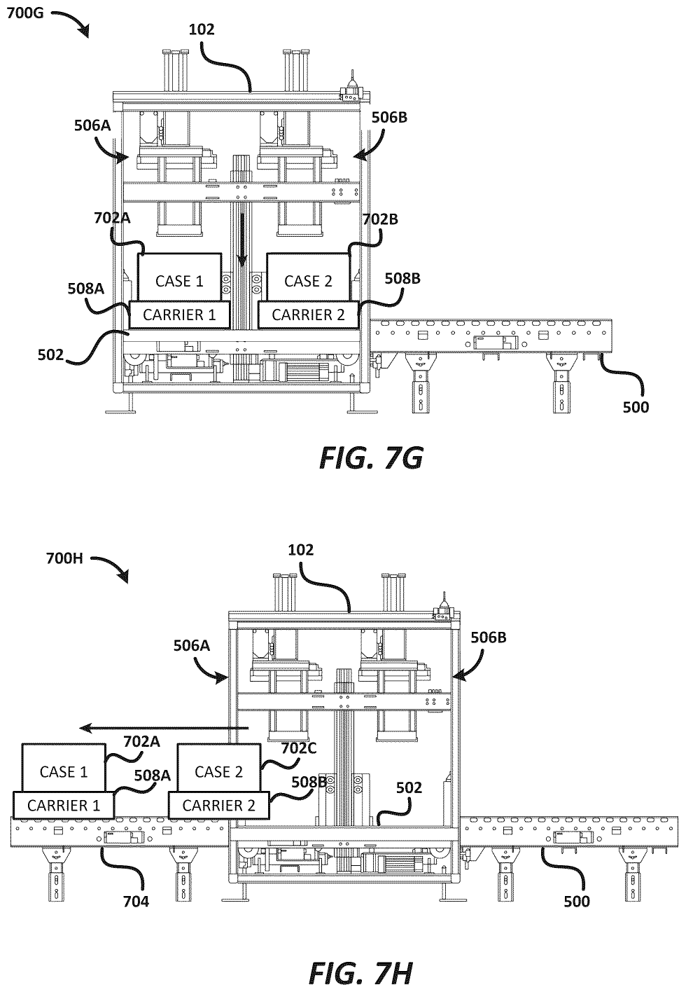

FIGS. 7A-7H illustrate an example case-to-carrier process 700, according to the present teachings. Although the steps in process 700 are described in conjunction with the inbound system 102 and/or other systems of FIGS. 1-7H, persons skilled in the art will understand that any system configured to perform the method steps, in any order, is within the scope of the present disclosure. For example, although the process 700 is described and illustrated as using the first and second grip assemblies 506A, 506B, which include vacuum pads 510A, 510B and clamps 512A, 512B respectively, in other examples, process 700 can be implemented using other types of grip assemblies that do not include vacuum pads, do not include clamps, and/or include one or more other types of gripping devices adapted to grip and hold a case.

As shown in FIG. 7A, the process 700 begins with step 700A at which first and second cases 702A, 702B are transported along the inbound conveyor 500 towards the lift conveyor 502. In some examples, the controller 204 controls the inbound conveyor 500 to convey the first and second cases 702A, 702B towards the lift conveyor 502. As shown in FIG. 7A, the first and second cases 702A, 702B are not inserted into any carriers (e.g., carriers 508) when the process 700 begins.

As shown in FIG. 7B, the process 700 proceeds to step 700B, where the lift conveyor 502 receives the first and second cases 702A, 702B from the inbound conveyor 500. At the completion of step 700B, the first case 702A is disposed on the lift conveyor 502 at a first position underneath the first grip assembly 506A and the second case 702B is disposed on the lift conveyor 502 at a second position underneath the second grip assembly 506B. In some examples, the controller 204 controls the inbound conveyor 500 to convey the first and second cases 702A, 702B onto the lift conveyor 502. In some examples, the controller 204 further controls the lift conveyor 502 to position the first and second cases 702A, 702B underneath the first and second grip assemblies 506A, 506B. In some examples, the controller 204 can control one or more blade stops to raise through rollers in the lift conveyor 502 when positioning the first and second cases 702A, 702B underneath the first and second grip assemblies 506A, 506B

As shown in FIG. 7C, the process 700 proceeds to step 700C, where the lift conveyor 502 raises the first and second cases 702A, 702B upwards towards the first and second grip assemblies 506A, 506B. In the illustrated example of FIG. 7C, the upward movement of the lift conveyor 502 and first and second cases 702A, 702B is indicated by an upward facing arrow. In some examples, the controller 204 controls one or more motors, actuators, and/or other components in the inbound system 102 to raise the lift conveyor 502.

As shown in FIG. 7D, the process 700 proceeds to step 700D, where while the lift conveyor 502 is in an elevated position, the first grip assembly 506A engages and grips the first case 702A and the second grip assembly 506B engages and grips the second case 702B. In the illustrated example of FIG. 7D, the vacuum pad 510A and the clamps 512A engage and grip the first case 702A, and the vacuum pad 510B and the clamps 512B engage and grip the second case 702B. In some examples, the controller 204 controls the first and second grip assemblies 506A, 506B to engage and grip the first and second cases 702A, 702B respectively (e.g., controls the vacuum pads 510A, 510B to apply suction force and/or the clamps 512A, 512B to apply a gripping force). As indicated by the downward facing arrow in FIG. 7D, also at step 700D, the lift conveyor 502 travels to a lowered position after the first and second grip assemblies 506A, 506B have engaged and gripped the first and second cases 702A, 702B. For example, the controller 204 controls one or more motors, actuators, and/or other components in the inbound system 102 to lower the lift conveyor 502.

As shown in FIG. 7E, the process 700 proceeds to step 700E, where the first and second grip assemblies 506A, 506B hold the first and second cases 702A, 702B above the lift conveyor 502. As further shown in FIG. 7E, at step 700E, the lift conveyor 502 receives first and second carriers 508A, 508B from the carrier infeed conveyor 504. For example, the controller 204 controls the carrier infeed conveyor 504 and/or the carrier transfer system 106 to transfer the first and second carriers 508A, 508B onto the lift conveyor 502. At the completion of step 700E, the first carrier 508A is positioned on the lift conveyor 502 underneath the first case 702A and the second carrier 508B is positioned on the lift conveyor 502 underneath the second case 702B. In some examples, the controller 204 can control one or more blade stops to raise through rollers in the lift conveyor 502 and help position the first carrier 508A underneath the first case 702A and/or the second carrier 508B underneath the second case 702A.

As shown in FIG. 7F, the process 700 proceeds to step 700F, where the lift conveyor 502 raises the first and second carriers 508A, 508B upwards towards the first and second cases 702A, 702B. In the illustrated example of FIG. 7F, the upward movement of the lift conveyor 502 and first and second carriers 508A, 508B is indicated by an upward facing arrow. In some examples, the controller 204 controls one or more motors, actuators, and/or other components in the inbound system 102 to raise the lift conveyor 502. At the completion of step 700F, while the lift conveyor 502 is in an elevated position, the first carrier 508A is positioned underneath and/or surrounds the first case 702A and the second carrier 508B is positioned underneath and/or surrounds the second case 702B.

As shown in FIG. 7G, the process 700 proceeds to step 700G, where the grip assemblies 506A, 506B disengage, or release, the first and second cases 702A, 702B into the first and second carriers 508A, 508B respectively. For example, the controller 204 controls the first and second grip assemblies 506A, 506B to release the first and second cases 702A, 702B (e.g., shut off the vacuum pads 510A, 510B and/or control the clamps 512A, 512B to release the first and second cases 702A, 702B). In that regard, by releasing the first case 702A into the first carrier 508A, the first case 702A is inserted into the first carrier 508A. Similarly, by releasing the second case 702B into the second carrier 508B, the second case 702B is inserted into the second carrier 508B.

As further shown in FIG. 7G, at step 700G, the lift conveyor 502 lowers first case 702A inserted in the first carrier 508A and the second case 702B inserted in the second carrier 508B back to the lowered position after the first and second grip assemblies 506A, 506B release the first and second cases 702A, 702B. For example, the controller 204 controls one or more motors, actuators, and/or other components in the inbound system 102 to lower the lift conveyor 502.

As shown in FIG. 7H, the process 700 proceeds to step 700H where the first case 702A inserted in the first carrier 508A and the second case 702B inserted in the second carrier 508B are transported away to storage. In the illustrated example of FIG. 7H, the lift conveyor 502 and an outbound conveyor 704 convey the first case 702A inserted in the first carrier 508A and the second case 702B inserted in the second carrier 508B away to storage. In some examples, the controller 204 controls the lift conveyor 502 and/or the outbound conveyor 704 to convey the first case 702A inserted in the first carrier 508A and the second case 702B inserted in the second carrier 508B away to storage.

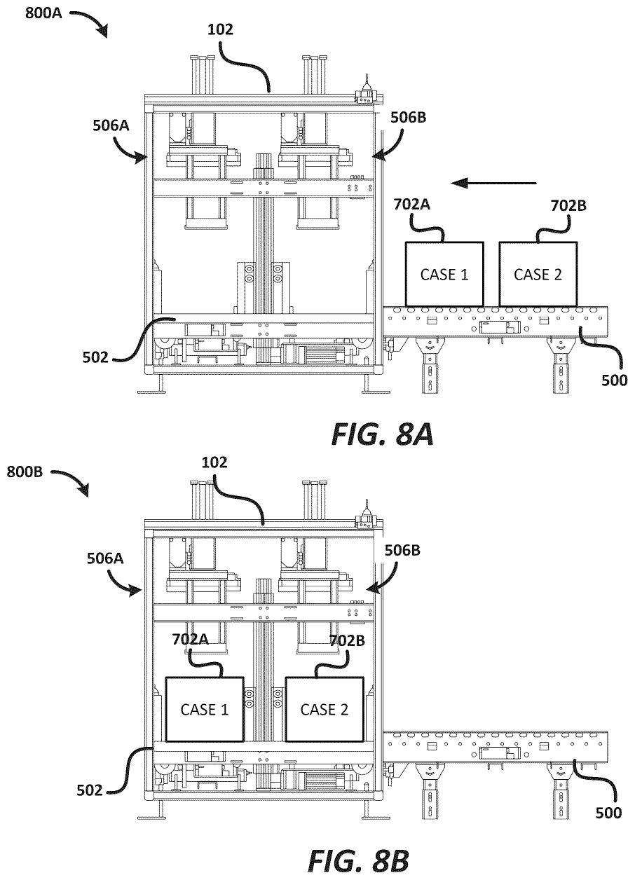

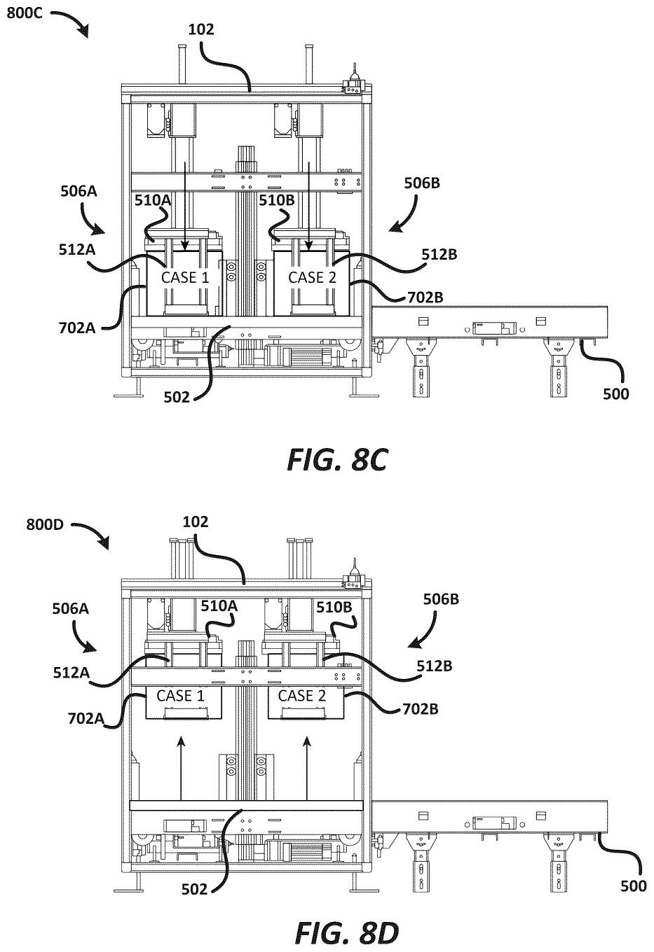

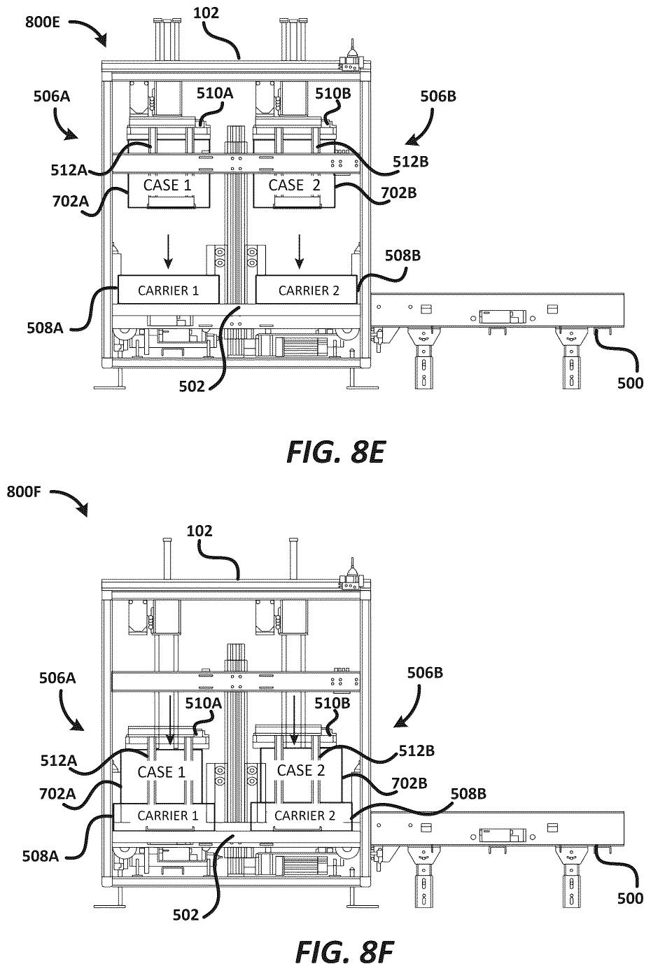

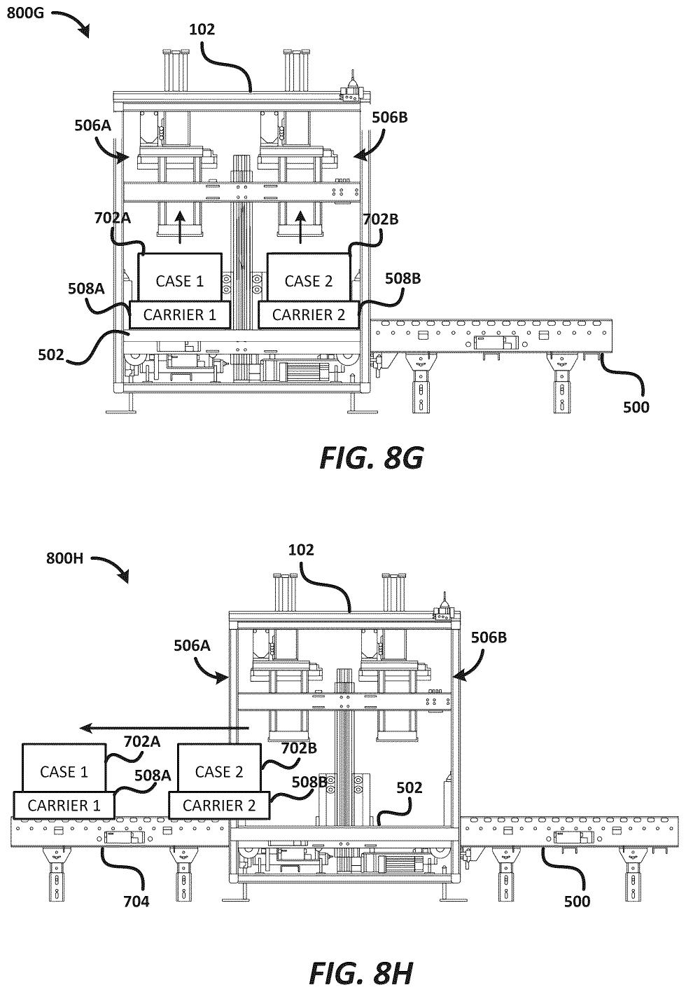

FIGS. 8A-8H illustrate another example case-to-carrier process 800, according to the present teachings. Although the steps in process 800 are described in conjunction with the inbound system 102 and/or other systems of FIGS. 1-8H, persons skilled in the art will understand that any system configured to perform the method steps, in any order, is within the scope of the present disclosure. For example, although the process 800 is described and illustrated as using the first and second grip assemblies 506A, 506B, which include vacuum pads 510A, 510B and clamps 512A, 512B respectively, in other examples, process 800 can be implemented using other types of grip assemblies that do not include vacuum pads, do not include clamps, and/or include one or more other types of gripping devices adapted to grip and hold a case.

As shown in FIG. 8A, the process 800 begins with step 800A at which first and second cases 702A, 702B are transported along the inbound conveyor 500. As shown, the first and second cases 702A, 702B are not inserted into any carriers (e.g., carriers 508) at the start of process 800.

As shown in FIG. 8B, the process 800 proceeds to step 800B, where the lift conveyor 502 receives the first and second cases 702A, 702B from the inbound conveyor 500. At the completion of step 800B, the first case 702A is disposed at a first position on the lift conveyor 502 underneath the first grip assembly 506A and the second case 702B is disposed at a second position on the lift conveyor 502 underneath the second grip assembly 506B. In some examples, the controller 204 controls the inbound conveyor 500 to convey the first and second cases 702A, 702B onto the lift conveyor 502. In some examples, the controller 204 further controls the lift conveyor 502 to position the first and second cases 702A, 702B underneath the first and second grip assemblies 506A, 506B. In some examples, the controller 204 can control one or more blade stops to raise through rollers in the lift conveyor 502 when positioning the first and second cases 702A, 702B underneath the first and second grip assemblies 506A, 506B

As shown in FIG. 8C, the process 800 proceeds to step 800C, where the grip assemblies 506A, 506B are lowered towards the first and second cases 702A, 702B positioned on the lift conveyor 502. In the illustrated example of FIG. 8C, the downward movement of the first and second grip assemblies 506A, 506B is indicated by downward facing arrows. In some examples, the controller 204 controls one or more motors, actuators, and/or other components in the inbound system 102 to lower the grip assemblies 506A, 506B.

As shown in FIG. 8D, the process 800 proceeds to step 800D, where the first grip assembly 506A engages and grips the first case 702A and the second grip assembly 506B engages and grips the second case 702B. In the illustrated example of FIG. 7D, the vacuum pad 510A and the clamps 512A engage and grip the first case 702A, and the vacuum pad 510B and the clamps 512B engage and grip the second case 702B. In some examples, the controller 204 controls the first and second grip assemblies 506A, 506B to engage and grip the first and second cases 702A, 702B respectively (e.g., controls the vacuum pads 510A, 510B to apply suction force and/or the clamps 512A, 512B to apply a gripping force). As indicated by the upward facing arrows in FIG. 8D, also at step 800D, the grip assemblies 506A, 506B travel upwards after the first and second grip assemblies 506A, 506B have engaged and gripped the first and second cases 702A, 702B, thereby raising the first and second cases 702A, 702B above the lift conveyor 502. For example, the controller 204 controls one or more motors, actuators, and/or other components in the inbound system 102 to raise the first and second grip assemblies 506A, 506B and the first and second cases 702A, 702B held thereby.

As shown in FIG. 8E, the process 800 proceeds to step 800E, where the first and second grip assemblies 506A, 506B hold the first and second cases 702A, 702B above the lift conveyor 502. As further shown in FIG. 8E, at step 800E, the lift conveyor 502 receives first and second carriers 508A, 508B from the carrier infeed conveyor 504. For example, the controller 204 controls the carrier infeed conveyor 504 and/or the carrier transfer system 106 to transfer the first and second carriers 508A, 508B onto the lift conveyor 502. Notably, the first carrier 508A is positioned on the lift conveyor 502 underneath the first case 702A and the second carrier 508B is positioned on the lift conveyor 502 underneath the second case 702B.

As shown in FIG. 8F, the process 800 proceeds to step 800F, where grip assemblies 506A, 506B lower the first and second cases 702A, 702B downward towards the first and second carriers 508A, 508B. In the illustrated example of FIG. 8F, the downward movement of the grip assemblies 506A, 506B and first and second cases 702A, 702B is indicated by downward facing arrows. In some examples, the controller 204 controls one or more motors, actuators, and/or other components in the inbound system 102 to lower the first and second grip assemblies 506A, 506B. At the completion of step 800F, while the first and second grip assemblies 506A, 506B are in a lowered position, the first carrier 508A is positioned underneath and/or surrounds the first case 702A and the second carrier 508B is positioned underneath and/or surrounds the second case 702B.

As shown in FIG. 8G, the process 800 proceeds to step 800G, where the grip assemblies 506A, 506B disengage, or release, the first and second cases 702A, 702B into the first and second carriers 508A, 508B respectively. For example, the controller 204 controls the first and second grip assemblies 506A, 506B to release the first and second cases 702A, 702B (e.g., shut off the vacuum pads 510A, 510B and/or control the clamps 512A, 512B to release the first and second cases 702A, 702B). In that regard, by releasing the first case 702A into the first carrier 508A, the first case 702A is inserted into the first carrier 508A. Similarly, by releasing the second case 702B into the second carrier 508B, the second case 702B is inserted into the second carrier 508B.

As further shown in FIG. 8G, at step 800G, the first and second grip assemblies 506A, 506B raise to the elevated position after disengaging, or releasing, the first and second cases 702A, 702B. For example, the controller 204 controls one or more motors, actuators, and/or other components in the inbound system 102 to raise the first and second grip assemblies 506A, 506B.

As shown in FIG. 8H, the process 800 proceeds to step 800H where the first case 702A inserted in the first carrier 508A and the second case 702B inserted in the second carrier 508B are transported away to storage. In the illustrated example of FIG. 8H, the lift conveyor 502 and the outbound conveyor 704 convey the first case 702A inserted in the first carrier 508A and the second case 702B inserted in the second carrier 508B away to storage. In some examples, the controller 204 controls the lift conveyor 502 and/or the outbound conveyor 704 to convey the first case 702A inserted in the first carrier 508A and the second case 702B inserted in the second carrier 508B away to storage.

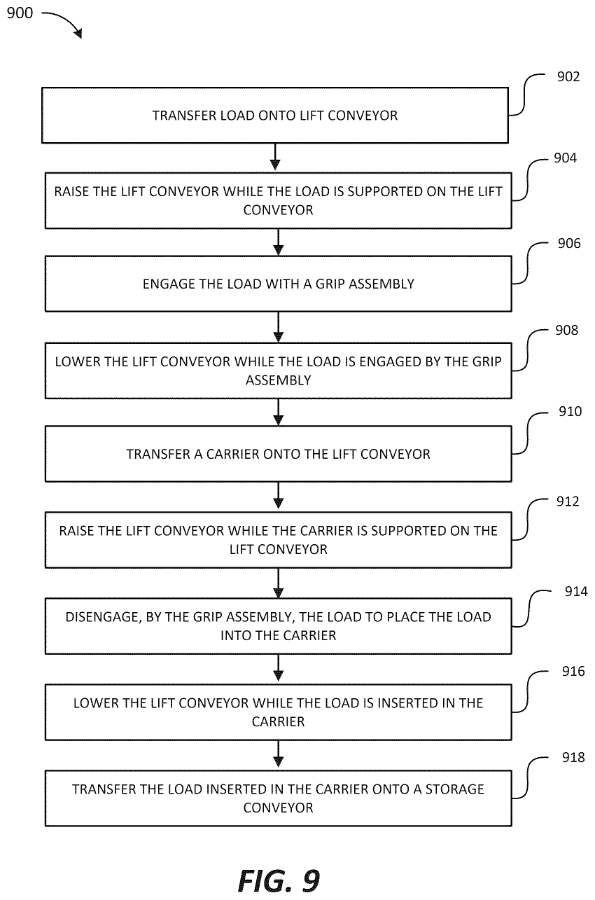

FIG. 9 is a flow diagram of method steps for an example case-to-carrier process, according to the present teachings. Although the method steps are described in conjunction with the systems of FIGS. 1-8H, persons skilled in the art will understand that any system configured to perform the method steps, in any order, is within the scope of the present disclosure. For example, although FIG. 9 is described as using the first and second grip assemblies 506A, 506B, which include vacuum pads 510A, 510B and clamps 512A, 512B respectively, in other examples, the method steps in FIG. 9 can be implemented using other types of grip assemblies that do not include vacuum pads, do not include clamps, and/or include one or more other types of gripping devices adapted to grip and hold a case.

As shown, a method 900 begins at step 902, at which a load is transferred onto a lift conveyor. For example, the controller 204 controls the inbound conveyor 500 to transfer the first case 702A onto the lift conveyor 502.

At step 904, the lift conveyor is raised while the load is supported on the lift conveyor. For example, the controller 204 controls a motor and/or some other device to raise the lift conveyor 502 while the first case 702A is supported on the lift conveyor 502.

At step 906, the load is engaged by a grip assembly. For example, the controller 204 controls the first grip assembly 506A to engage and grip the first case 702A. In some examples, engaging the first case 702A with the first grip assembly 506A includes applying, by the vacuum pad 510A, a suction force to a top surface of the first case 702 and/or applying a gripping force to one or more sides of the first case 702A with the clamps 512A.

At step 908, the lift conveyor is lowered while the load is engaged, or held, by the grip assembly. For example, the controller 204 controls a motor and/or some other device to lower the lift conveyor 502 while the first grip assembly 506A holds the first case 702A above the lift conveyor 502.

At step 910, a carrier is transferred onto the lift conveyor. For example, the controller 204 controls the carrier infeed conveyor 504 to transfer a first carrier 508A onto the lift conveyor 502.

At step 912, the lift conveyor is raised while the carrier is supported on the lift conveyor. For example, the controller 204 controls a motor and/or some other device to raise the lift conveyor 502 while the first case carrier 508A is supported on the lift conveyor 502.

At step 914, the load is disengaged, or released, by the grip assembly and inserted into the carrier. For example, the controller 204 controls the first grip assembly 506A to release the first case 702A, thereby placing the first case 702A into the first carrier 508A.

At step 916, the lift conveyor is lowered while the load is inserted in the carrier supported on the lift conveyor. For example, the controller 204 controls a motor and/or some other device to lower the lift conveyor 502 while the first case 702A is inserted in the first carrier 508A supported on the lift conveyor 502.

At step 918, the load inserted in the carrier is transferred onto a storage conveyor. For example, the controller 204 controls the lift conveyor 502 to transfer, or convey, the first case 702A inserted in the first carrier 508A onto the outbound conveyor 704.

### Outbound System

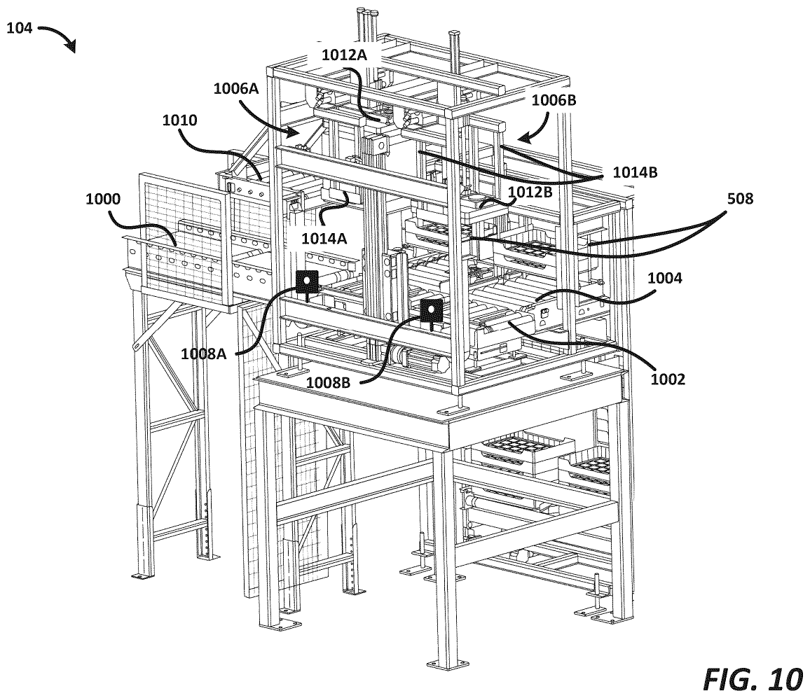

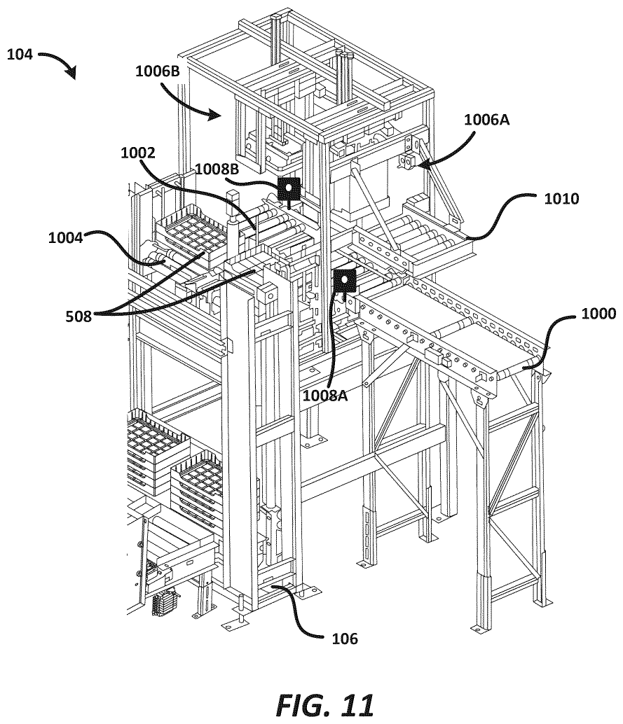

FIGS. 10 and 11 illustrate first and second perspective views of the outbound system 104 included in the CHS 100, according to the present teachings. As described herein, the outbound system 104 is adapted to perform one or more carrier-to-case processes in which cases of product are removed from carriers and transported away for further handling. As shown in FIGS. 10 and 11, the outbound system 104 includes an outbound conveyor 1000, a lift conveyor 1002, a carrier transfer conveyor 1004, a first grip assembly 1006A, and a second grip assembly 1006B. As will be described in more detail herein, in some examples, the outbound system 104 can further include one or more leak sensors 1008A, 1008B and a buffer conveyor 1010 that can be used to implement one or more of the leak detection processes and/or methods described herein.

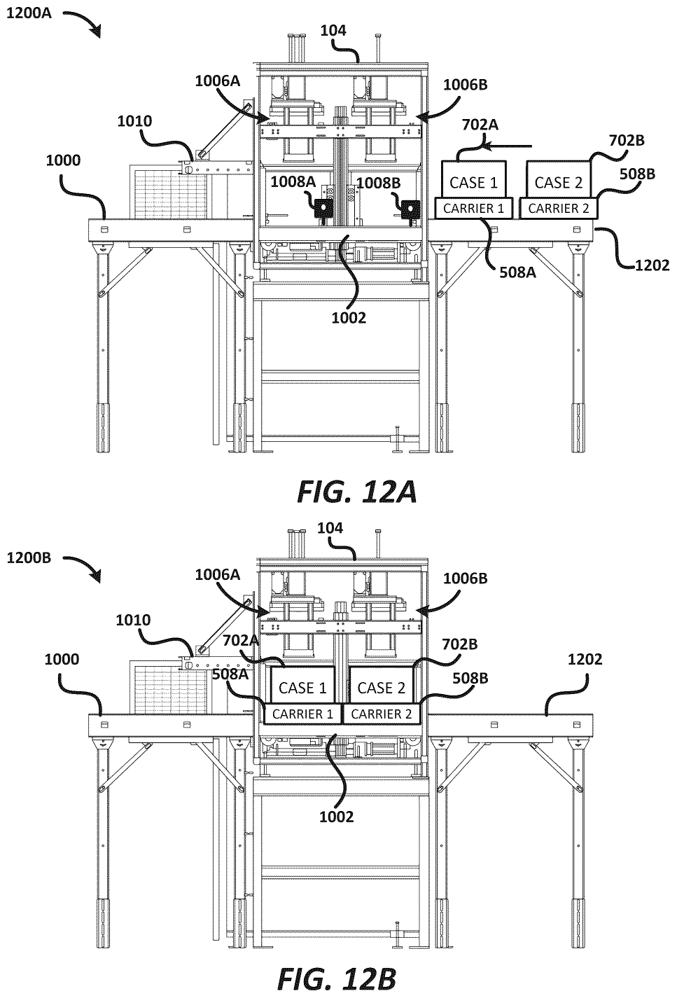

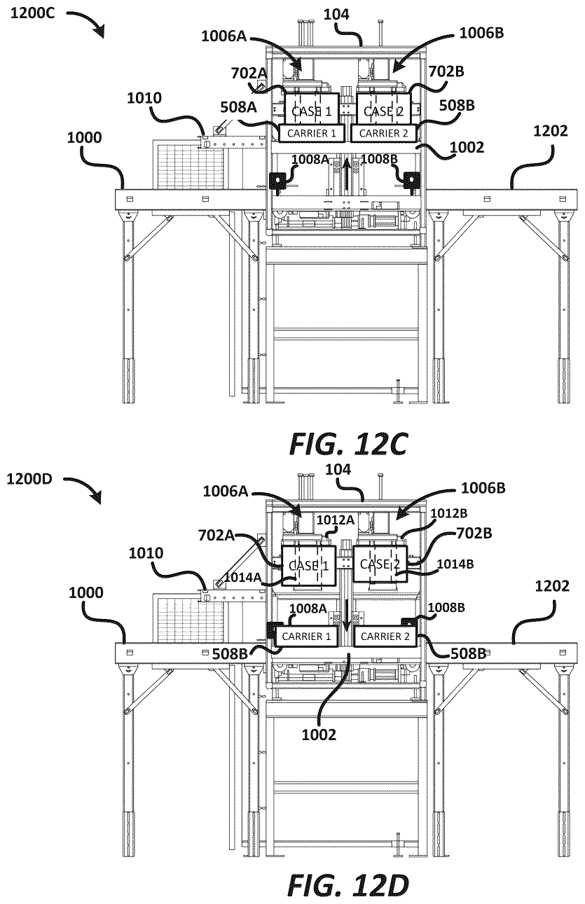

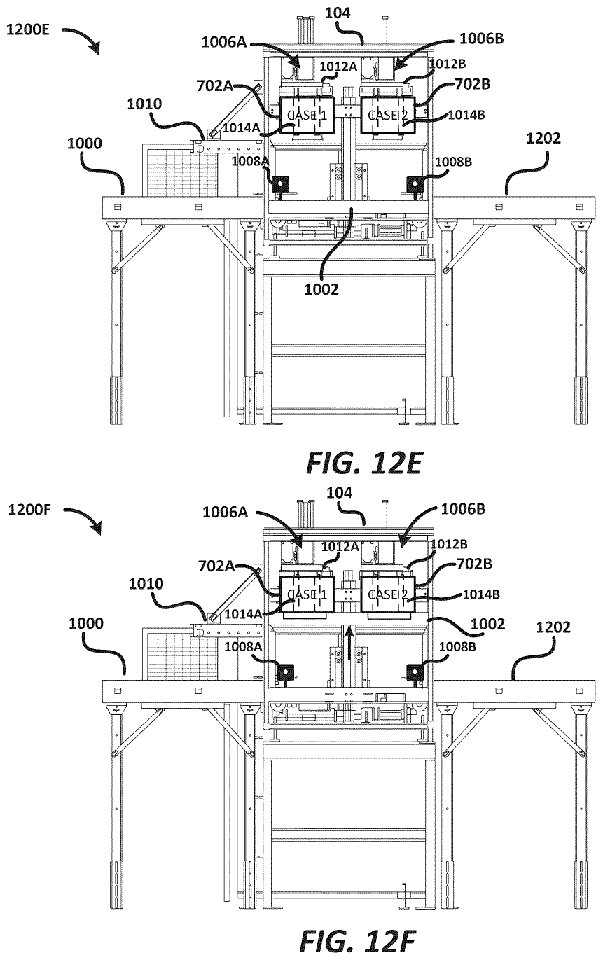

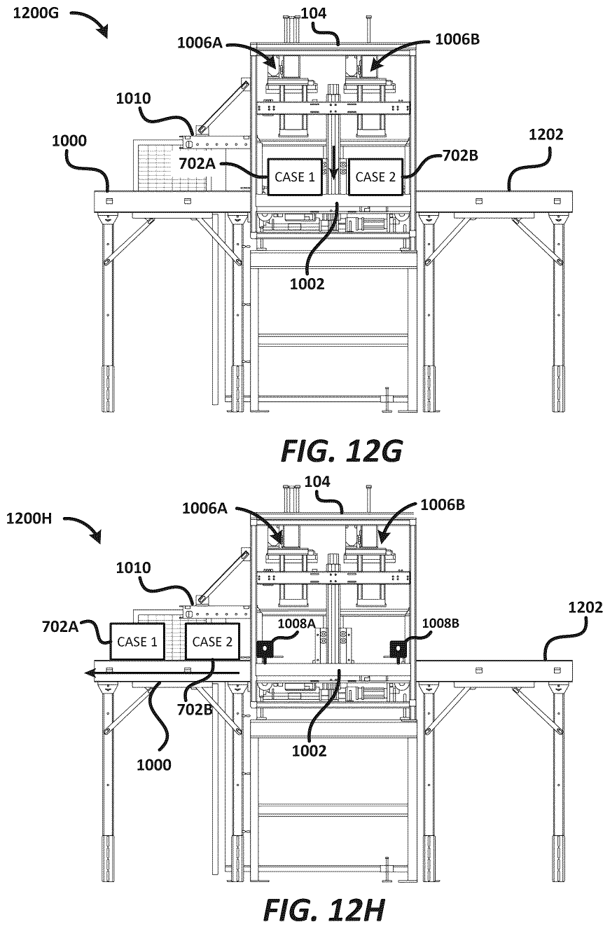

As will be described in more detail herein, an inbound conveyor 1202 (See FIG. 12A) is adapted to transport carriers that contain cases from storage onto the lift conveyor 1002. In some examples, the lift conveyor 1002 is adapted to be raised and lowered (e.g., via one or more motors, actuators, etc.). In such examples, the lift conveyor 1002 can be lowered to receive carriers 508 containing cases from the inbound conveyor 1202, raised to bring the carriers 508 containing the cases up to the grip assemblies 1006A, 1006B, lowered to remove cases from the carriers 508 and transfer the empty carriers 508 to the carrier transfer conveyor 1004. In some examples, the lift conveyor 1002 cannot raise and lower. The lift conveyor 1002 is further adapted to convey, or transport, cases away for further handling once the cases have been removed from the carriers 508. The carrier transfer conveyor 1004 is adapted to convey, or transfer, empty carriers 508 to the carrier transfer system 1006.

The first grip assembly 1006A is similar to the first grip assembly 506A described herein with respect to the inbound system 102. In operation, the first grip assembly 1006A is adapted to engage and grip a case contained, or positioned in, a carrier 508 supported on the lift conveyor 1002, hold the case above the lift conveyor 1002, and disengage the case to place the case back onto the lift conveyor 1002 after the empty carrier 508 has been transferred to the carrier transfer system 1006. In the illustrated example of FIGS. 10 and 11, the first grip assembly 1006A is shown to include a vacuum pad 1012A and clamps 1014A. The vacuum pad 1012A is adapted to provide a suction force to the top of the case and the clamps 1014A are adapted to apply a gripping force to the sides and/or the bottom of the case. In some examples, the first grip assembly 1006A can be lowered towards the lift conveyor 1002 to grip a case and raised back above the lift conveyor 1002 to hold the case above the lift conveyor 1002. In other examples, the first grip assembly 1006A remains at a fixed height above the lift conveyor 1002.

In some examples, the first grip assembly 1006A does not include the vacuum pad 1012A and instead only includes the clamps 1014A. In some examples, the first grip assembly 1012A does not include the clamps 1014A and instead only includes the vacuum pad 1012A. In some examples, the first grip assembly 1006A can include one or more other types of gripping devices in lieu of and/or in addition to the vacuum pad 1012A and/or the clamps 1014A. In such examples, the one or more other types of gripping devices can be adapted to grip and hold a case above the lift conveyor 1002 in conjunction with and/or in lieu of the vacuum pad 1012A and the clamps 1014A. The one or more other types of gripping devices can include, for example, one or more additional clamps, one or more belts, one or more robotic arms, one or more suction devices, one or more magnets, and/or one or more other types of gripping devices.

The second grip assembly 1006B is similar to the second grip assembly 506B described herein with respect to the inbound system 102. In operation, the second grip assembly 1006B is adapted to engage and grip a case contained, or positioned in, a carrier 508 supported on the lift conveyor 1002, hold the case above the lift conveyor 1002, and disengage the case to place the case back onto the lift conveyor 1002 after the empty carrier 508 has been transferred to the carrier transfer system 1006. In the illustrated example of FIGS. 10 and 11, the second grip assembly 1006B is shown to include a vacuum pad 1012B and clamps 1014B. The vacuum pad 1012B is adapted to provide a suction force to the top of the case and the clamps 1014B are adapted to apply a gripping force to the sides and/or the bottom of the case. In some examples, the second grip assembly 1006B can be lowered towards the lift conveyor 1002 to grip a case and raised back above the lift conveyor 1002 to hold the case above the lift conveyor 1002. In other examples, the second grip assembly 1006B remains at a fixed height above the lift conveyor 1002.

In some examples, the second grip assembly 1006B does not include the vacuum pad 1012B and instead only includes the clamps 1014B. In some examples, the first grip assembly 1012B does not include the clamps 1014B and instead only includes the vacuum pad 1012B. In some examples, the second grip assembly 1006B can include one or more other types of gripping devices in lieu of and/or in addition to the vacuum pad 1012B and/or the clamps 1014B. In such examples, the one or more other types of gripping devices can be adapted to grip and hold a case above the lift conveyor 1002 in conjunction with and/or in lieu of the vacuum pad 1012B and the clamps 1014B. The one or more other types of gripping devices can include, for example, one or more additional clamps, one or more belts, one or more robotic arms, one or more suction devices, one or more magnets, and/or one or more other types of gripping devices.

Although two grip assemblies 1006A, 1006B are shown to be included in the outbound system 104 in the illustrated examples of FIGS. 10 and 11, persons skilled in the art should understand that in other examples, more or less than two grip assemblies 1006 can be included in the outbound system 104. For example, the outbound system 104 may only include a single grip assembly 1006 or can include three, four, five, six, or more grip assemblies 1006. Furthermore, although not shown, in some examples, the outbound system 104 can also include one or more leak sensors adapted to detect the occurrence of a leak associated with a case.

FIGS. 12A-12H illustrate an example carrier-to-case process 1200, according to the present teachings. Although the steps in process 1200 are described in conjunction with the inbound system 102 and/or other systems of FIGS. 1-12H, persons skilled in the art will understand that any system configured to perform the method steps, in any order, is within the scope of the present disclosure. For example, although the process 1200 is described and illustrated as using the first and second grip assemblies 1006A, 1006B, which include vacuum pads 1012A, 1012B and clamps 1014A, 1014B respectively, in other examples, process 1200 can be implemented using other types of grip assemblies that do not include vacuum pads, do not include clamps, and/or include one or more other types of gripping devices adapted to grip and hold a case.

As shown in FIG. 12A, the process 1200 begins with step 1200A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 12B, the process 1200 proceeds to step 1200B, where the lift conveyor 1002 receives the first and second cases 702A, 702B inserted in the first and second carriers 508A, 508B from the inbound conveyor 1202. At the completion of step 1200B, the first case 702A inserted in the first carrier 508A is disposed at a first position on the lift conveyor 1002 underneath the first grip assembly 1006A and the second case 702B inserted in the second carrier 508B is disposed at a second position on the lift conveyor 1002 underneath the second grip assembly 1006B. In some examples, the controller 204 controls the lift conveyor 1002 to position the first and second cases 702A, 702B underneath the first and second grip assemblies 1006A, 1006B. In some examples, the controller 204 can control one or more blade stops to raise through rollers in the lift conveyor 1002 when positioning the first and second cases 702A, 702B inserted in the first and second carriers 508A, 508B underneath the first and second grip assemblies 1006A, 1006B.

As shown in FIG. 12C, the process 1200 proceeds to step 1200C, where the lift conveyor 1002 raises the first and second cases 702A, 702B inserted in the first and second carriers 508A, 508B upwards towards the first and second grip assemblies 1006A, 1006B. In the illustrated example of FIG. 12C, the upward movement of the lift conveyor 1002 and first and second cases 702A, 702B inserted in the first and second carriers 508A, 508B is indicated by an upward facing arrow. In some examples, the controller 204 controls one or more motors, actuators, and/or other components in the outbound system 104 to raise the lift conveyor 1002.

As shown in FIG. 12D, the process 1200 proceeds to step 1200D, where while the lift conveyor 1002 is in an elevated position, the first grip assembly 1006A engages and grips the first case 702A inserted in the first carrier 508A and the second grip assembly 1006B engages and grips the second case 702B inserted in the second carrier 508C. In the illustrated example of FIG. 12D, the vacuum pad 1012A and the clamps 1014A engage and grip the first case 702A inserted in the first carrier 508A, and the vacuum pad 1012B and the clamps 1014B engage and grip the second case 702B inserted in the second carrier 508B. In some examples, the controller 204 controls the first and second grip assemblies 1006A, 1006B to engage and grip the first and second cases 702A, 702B respectively (e.g., controls the vacuum pads 1012A, 1012B to apply suction force and/or the clamps 1014A, 1014B to apply a gripping force).

As indicated by the downward facing arrow in FIG. 12D, also at step 1200D, the lift conveyor 1002 travels to a lowered position after the first and second grip assemblies 1006A, 1006B have engaged and gripped the first and second cases 702A, 702B, thereby lowering the first and second carriers 508A, 508B supported on the lift conveyor 1002 away from the first and second cases 702A, 702B. For example, the controller 204 controls one or more motors, actuators, and/or other components in the outbound system 104 to lower the lift conveyor 1002. In that regard, the lift conveyor 1002 effectively removes the first case 702A from the first carrier 508A and the second case 702B from the second carrier 508B by lowering the lift conveyor 1002 away from the first and second grip assemblies 1006A, 1006B. As shown in FIG. 12D, at the conclusion of step 1200D, the first and second grip assemblies 1006A, 1006B hold the first and second cases 702A, 702B above the first and second carriers 508A, 508B supported on the lift conveyor 1002.

As shown in FIG. 12E, the process 1200 proceeds to step 1200E, where the first and second carriers 508A, 508B are transferred from the lift conveyor 1002 onto the carrier transfer conveyor 1004. For example, the controller 1204 controls the lift conveyor 1002 to transfer the empty first and second carriers 508A, 508B onto the carrier transfer conveyor 1004, which provides the empty first and second carriers 508A, 508B to the carrier transfer system 106 for reuse by the inbound system 102. As further shown in FIG. 12E, at step 1200E, the first and second grip assemblies 1006A, 1006B continue to hold the first and second cases 702A, 702B above the lift conveyor 1002 after the first and second carriers 508A, 508B have been removed from the lift conveyor 1002.

As shown in FIG. 12F, the process 1200 proceeds to step 1200F, where the lift conveyor 1002 raises upwards towards the first and second cases 702A, 702B being held by the first and second grip assemblies 1006A, 1006B. In the illustrated example of FIG. 12F, the upward movement of the lift conveyor 1002 is indicated by an upward facing arrow. In some examples, the controller 204 controls one or more motors, actuators, and/or other components in the outbound system 104 to raise the lift conveyor 1002. At the completion of step 1200F, the lift conveyor 1002 is positioned underneath the first and second cases 702A, 702B.

As shown in FIG. 12G, the process 1200 proceeds to step 1200G, where the first and second grip assemblies 1006A, 1006B disengage, or release, the first and second cases 702A, 702B onto the lift conveyor 1002. For example, the controller 204 controls the first and second grip assemblies 1006A, 1006B to release the first and second cases 702A, 702B (e.g., shut off the vacuum pads 1012A, 1012B and/or control the clamps 1014A, 1014B to release the first and second cases 702A, 702B). As further shown in FIG. 12G, at step 1200G, the lift conveyor 1002 lowers the first and second cases 702A, 702B back to the lowered position after the first and second grip assemblies 1006A, 1006B release the first and second cases 702A, 702B. For example, the controller 204 controls one or more motors, actuators, and/or other components in the outbound system 104 to lower the lift conveyor 1002.

As shown in FIG. 12H, the process 1200 proceeds to step 1200H where the first and second cases 702A, 702B are transported away for further handling. In the illustrated example of FIG. 12H, the lift conveyor 1002 and an outbound conveyor 1000 convey the first and second cases 702A, 702B away. In some examples, the controller 204 controls the lift conveyor 1002 and/or the outbound conveyor 1000 to convey the first and second cases 702A, 702B away.

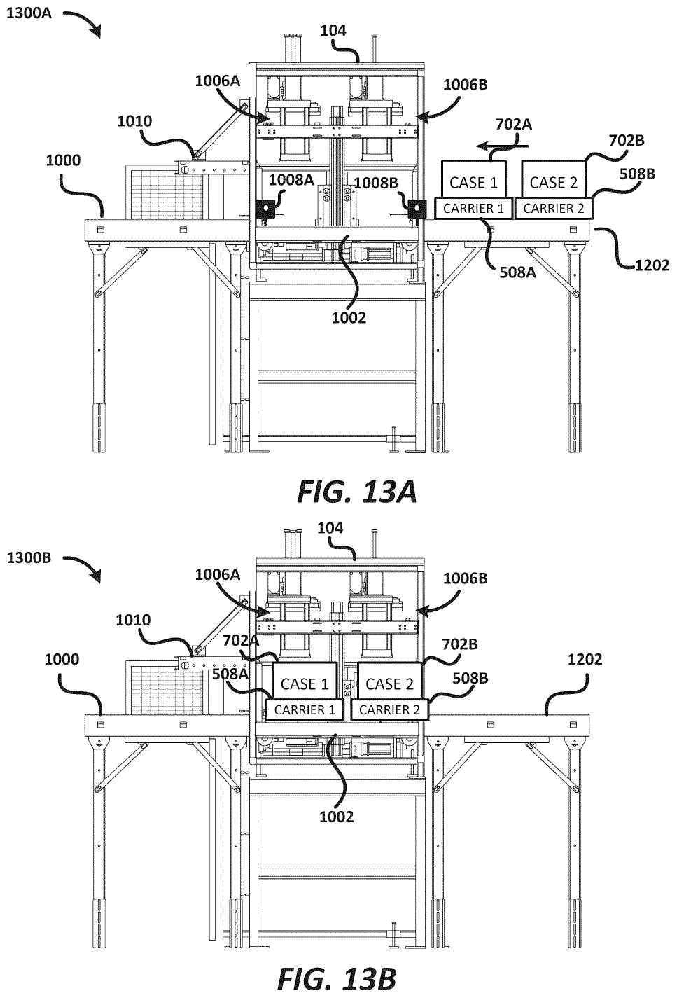

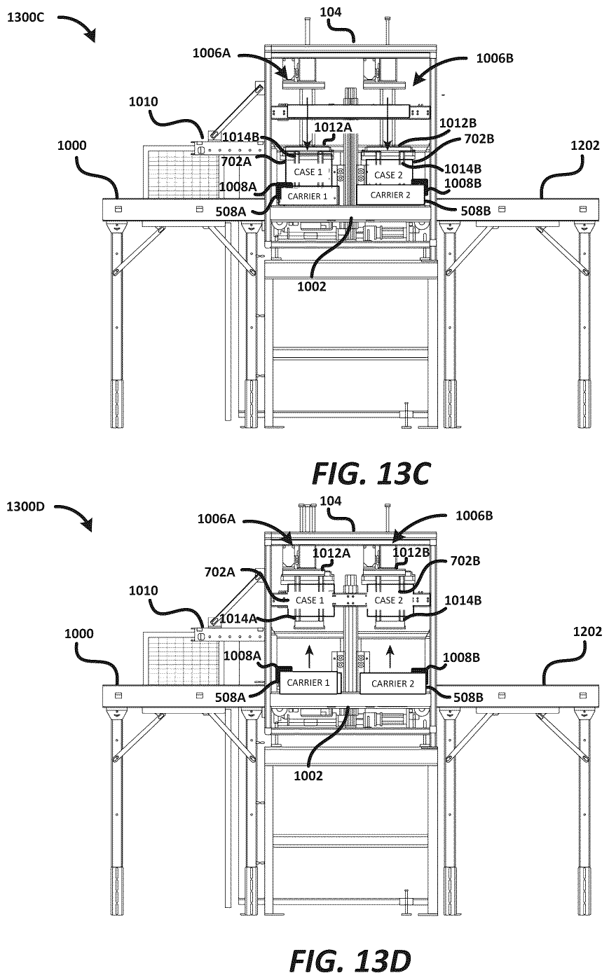

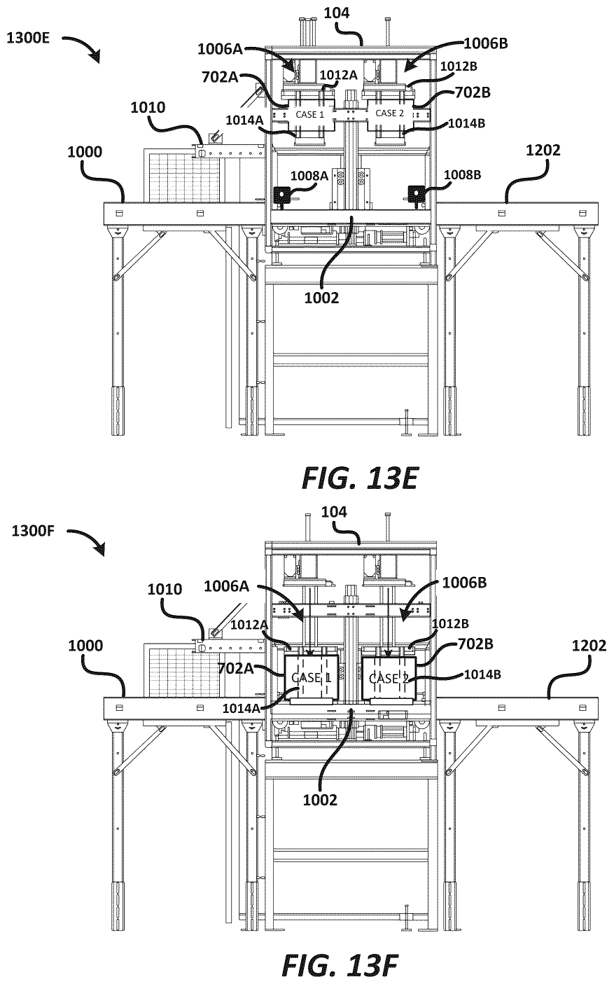

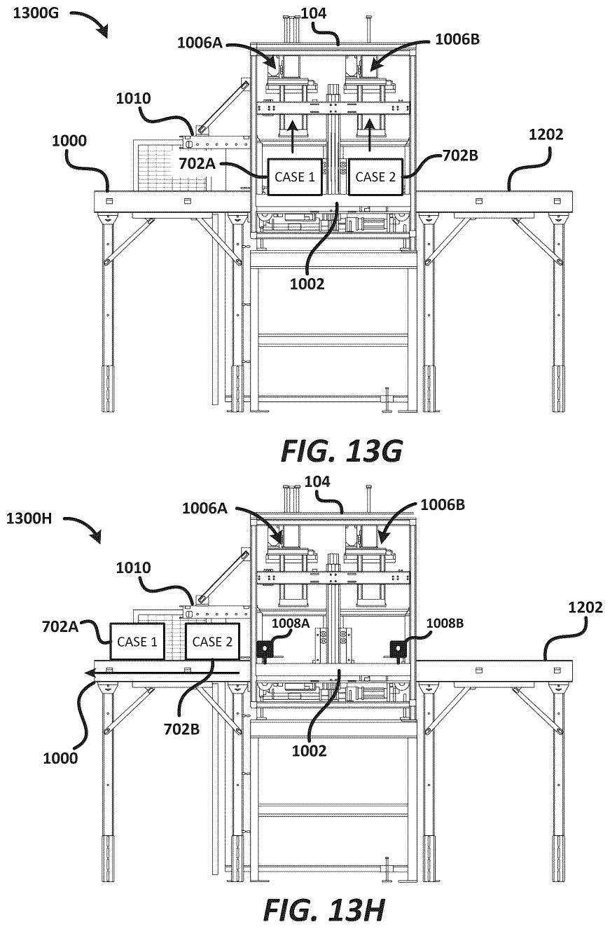

FIGS. 13A-13H illustrate another example carrier-to-case process 1300, according to the present teachings. Although the steps in process 1300 are described in conjunction with the outbound system 104 and/or other systems of FIGS. 1-13H, persons skilled in the art will understand that any system configured to perform the method steps, in any order, is within the scope of the present disclosure. For example, although the process 1300 is described and illustrated as using the first and second grip assemblies 1006A, 1006B, which include vacuum pads 1012A, 1012B and clamps 1014A, 1014B respectively, in other examples, process 1300 can be implemented using other types of grip assemblies that do not include vacuum pads, do not include clamps, and/or include one or more other types of gripping devices adapted to grip and hold a case.

As shown in FIG. 13A, the process 1300 begins with step 1300A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 13B, the process 1300 proceeds to step 1300B, where the lift conveyor 1002 receives the first and second cases 702A, 702B inserted in the first and second carriers 508A, 508B from the inbound conveyor 1202. At the completion of step 1300B, the first case 702A inserted in the first carrier 508A is disposed at a first position on the lift conveyor 1002 underneath the first grip assembly 1006A and the second case 702B inserted in the second carrier 508B is disposed at a second position on the lift conveyor 1002 underneath the second grip assembly 1006B. In some examples, the controller 204 controls the lift conveyor 1002 to position the first and second cases 702A, 702B underneath the first and second grip assemblies 1006A, 1006B. In some examples, the controller 204 can control one or more blade stops to raise through rollers in the lift conveyor 1002 when positioning the first and second cases 702A, 702B inserted in the first and second carrier 508A, 508B underneath the first and second grip assemblies 1006A, 1006B.

As shown in FIG. 13C, the process 1300 proceeds to step 1300C, where the grip assemblies 1006A, 1006B are lowered towards the first and second cases 702A, 702B inserted in the first and second carriers 508A, 508B positioned on the lift conveyor 1002. In the illustrated example of FIG. 13C, the downward movement of the first and second grip assemblies 1006A, 5006B is indicated by downward facing arrows. In some examples, the controller 204 controls one or more motors, actuators, and/or other components in the outbound system 104 to lower the grip assemblies 1006A, 1006B.

As shown in FIG. 13D, the process 1300 proceeds to step 1300D, where the first grip assembly 1006A engages and grips the first case 702A and the second grip assembly 1006B engages and grips the second case 702B. In the illustrated example of FIG. 13D, the vacuum pad 1012A and the clamps 1014A engage and grip the first case 702A, and the vacuum pad 1012B and the clamps 1014B engage and grip the second case 702B. In some examples, the controller 204 controls the first and second grip assemblies 1006A, 1006B to engage and grip the first and second cases 702A, 702B respectively (e.g., controls the vacuum pads 1012A, 1012B to apply suction force and/or the clamps 1014A, 1014B to apply a gripping force).

As indicated by the upward facing arrows in FIG. 13D, further at step 1300D, the grip assemblies 1006A, 1006B travel upwards after the first and second grip assemblies 1006A, 1006B have engaged and gripped the first and second cases 702A, 702B, thereby removing the first and second cases 702A, 702B from the first and second carriers 508A, 508B and raising the first and second cases 702A, 702B above the lift conveyor 1002. For example, the controller 204 controls one or more motors, actuators, and/or other components in the outbound system 104 to raise the first and second grip assemblies 1006A, 1006B holding the first and second cases 702A, 702B.

As shown in FIG. 13E, the process 1300 proceeds to step 1300E, where the first and second carriers 508A, 508B are transferred from the lift conveyor 1002 onto the carrier transfer conveyor 1004. For example, the controller 1204 controls the lift conveyor 1002 to transfer the empty first and second carriers 508A, 508B onto the carrier transfer conveyor 1004, which provides the empty first and second carriers 508A, 508B to the carrier transfer system 106 for reuse by the inbound system 102. As further shown in FIG. 13E, at step 1300E, the first and second grip assemblies 1006A, 1006B continue to hold the first and second cases 702A, 702B above the lift conveyor 1002 after the first and second carriers 508A, 508B have been removed from the lift conveyor 1002.

As shown in FIG. 13F, the process 1300 proceeds to step 1300F, where the first and second grip assemblies 1006A, 1006B lower the first and second cases 702A, 702B downward towards the lift conveyor 1006. In the illustrated example of FIG. 13F, the downward movement of the grip assemblies 1006A, 1006B and the first and second cases 702A, 702B held thereby is indicated by downward facing arrows. In some examples, the controller 204 controls one or more motors, actuators, and/or other components in the outbound system 104 to lower the first and second grip assemblies 1006A, 1006B holding the first and second cases 702A, 702B.

As shown in FIG. 13G, the process 1300 proceeds to step 1300G, where the first and second grip assemblies 1006A, 1006B disengage, or release, the first and second cases 702A, 702B onto the lift conveyor 1002. For example, the controller 204 controls the first and second grip assemblies 1006A, 1006B to release the first and second cases 702A, 702B (e.g., shut off the vacuum pads 1012A, 1012B and/or control the clamps 1014A, 1014B to release the first and second cases 702A, 702B). As further shown in FIG. 13G, at step 1300G, the first and second grip assemblies 1006A, 1006B raise to the elevated position after disengaging, or releasing, the first and second cases 702A, 702B. For example, the controller 204 controls one or more motors, actuators, and/or other components in the outbound system 104 to raise the first and second grip assemblies 1006A, 1006B.

As shown in FIG. 13H, the process 1300 proceeds to step 1300H where the first and second cases 702A, 702B are transported away for further handling. In the illustrated example of FIG. 13H, the lift conveyor 1002 and an outbound conveyor 1000 convey the first and second cases 702A, 702B away. In some examples, the controller 204 controls the lift conveyor 1002 and/or the outbound conveyor 1000 to convey the first and second cases 702A, 702B away.

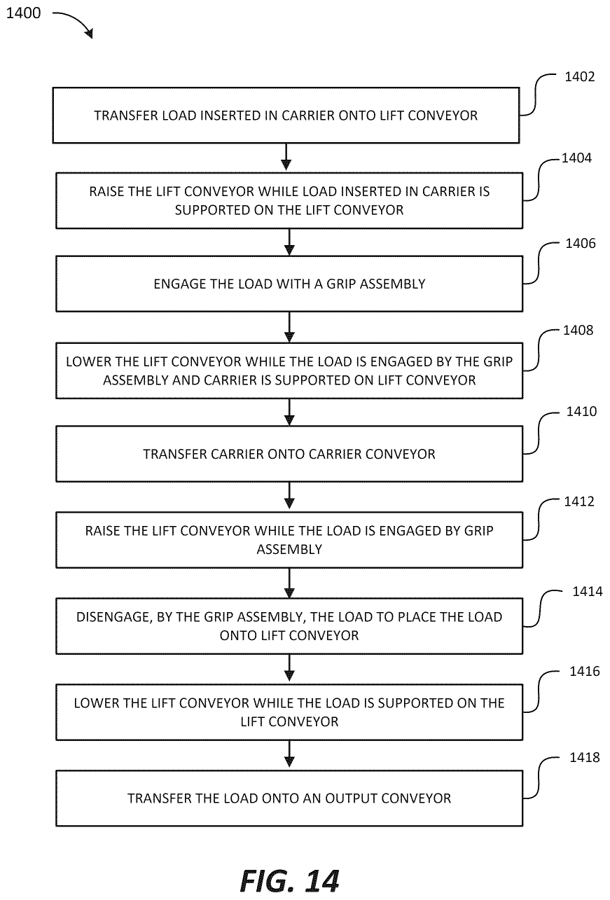

FIG. 14 is a flow diagram of method steps for an example carrier-to-case process, according to the present teachings. Although the method steps are described in conjunction with the systems of FIGS. 1-13H, persons skilled in the art will understand that any system configured to perform the method steps, in any order, is within the scope of the present disclosure. For example, although FIG. 14 is described as using the first and second grip assemblies 1006A, 1006B, which include vacuum pads 1012A, 1012B and clamps 1014A, 1014B respectively, in other examples, the method steps in FIG. 14 can be implemented using other types of grip assemblies that do not include vacuum pads, do not include clamps, and/or include one or more other types of gripping devices adapted to grip and hold a case.

As shown, a method 1400 begins at step 1402, at which a load inserted in a carrier is transferred onto a lift conveyor. For example, the controller 204 controls the inbound conveyor 1202 to transfer, from storage, the first case 702A inserted in the first carrier 508A onto the lift conveyor 1002.

At step 1404, the lift conveyor is raised while the load inserted in the carrier is supported on the lift conveyor. For example, the controller 204 controls a motor and/or some other device to raise the lift conveyor 1002 while the first case 702A inserted in the first carrier 508A is supported on the lift conveyor 1002.

At step 1406, the load is engaged by a grip assembly. For example, the controller 204 controls the first grip assembly 1006A to engage and grip the first case 702A. In some examples, engaging the first case 702A with the first grip assembly 1006A includes applying, by the vacuum pad 1012A, a suction force to a top surface of the first case 702 and/or applying a gripping force to one or more sides of the first case 702A with the clamps 1014A.

At step 1408, the lift conveyor is lowered while the load is engaged, or held, by the grip assembly and the carrier is supported on the lift conveyor. For example, the controller 204 controls a motor and/or some other device to lower the lift conveyor 1002 while the first grip assembly 1006A holds the first case 702A above the lift conveyor 1002 and the first carrier 508A remains supported on the lift conveyor 1002.

At step 1410, the carrier is transferred onto a carrier conveyor. For example, the controller 204 controls the lift conveyor 1002 to transfer the first carrier 508A onto the carrier transfer conveyor 1004.

At step 1412, the lift conveyor is raised while the load is engaged, or held, by the grip assembly. For example, the controller 204 controls a motor and/or some other device to raise the lift conveyor 1002 while the first grip assembly 1006A holds the first case 702A above the lift conveyor 1002.

At step 1414, the load is disengaged, or released, by the grip assembly and placed onto the lift conveyor. For example, the controller 204 controls the first grip assembly 1006A to release the first case 702A, thereby placing the first case 702A onto the lift conveyor 1002.

At step 1416, the lift conveyor is lowered while the load is supported on the lift conveyor. For example, the controller 204 controls a motor and/or some other device to lower the lift conveyor 1002 while the first case 702A is supported on the lift conveyor 1002.

At step 1418, the load is transferred onto an output conveyor. For example, the controller 204 controls the lift conveyor 1002 to transfer, or convey, the first case 702A onto the outbound conveyor 1000.

### Leak Detection

As described herein, cases handled by the CHS 100 can contain products of various types, including liquid products. For instances in which a case contains a liquid product (e.g., a beverage, a chemical, a pharmaceutical, a food product, etc.), it is possible for the case to experience a leak. When liquid leaks from a case being handled by the CHS 100, the leak can cause damage to one or more components of the CHS 100 and/or to the products contained in one or more other cases. In that regard, the CHS 100 and/or the controller 204 can implement one or more leak detection techniques to identify and mitigate the effects of a leak associated with a case being handled by the CHS 100.

In some examples, the CHS 100 and/or the controller 204 implements one or more leak detection processes when retrieving cases inserted in carriers from storage. In that regard, the CHS 100 and/or the controller 204 implements can implement one or more leak detection processes prior to implementing a carrier-to-case process described herein (e.g., process 1200, process 1300, method 1400 etc.) in which a case is removed from a carrier 508 prior to further handling of the case. For instances in which a leak associated with a case inserted in a carrier 508 is detected prior to a carrier-to-case process (e.g., process 1200, process 1300, method 1400, etc.), the CHS 100 and/or the controller can leave the case inserted in the carrier 508 to (i) contain the leak and (ii) provide a visual indication to one or more operators that the case is experiencing a leak.

As described herein with respect to FIGS. 10 and 11, in some examples, the outbound system 104 can include one or more leak sensors 1008 and/or a buffer conveyor 1010 that can be used to implement one or more leak detection processes. In the illustrated examples of FIGS. 10 and 11, the outbound system 104 includes first and second leak sensors 1008A, 1008B. However, in other examples, the outbound system 104 can include fewer than (e.g., 1) or more than (e.g., 3, 4, 5, etc.) leaks sensors 1008.

In operation, a leak sensor 1008 is adapted to generate sensor data indicative of the ambient humidity and/or moisture levels near a case. When the sensor data indicates that the ambient humidity and/or moisture levels near a case exceed one or more leak detection thresholds and/or setpoints, the controller 204 can determine that a leak associated with the case has occurred. Responsive to determining that a leak associated with a case has occurred, the controller 204 can control one or more components of the CHS 100, or more particularly the outbound system 104, to handle the leak associated with the case.

With respect to the illustrated examples of FIGS. 10 and 11, the first and second leak sensors 1008A, 1008B are installed at positions in the outbound system 104 suitable for sensing ambient humidity and/or moisture levels near cases. In some examples, the first and/or second leak sensors 1008A, 1008B can be mounted to and/or otherwise supported on the lift conveyor 1002. In some examples, the first and/or second leak sensors 1008A, 1008B can be mounted to and/or otherwise supported on the carrier transfer conveyor 1004. In some examples, the first and/or second leak sensors 1008A, 1008B can be mounted to and/or otherwise supported on the inbound conveyor 1202. In some examples, the first and/or second leak sensors 1008A, 1008B can be mounted to and/or otherwise supported on a frame, a bracket, and/or some other structure in the outbound system 104. For example, the first and/or second leak sensors 1008A, 1008B can be installed on a frame of the outbound system 104 near the positions at which cases inserted in carriers 508 are conveyed onto the lift conveyor 1002.

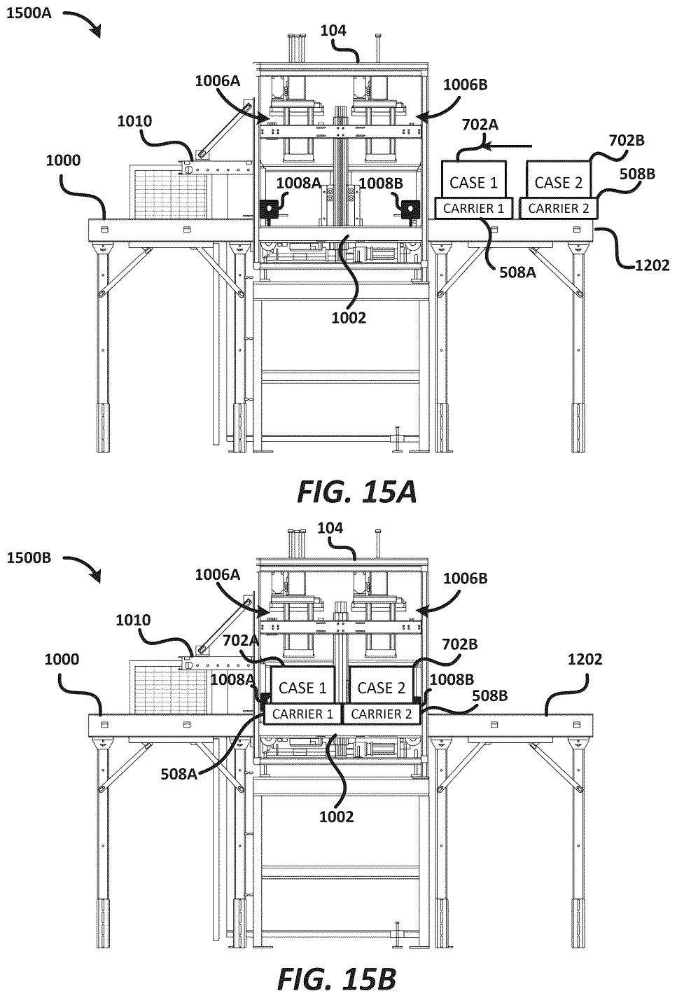

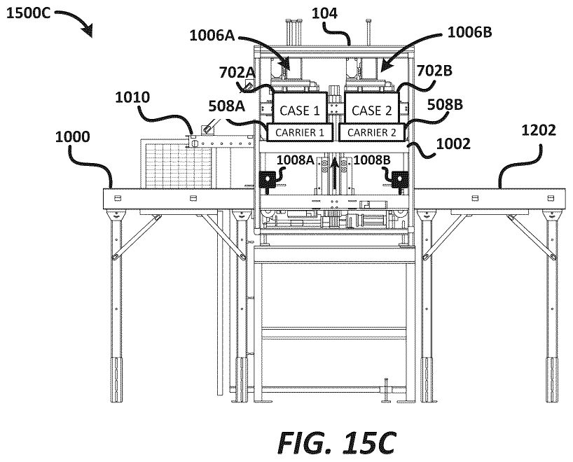

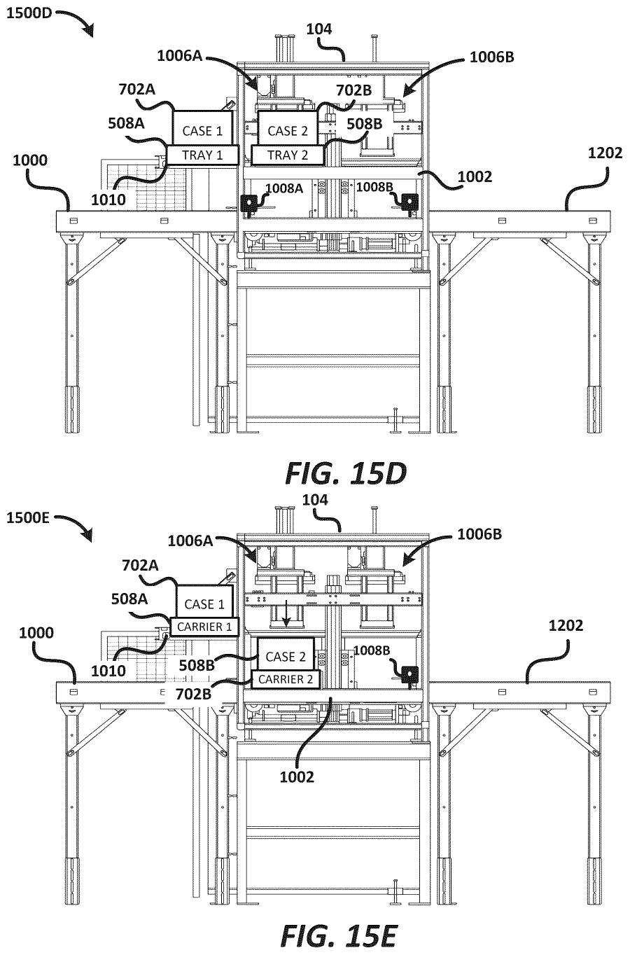

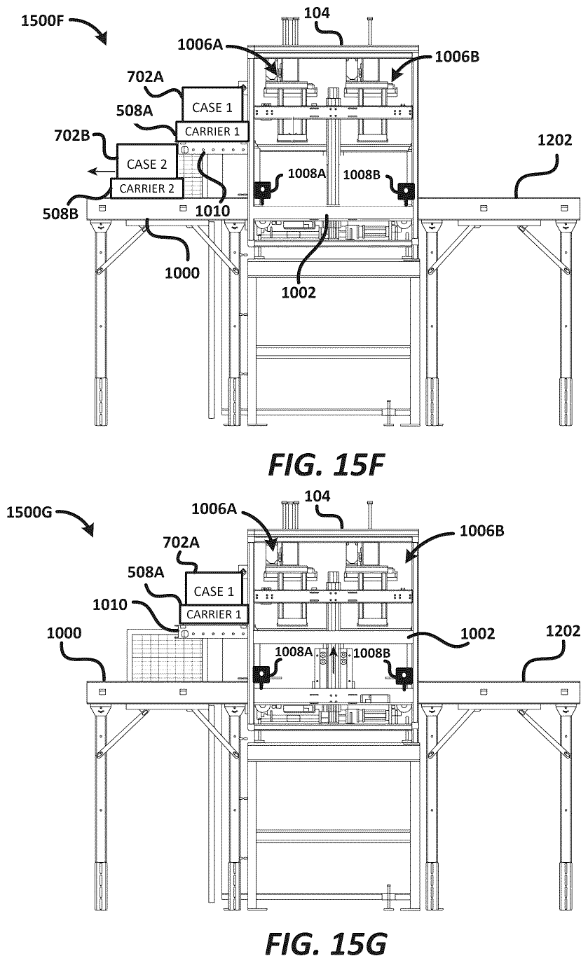

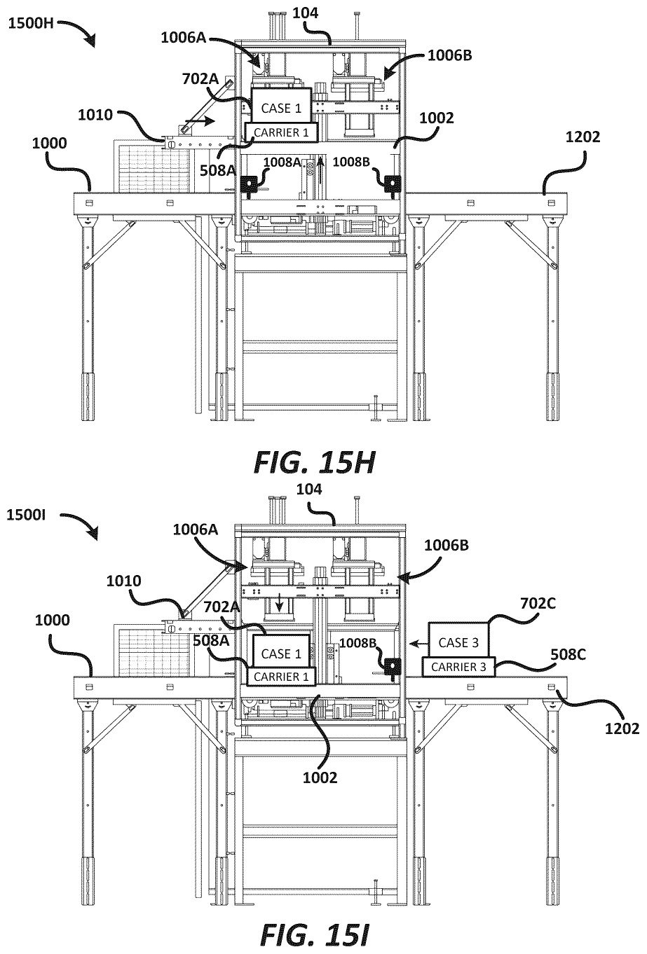

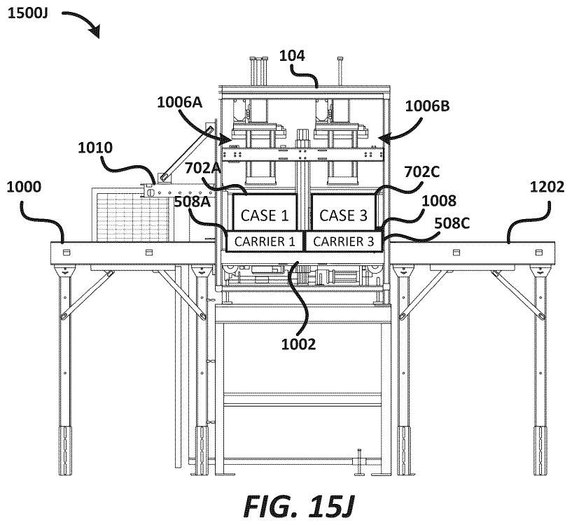

FIGS. 15A-15J illustrate an example leak detection process 1500, according to the present teachings. Although the steps in process 1500 are described in conjunction with the outbound system 104 and/or other systems of FIGS. 1-15J, persons skilled in the art will understand that any system configured to perform the method steps, in any order, is within the scope of the present disclosure. For example, although the process 1500 is described and illustrated as using two leak sensors 1008A, 1008B, in other examples, the process 1500 can be implemented using less than or more than two leak sensors.

As shown in FIG. 15A, the process 1500 begins with step 1500A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 15B, the process 1500 proceeds to step 1500B, where the first and second cases 702A, 702B inserted in the first and second carriers 508A, 508B are transferred from the inbound conveyor 1202 onto the lift conveyor 1002. In the illustrated example of FIG. 15B, the first case 702A inserted in the first carrier 508A is transferred to a first position on the lift conveyor 1002 that is nearby, or within a sensing range of, the first leak sensor 1008A and the second case 702B inserted in the second carrier 508B is transferred to a second position on the lift conveyor 1002 that is nearby, or within a sensing range of, the second leak sensor 1008B. In some examples, the controller 204 can control one or more blade stops to raise through rollers in the lift conveyor 1002 when positioning the first and second cases 702A, 702B inserted in the first and second carriers 508A, 508B near the first and second leak detection sensors 1008A, 1008B.

Further at step 1500B, the first leak sensor 1008A generates sensor data indicative of the moisture and/or humidity levels associated with the first case 702A inserted in the first carrier 508A and the second leak sensor 1008B generates sensor data indicative of the moisture and/or humidity levels associated with the second case 702B inserted in the second carrier 508B. The controller 204 receives the sensor data from the first and second leak sensors 1008A, 1008B and determines, based on the received sensor data, whether the first case 702A and/or the second case 702B is experiencing a leak.

For example, the controller 204 can determine, based on the sensor data received from the first leak sensor 1008A, whether the moisture and/or humidity levels associated with the first case 702A exceed one or more leak thresholds. Responsive to determining that the moisture and/or humidity levels associated with the first case 702A do exceed one or more leak thresholds, the controller 204 can determine that a leak associated with the first case 702A has occurred. However, responsive to determining that the moisture and/or humidity levels associated with the first case 702A do not exceed one or more leak thresholds, the controller 204 can determine that there is no leak associated with the first case 702A. As described herein, the values of the one or more leak thresholds can be user-defined and/or automatically determined. Moreover, the leak thresholds can be stored in the memory 402 of controller 204.

As another example, the controller 204 can determine, based on the sensor data received from the second leak sensor 1008B, whether the moisture and/or humidity levels associated with the second case 702B exceed one or more leak thresholds. Responsive to determining that the moisture and/or humidity levels associated with the second case 702B do exceed one or more leak thresholds, the controller 204 can determine that a leak associated with the second case 702B has occurred. However, responsive to determining that the moisture and/or humidity levels associated with the second case 702B do not exceed one or more leak thresholds, the controller 204 can determine that there is no leak associated with the second case 702B.

In the illustrated example of FIG. 15B, the controller 204 determines, based on the sensor data received from the first and second leak sensors 1008A, 1008B, that a leak associated with the second case 702B has occurred. Further in the illustrated example of FIG. 15B, the controller 204 determines, based on the sensor data received from the first and second leak sensors 1008A, 1008B, that there is no leak associated with the first case 702A. In that regard, in the illustrated example of FIG. 15B, the controller 204 determines that the leading case (e.g., first case 702A) is not experiencing a leak while the trailing case (e.g., second case 702B) is experiencing a leak.

Responsive to determining that the leading case (e.g., first case 702A) is not experiencing a leak and the trailing case (e.g., second case 702B) is experiencing a leak, the subsequent steps 15C-15J in the process 1500 are preformed to position the leading case (e.g., first case 702A) for removal from the corresponding carrier (e.g., first carrier 508A) using a carrier-to-case process described herein (e.g., process 1200, process 1300, method 1400, etc.) while also pushing the trailing case (e.g., second case 702B) through the outbound system 104 without removing the trailing case from the corresponding carrier (e.g., the second carrier 508B).

As shown in FIG. 15C, the process 1500 proceeds to step 1500C, where the lift conveyor 1002 raises the first and second cases 702A, 702B inserted in the first and second carriers 508A, 508B upwards towards the buffer conveyor 1010, which is elevated above the outbound conveyor 1000. In the illustrated example of FIG. 15C, the upward movement of the lift conveyor 1002 and first and second cases 702A, 702B inserted in the first and second carriers 508A, 508B is indicated by an upward facing arrow. In some examples, the controller 204 controls one or more motors, actuators, and/or other components in the outbound system 104 to raise the lift conveyor 1002.

As shown in FIG. 15D, the process 1500 proceeds to step 1500D, where the first case 702A inserted in the first carrier 508A is transferred to the buffer conveyor 1010. For example, the controller 204 controls the lift conveyor 1002 to convey the first case 702A inserted in the first carrier 508A onto the buffer conveyor 1010. Although described as a conveyor, in some examples, the buffer conveyor 1010 can be implemented as some other type of staging area such as, but not limited to, a platform. At the end of step 1500D, the first case inserted 702A inserted in the first carrier 508A is supported on the buffer conveyor 1010 and the second case 702B inserted in the second carrier 508B is supported on the lift conveyor 1002.

As shown in FIG. 15E, the process 1500 proceeds to step 1500E, where the lift conveyor 1002 lowers the second case 702B inserted in the second carrier 508B back to the lowered position (e.g., to the height of the outbound conveyor 1000). For example, the controller 204 controls one or more motors, actuators, and/or other components in the outbound system 104 to lower the lift conveyor 1002.

As shown in FIG. 15F, the process 1500 proceeds to step 1500F, where the second case 702B inserted in the second carrier 508B is transported away. For example, the controller 204 controls the lift conveyor 1002 and/or the outbound conveyor 1000 to convey the second case 702B inserted in the second carrier 508B away such that the leak associated with the second case 702B can be handled. By leaving the second case 702B inserted in the second carrier 508B as the second case 702B moves along the outbound conveyor 1000, operators can quickly and easily determine that a leak associated with the second case 702B is occurring. As also shown in FIG. 15F, the first case 702A inserted in the first carrier 508A remains on the buffer conveyor 1010.

As shown in FIG. 15G, the process 1500 proceeds to step 1500G, where the where the lift conveyor 1002 raises upwards towards the buffer conveyor 1010. In the illustrated example of FIG. 15G, the upward movement of the lift conveyor 1002 is indicated by an upward facing arrow. In some examples, the controller 204 controls one or more motors, actuators, and/or other components in the outbound system 104 to raise the lift conveyor 1002.

As shown in FIG. 15H, the process 1500 proceeds to step 1500H where the first case 702A inserted in the first carrier 508A is retrieved from the buffer conveyor 1010. For example, the first case inserted in the first carrier 508A is moved from the buffer conveyor 1010 back to the lift conveyor 1002. In the illustrated example of FIG. 15H, movement of the first case 702A inserted in the first carrier 508A is indicated by the rightward facing arrow. In some examples, the controller 204 controls the buffer conveyor 1010 and/or the lift conveyor 1002 to transfer, or convey, the first case 702A inserted in the first carrier 508A form the buffer conveyor 1010 to the lift conveyor 1002.

As shown in FIG. 15I, the process 1500 proceeds to step 1500I, where the lift conveyor 1002 lowers the first case 702A inserted in the first carrier 508A back to the lowered position (e.g., to the height of the outbound conveyor 1000). For example, the controller 204 controls one or more motors, actuators, and/or other components in the outbound system 104 to lower the lift conveyor 1002. As further shown in FIG. 15I, a third case 702C inserted, or disposed, in a third carrier 508C is transported along the inbound conveyor 1202 towards the lift conveyor 1002. In some examples, the controller 204 controls the inbound conveyor 1202 to convey the third case 702C inserted in the third carrier 508C towards the lift conveyor 1002.

As shown in FIG. 15J, the process 1500 proceeds to step 1500J, where the lift conveyor 1002 receives the third case 702C inserted in the third carrier 508C from the inbound conveyor 1202. At the completion of step 1500J, the first case 702A inserted in the first carrier 508A is disposed at a first position on the lift conveyor 1002 underneath the first grip assembly 1006A and the third case 702C inserted in the third carrier 508C is disposed at a second position on the lift conveyor 1002 underneath the second grip assembly 1006B. In some examples, the controller 204 controls the lift conveyor 1002 to position the first and third cases 702A, 702C underneath the first and second grip assemblies 1006A, 1006B.

Further at the completion of step 1500J, new sensor data can be generated by the first and/or second leak sensors 1008A, 1008B. If the controller 204 determines, based on the newly generated sensor data received from the first and/or second leak sensors 1008A, 1008B, that no leaks associated with the first and/or third cases 702A, 702C are occurring, the controller 204 can proceed with implementing one or more of the carrier-to-case processes described herein (e.g., process 1200, process 1300, method 1400, etc.) to remove the first and third cases 702A, 702C from the first and third carriers 508A, 508C.

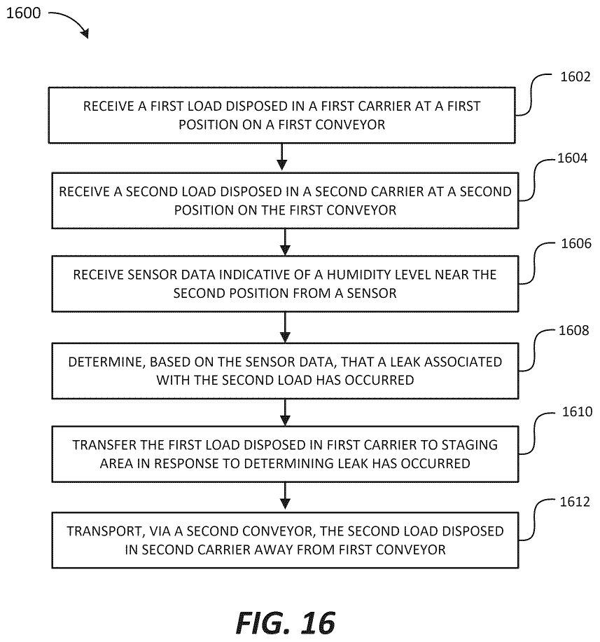

FIG. 16 is a flow diagram of method steps for an example leak detection process, according to the present teachings. Although the method steps are described in conjunction with the systems of FIGS. 1-15J, persons skilled in the art will understand that any system configured to perform the method steps, in any order, is within the scope of the present disclosure. For example, although the method of FIG. 16 is described and illustrated as using two leak sensors 1008A, 1008B, in other examples, the method of FIG. 16 can be implemented using less than or more than two leak sensors.

As shown, a method 1600 begins at step 1602, at which a first load disposed in a first carrier is received at a first position on a first conveyor. For example, the controller 204 controls the lift conveyor 1002 to convey a first case 702A inserted in the first carrier 508A received from the inbound conveyor 1202 to a first position on the lift conveyor 1002. The first position can be, for example, a leading position on the lift conveyor 1002 that corresponds to the position of the first leak sensor 1008A and/or the first grip assembly 1006A.

At step 1604, a second load disposed in a second carrier is received at a second position on the first conveyor. For example, the controller 204 controls the lift conveyor 1002 to convey a second case 702B inserted in the second carrier 508B received from the inbound conveyor 1202 to a second position on the lift conveyor 1002. The second position can be, for example, a trailing position that is behind the first position on the lift conveyor 1002. In some examples, the second position corresponds to the position of the second leak sensor 1008B and/or the second grip assembly 1006B.

At step 1606, sensor data indicative of a humidity level near the second position is received from a sensor. For example, the controller 204 receives sensor data generated by the second leak sensor 1008B.

At step 1608, it is determined, based on the sensor data, that a leak associated with the second load has occurred. For example, the controller 204 determines that a leak associated with the second case 702B has occurred responsive to determining that the humidity level indicated by the sensor data exceeds a threshold.

At step 1610, the first load disposed in the first carrier is transferred to a staging area in response to determining that the leak has occurred. For example, the controller 204 controls the lift conveyor 1002 to transfer the first case 702A disposed in the first carrier 508A onto the buffer conveyor 1010.

At step 1612, the second load disposed in the second carrier is transported away from the first conveyor via a second conveyor. For example, the controller 204 controls the outbound conveyor 1000 and/or lift conveyor 1002 to transport the second case 702B disposed in the second carrier 508B away from the lift conveyor 1002.

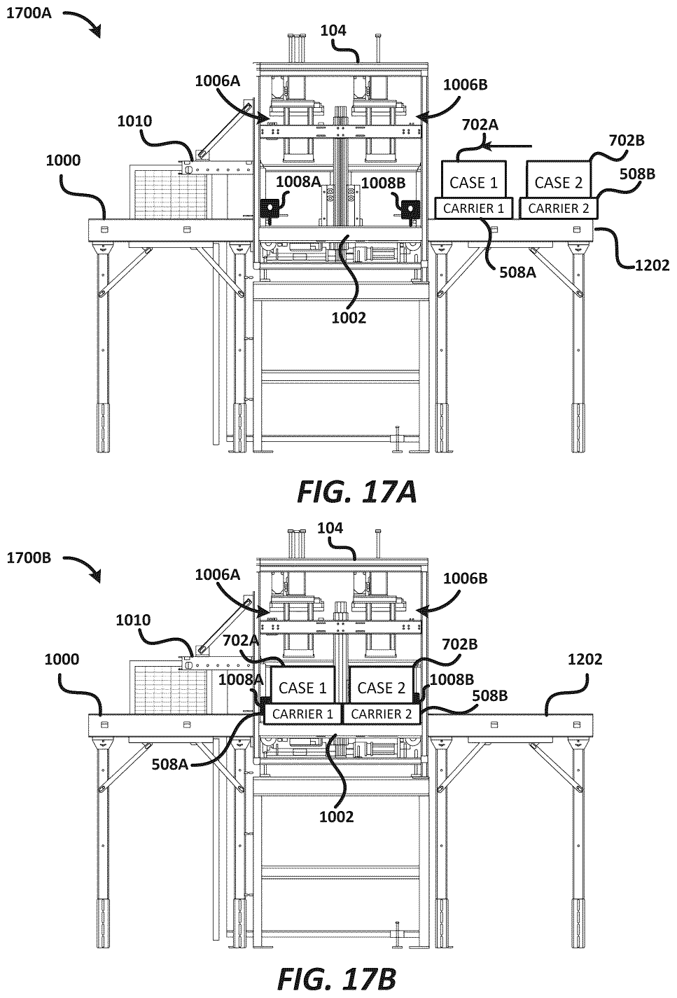

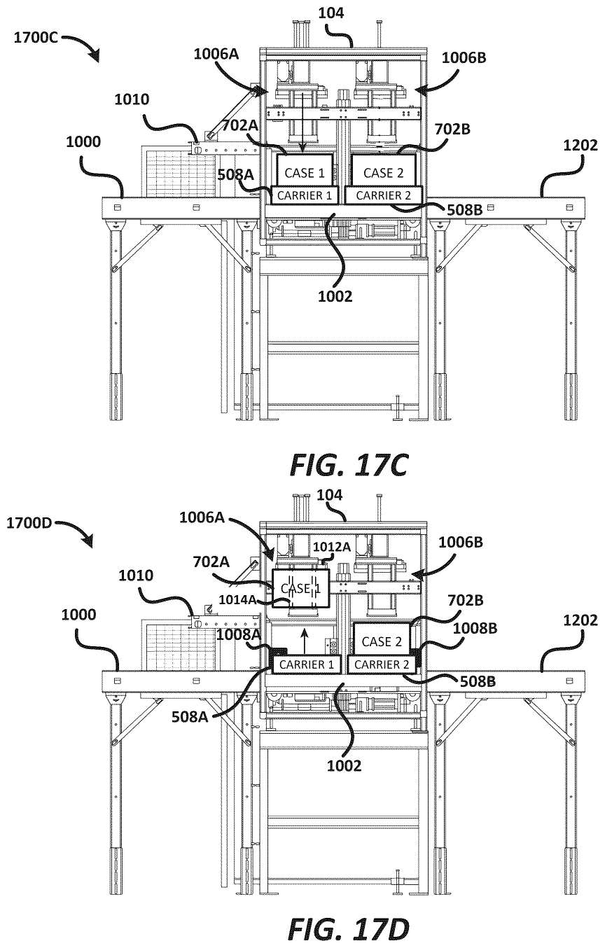

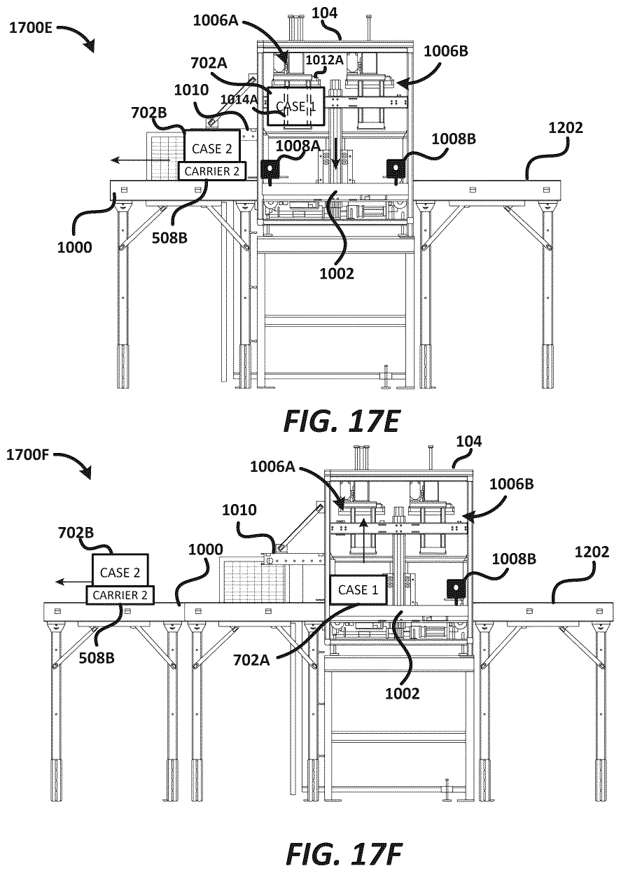

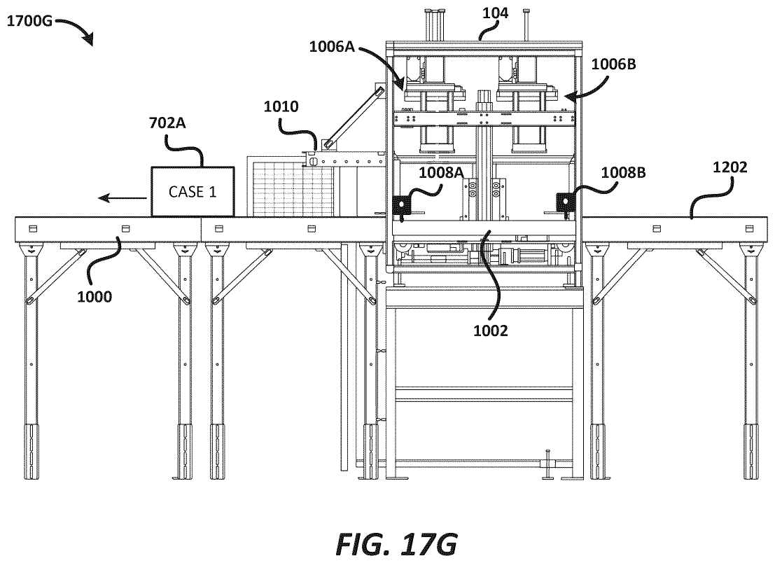

FIGS. 17A-17G illustrate an example leak detection process 1700, according to the present teachings. Although the steps in process 1700 are described in conjunction with the outbound system 104 and/or other systems of FIGS. 1-17G, persons skilled in the art will understand that any system configured to perform the method steps, in any order, is within the scope of the present disclosure. For example, although the process 1700 is described and illustrated as using two leak sensors 1008A, 1008B, in other examples, the process 1700 can be implemented using less than or more than two leak sensors. As another example, although the process 1700 is described and illustrated as using the first and second grip assemblies 1006A, 1006B, which include vacuum pads 1012A, 1012B and clamps 1014A, 1014B respectively, in other examples, process 1700 can be implemented using other types of grip assemblies that do not include vacuum pads, do not include clamps, and/or include one or more other types of gripping devices adapted to grip and hold a case.

As shown in FIG. 17A, the process 1700 begins with step 1700A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 17B, the process 1700 proceeds to step 1700B, where the first and second cases 702A, 702B inserted in the first and second carriers 508A, 508B are transferred from the inbound conveyor 1202 onto the lift conveyor 1002. In the illustrated example of FIG. 17B, the first case 702A inserted in the first carrier 508A is transferred to a first position on the lift conveyor 1002 that is nearby, or within a sensing range of, the first leak sensor 1008A and the second case 702B inserted in the second carrier 508B is transferred to a second position on the lift conveyor 1002 that is nearby, or within a sensing range of, the second leak sensor 1008B. In some examples, the controller 204 can control one or more blade stops to raise through rollers in the lift conveyor 1002 when positioning the first and second cases 702A, 702B inserted in the first and second carriers 508A, 508B near the first and second leak detection sensors 1008A, 1008B.

Further at step 1700B, the first leak sensor 1008A generates sensor data indicative of the moisture and/or humidity levels associated with the first case 702A inserted in the first carrier 508A and the second leak sensor 1008B generates sensor data indicative of the moisture and/or humidity levels associated with the second case 702B inserted in the second carrier 508B. The controller 204 receives the sensor data from the first and second leak sensors 1008A, 1008B and determines, based on the received sensor data, whether the first case 702A and/or the second case 702B is experiencing a leak.

In the illustrated example of FIG. 17B, the controller 204 determines, based on the sensor data received from the first and second leak sensors 1008A, 1008B, that a leak associated with the second case 702B has occurred. Further in the illustrated example of FIG. 17B, the controller 204 determines, based on the sensor data received from the first and second leak sensors 1008A, 1008B, that there is no leak associated with the first case 702A. In that regard, in the illustrated example of FIG. 17B, the controller 204 determines that the leading case (e.g., first case 702A) is not experiencing a leak while the trailing case (e.g., second case 702B) is experiencing a leak.

Responsive to determining that the leading case (e.g., first case 702A) is not experiencing a leak and the trailing case (e.g., second case 702B) is experiencing a leak, the subsequent steps 17C-17G in the process 1700 are preformed to remove the leading case (e.g., first case 702A) from the corresponding carrier (e.g., first carrier 508A) and push the trailing case (e.g., second case 702B) through the outbound system 104 without removing the trailing case from the corresponding carrier (e.g., the second carrier 508B).

As shown in FIG. 17C, the process 1700 proceeds to step 1700C, where the first grip assembly 1006A is lowered towards the first case 702A inserted in the first carrier 702A positioned on the lift conveyor 1002. In the illustrated example of FIG. 17C, the downward movement of the first grip assembly 1006A is indicated by a downward facing arrow. In some examples, the controller 204 controls one or more motors, actuators, and/or other components in the outbound system 104 to lower the first grip assembly 1006A.

As shown in FIG. 17D, the process 1700 proceeds to step 1700D, where the first grip assembly 1006A engages and grips the first case 702A and subsequently travels upwards to raise the first case 702A above the lift conveyor 1002, thereby removing the first case 702A from the first carrier 508A. In the illustrated example of FIG. 17D, the vacuum pad 1012A and the clamps 1014A engage and grip the first case 702A. In some examples, the controller 204 controls the first grip assembly 1006A to engage and grip the first case 702A (e.g., controls the vacuum pad 1012A to apply suction force and/or the clamps 1014A to apply a gripping force) and controls one or more motors, actuators, and/or other components in the outbound system 104 to raise the first grip assembly 1006A holding the first case 702A.

As shown in FIG. 17E, the process 1700 proceeds to step 1700E, where the empty first carrier 508A is transferred from the lift conveyor 1002 onto the carrier transfer conveyor 1004. For example, the controller 1204 controls the lift conveyor 1002 to transfer the empty first carrier 508A onto the carrier transfer conveyor 1004, which provides the empty first carrier 508A to the carrier transfer system 106 for reuse by the inbound system 102.

As further shown in FIG. 17E, at step 1700E, the second case 702B inserted in the second carrier 508B is transported away. For example, the controller 204 controls the lift conveyor 1002 and/or the outbound conveyor 1000 to convey the second case 702B inserted in the second carrier 508B away such that the leak associated with the second case 702B can be handled. By leaving the second case 702B inserted in the second carrier 508B as the second case 702B moves along the outbound conveyor 1000, operators can quickly and easily determine that a leak associated with the second case 702B is occurring. As also shown in FIG. 17E, the first case 702A remains held above the lift conveyor 1002 by the first grip assembly 1006A. However, in some examples, the first case 702A can be lowered and/or placed back onto the lift conveyor 1002 prior to transporting the second case 702A inserted in the second carrier 508B away.

As further shown in FIG. 17E, at step 1700E, the first grip assembly 1006A lowers the first case 702A downward towards the lift conveyor 1006. In the illustrated example of FIG. 17F, the downward movement of the first grip assembly 1006A holding the first case 702A is indicated by a downward facing arrow. In some examples, the controller 204 controls one or more motors, actuators, and/or other components in the outbound system 104 to lower the first grip assembly 1006A holding the first case 702A.).

As shown in FIG. 17F, at step 1700F, where the first grip assembly 1006A disengages, or releases, the first case 702A, thereby placing the first case onto the lift conveyor 1002. For example, the controller 204 controls the first grip assembly 1006A to release the first case 702A (e.g., shut off the vacuum pad 1012A and/or control the clamps 1014A to release the first case 702A). As further shown in FIG. 17F, at step 1700G, the first grip assembly 1006A raises to the elevated position after disengaging, or releasing, the first case 702A. For example, the controller 204 controls one or more motors, actuators, and/or other components in the outbound system 104 to raise the first grip assembly 1006A.

As shown in FIG. 17G, the process 1700 proceeds to step 1700G where the first case 702A is transported away for further handling. In the illustrated example of FIG. 17G, the lift conveyor 1002 and an outbound conveyor 1000 convey the first case 702A away. In some examples, the controller 204 controls the lift conveyor 1002 and/or the outbound conveyor 1000 to convey the first case 702A away.

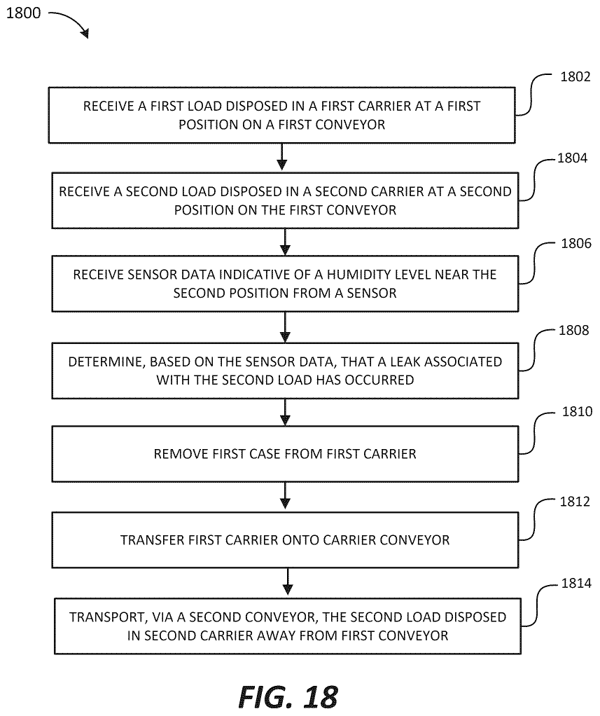

FIG. 18 is a flow diagram of method steps for another example leak detection process, according to the present teachings. Although the method steps are described in conjunction with the systems of FIGS. 1-17G, persons skilled in the art will understand that any system configured to perform the method steps, in any order, is within the scope of the present disclosure. For example, although the method of FIG. 18 is described and illustrated as using two leak sensors 1008A, 1008B, in other examples, the method of FIG. 18 can be implemented using less than or more than two leak sensors. As another example, although the method of FIG. 18 is described and illustrated as using the first and second grip assemblies 1006A, 1006B, which include vacuum pads 1012A, 1012B and clamps 1014A, 1014B respectively, in other examples, the method of FIG. 18 can be implemented using other types of grip assemblies that do not include vacuum pads, do not include clamps, and/or include one or more other types of gripping devices adapted to grip and hold a case.

As shown, a method 1800 begins at step 1802, at which a first load disposed in a first carrier is received at a first position on a first conveyor. For example, the controller 204 controls the lift conveyor 1002 to convey a first case 702A inserted in the first carrier 508A received from the inbound conveyor 1202 to a first position on the lift conveyor 1002. The first position can be, for example, a leading position on the lift conveyor 1002 that corresponds to the position of the first leak sensor 1008A and/or the first grip assembly 1006A.

At step 1804, a second load disposed in a second carrier is received at a second position on the first conveyor. For example, the controller 204 controls the lift conveyor 1002 to convey a second case 702B inserted in the second carrier 508B received from the inbound conveyor 1202 to a second position on the lift conveyor 1002. The second position can be, for example, a trailing position that is behind the first position on the lift conveyor 1002. In some examples, the second position corresponds to the position of the second leak sensor 1008B and/or the second grip assembly 1006B.

At step 1806, sensor data indicative of a humidity level near the second position is received from a sensor. For example, the controller 204 receives sensor data generated by the second leak sensor 1008B.

At step 1808, it is determined, based on the sensor data, that a leak associated with the second load has occurred. For example, the controller 204 determines that a leak associated with the second case 702B has occurred responsive to determining that the humidity level indicated by the sensor data exceeds a threshold.

At step 1810, the first load is removed from the first carrier in response to determining that the leak has occurred. For example, the controller 204 controls the lift conveyor 1002 and/or the first grip assembly 1006 to remove the first case 702A from the first carrier 508A.

At step 1812, the first carrier is transferred onto a carrier conveyor. For example, the controller 204 controls the lift conveyor 1002 to transfer the first carrier 508A onto the carrier transfer conveyor 1004.

At step 1814, the second load disposed in the second carrier is transported away from the first conveyor via a second conveyor. For example, the controller 204 controls the outbound conveyor 1000 to transport the second case 702B disposed in the second carrier 508B away from the lift conveyor 1002.

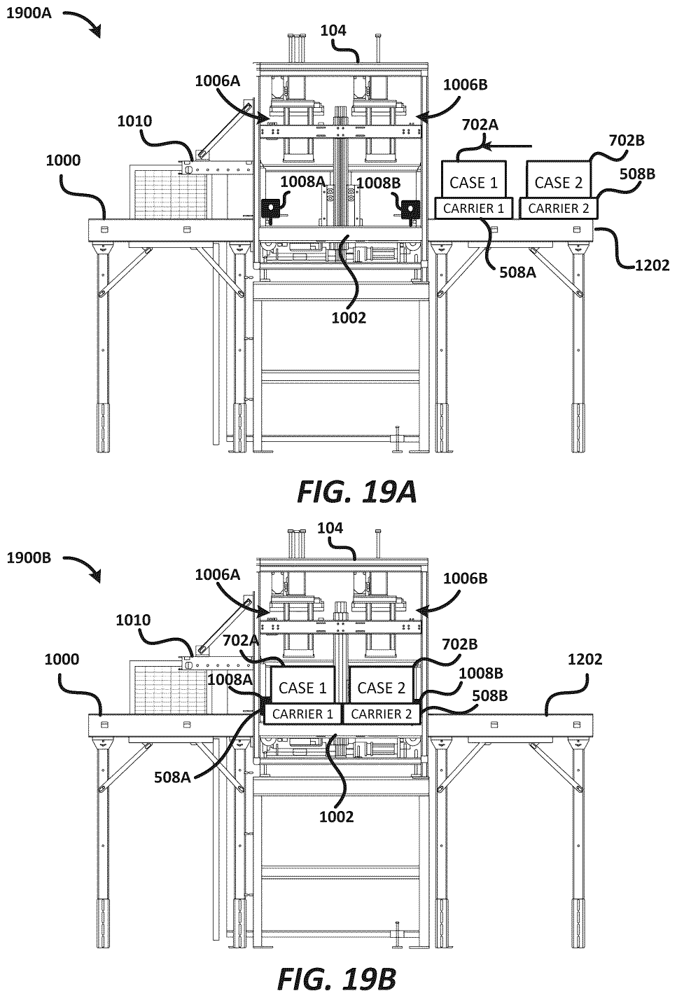

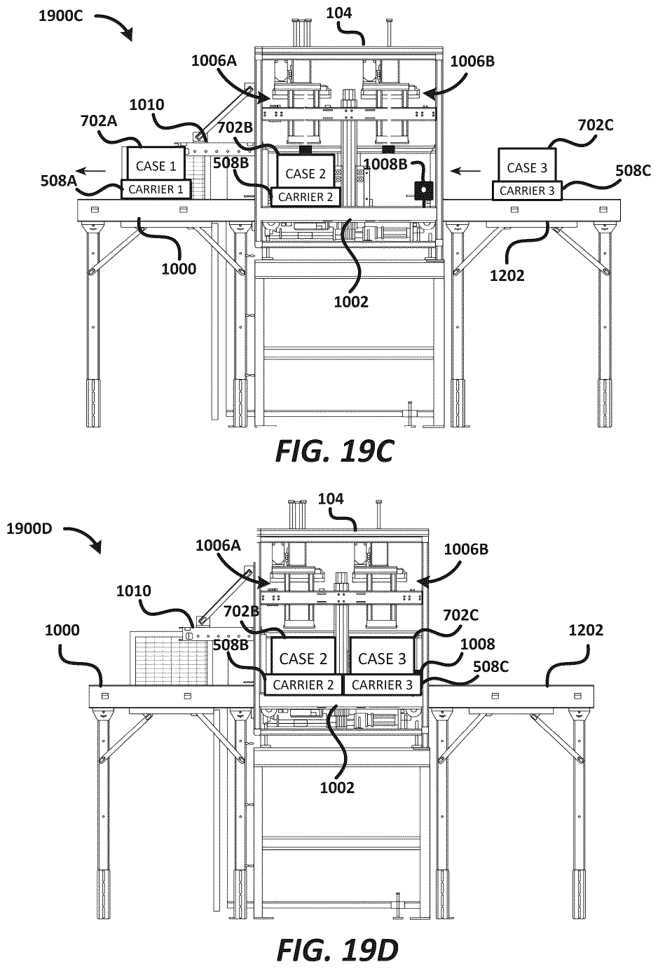

FIGS. 19A-19D illustrate another example leak detection process 1900, according to the present teachings. Although the steps in process 1900 are described in conjunction with the outbound system 104 and/or other systems of FIGS. 1-19D, persons skilled in the art will understand that any system configured to perform the method steps, in any order, is within the scope of the present disclosure. For example, although the process 1900 is described and illustrated as using two leak sensors 1008A, 1008B, in other examples, the process 1900 can be implemented using less than or more than two leak sensors.

As shown in FIG. 19A, the process 1900 begins with step 1900A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 19B, the process 1900 proceeds to step 1900B, where the first and second cases 702A, 702B inserted in the first and second carriers 508A, 508B are transferred from the inbound conveyor 1202 onto the lift conveyor 1002. In the illustrated example of FIG. 19B, the first case 702A inserted in the first carrier 508A is transferred to a first position on the lift conveyor 1002 that is nearby, or within a sensing range of, the first leak sensor 1008A and the second case 702B inserted in the second carrier 508B is transferred to a second position on the lift conveyor 1002 that is nearby, or within a sensing range of, the second leak sensor 1008B. In some examples, the controller 204 can control one or more blade stops to raise through rollers in the lift conveyor 1002 when positioning the first and second cases 702A, 702B inserted in the first and second carriers 508A, 508B near the first and second leak detection sensors 1008A, 1008B.

Further at step 1900B, the first leak sensor 1008A generates sensor data indicative of the moisture and/or humidity levels associated with the first case 702A inserted in the first carrier 508A and the second leak sensor 1008B generates sensor data indicative of the moisture and/or humidity levels associated with the second case 702B inserted in the second carrier 508B. The controller 204 receives the sensor data from the first and second leak sensors 1008A, 1008B and determines, based on the received sensor data, whether the first case 702A and/or the second case 702B is experiencing a leak.

In the illustrated example of FIG. 19B, the controller 204 determines, based on the sensor data received from the first and second leak sensors 1008A, 1008B, that a leak associated with the first case 702A has occurred. Further in the illustrated example of FIG. 19B, the controller 204 determines, based on the sensor data received from the first and second leak sensors 1008A, 1008B, that there is no leak associated with the second case 702B. In that regard, in the illustrated example of FIG. 17B, the controller 204 determines that the leading case (e.g., first case 702A) is experiencing a leak while the trailing case (e.g., second case 702B) is not experiencing a leak.

Responsive to determining that the leading case (e.g., first case 702A) is experiencing a leak and the trailing case (e.g., second case 702B) is not experiencing a leak, the subsequent steps 19C-19D in the process 1900 are preformed to push the leading case (e.g., first case 702A) through the outbound system 104 without removing the leading case from the corresponding carrier (e.g., the first carrier 508A) and position the trailing case (e.g., second case 702B) for removal from the corresponding carrier (e.g., second carrier 508B) using a carrier-to-case process described herein (e.g., process 1200, process 1300, method 1400, etc.).

As shown in FIG. 19C, the process 1900 proceeds to step 1900C, where the first case 702A inserted in the first carrier 508A is transported away and the second case 702B inserted in the second carrier 508B is advanced to the first position on the lift conveyor 1002 previously occupied by the first case 702A inserted in the first carrier 508A. For example, the controller 204 controls the lift conveyor 1002 and/or the outbound conveyor 1000 to convey the first case 702A inserted in the first carrier 508A away such that the leak associated with the second case 702B can be handled. By leaving the first case 702A inserted in the first carrier 508A as the first case 702A moves along the outbound conveyor 1000, operators can quickly and easily determine that a leak associated with the first case 702A is occurring. Moreover, the controller 204 controls the lift conveyor 1002 to advance the second case 702B inserted in the second carrier 508B to the first position on the lift conveyor 1002 previously occupied by the first case 702A inserted in the first carrier 508A. In some examples, the controller 204 controls one or more blade stops that rise up through the lift conveyor 1002 to help position the second case 702B inserted in the second carrier 508B.

As further shown in FIG. 19C, as step 1900C, a third case 702C inserted, or disposed, in a third carrier 508C is transported along the inbound conveyor 1202 towards the lift conveyor 1002. In some examples, the controller 204 controls the inbound conveyor 1202 to convey the third case 702C inserted in the third carrier 508C towards the lift conveyor 1002.

As shown in FIG. 19D, the process 1900 proceeds to step 1900D, where the lift conveyor 1002 receives the third case 702C inserted in the third carrier 508C from the inbound conveyor 1202. At the completion of step 1900D, the second case 702B inserted in the second carrier 508B is disposed at the first position on the lift conveyor 1002 underneath the first grip assembly 1006A and the third case 702C inserted in the third carrier 508C is disposed at the second position on the lift conveyor 1002 underneath the second grip assembly 1006B. In some examples, the controller 204 controls the lift conveyor 1002 to position the second and third cases 702B, 702C underneath the first and second grip assemblies 1006A, 1006B. In some examples, the controller 204 can control one or more blade stops to raise through rollers in the lift conveyor 1002 when positioning the second and third cases 702B, 702C inserted in the second and third carriers 508B, 508C underneath the first and second grip assemblies 1006A, 1006B.

Further at the completion of step 1900D, new sensor data can be generated by the first and/or second leak sensors 1008A, 1008B. If the controller 204 determines, based on the newly generated sensor data received from the first and/or second leak sensors 1008A, 1008B, that no leaks associated with the second and/or third cases 702B, 702C are occurring, the controller 204 can proceed with implementing one or more of the carrier-to-case processes described herein (e.g., process 1200, process 1300, method 1400, etc.) to remove the second and third cases 702B, 702C from the second and third carriers 508B, 508C.

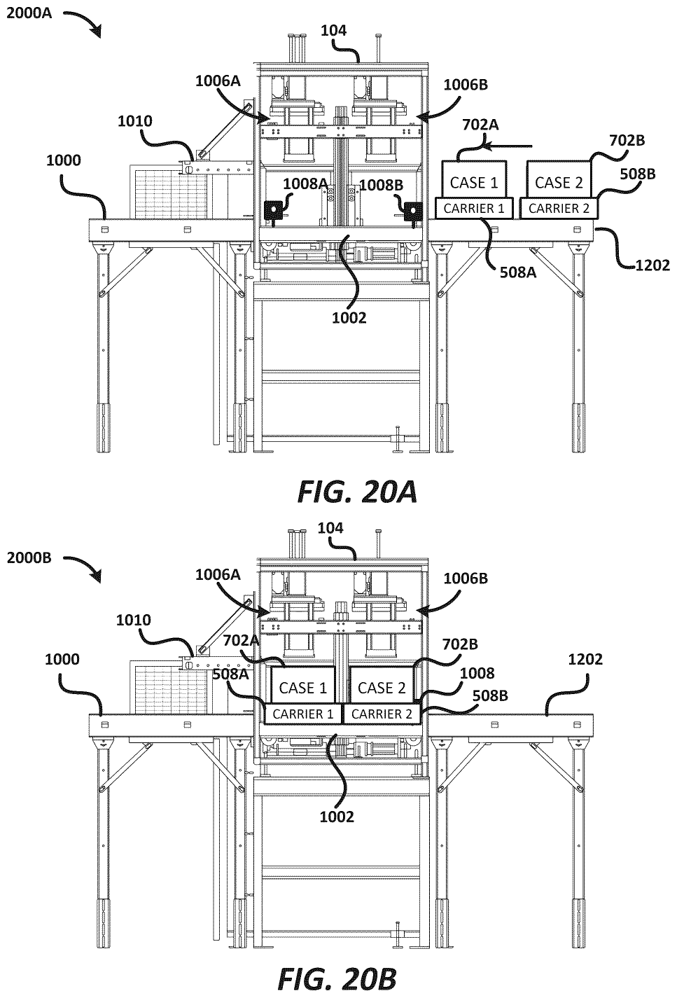

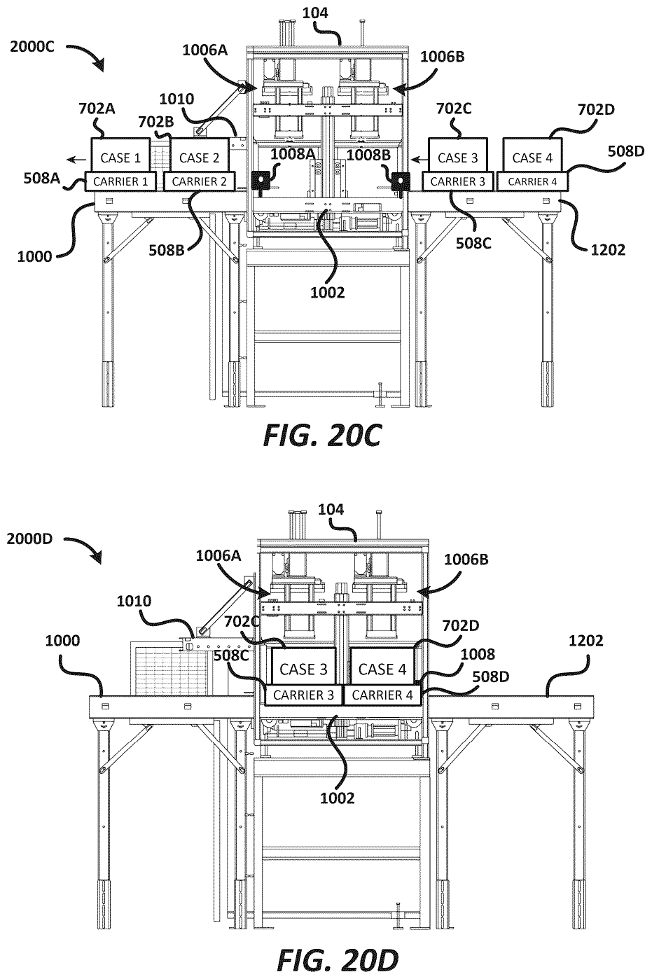

FIGS. 20A-20D illustrate another example leak detection process 2000, according to the present teachings. Although the steps in process 2000 are described in conjunction with the outbound system 104 and/or other systems of FIGS. 1-20D, persons skilled in the art will understand that any system configured to perform the method steps, in any order, is within the scope of the present disclosure. For example, although the process 2000 is described and illustrated as using two leak sensors 1008A, 1008B, in other examples, the process 2000 can be implemented using less than or more than two leak sensors.

As shown in FIG. 20A, the process 2000 begins with step 2000A at which first and second cases 702A, 702B inserted, or disposed, in first and second carriers 508A, 508B are transported along the inbound conveyor 1202 towards the lift conveyor 1002. In some examples, the controller 204 controls the inbound conveyor 1202 to convey the first and second cases 702A, 702B inserted in the first and second carriers 508A, 508B towards the lift conveyor 1002.

As shown in FIG. 20B, the process 2000 proceeds to step 2000B, where the first and second cases 702A, 702B inserted in the first and second carriers 508A, 508B are transferred from the inbound conveyor 1202 onto the lift conveyor 1002. In the illustrated example of FIG. 20B, the first case 702A inserted in the first carrier 508A is transferred to a first position on the lift conveyor 1002 that is nearby, or within a sensing range of, the first leak sensor 1008A and the second case 702B inserted in the second carrier 508B is transferred to a second position on the lift conveyor 1002 that is nearby, or within a sensing range of, the second leak sensor 1008B. In some examples, the controller 204 can control one or more blade stops to raise through rollers in the lift conveyor 1002 when positioning the first and second cases 702A, 702B inserted in the first and second carriers 508A, 508B near the first and second leak detection sensors 1008A, 1008B.

Further at step 2000B, the first leak sensor 1008A generates sensor data indicative of the moisture and/or humidity levels associated with the first case 702A inserted in the first carrier 508A and the second leak sensor 1008B generates sensor data indicative of the moisture and/or humidity levels associated with the second case 702B inserted in the second carrier 508B. The controller 204 receives the sensor data from the first and second leak sensors 1008A, 1008B and determines, based on the received sensor data, whether the first case 702A and/or the second case 702B is experiencing a leak.

In the illustrated example of FIG. 20B, the controller 204 determines, based on the sensor data received from the first and second leak sensors 1008A, 1008B, that a leak associated with the first case 702A has occurred. Further in the illustrated example of FIG. 20B, the controller 204 determines, based on the sensor data received from the first and second leak sensors 1008A, 1008B, that a leak associated with the second case 702B has occurred. In that regard, in the illustrated example of FIG. 20B, the controller 204 determines that the leading case (e.g., first case 702A) and the trailing case (e.g., second case 702B) are experiencing leaks.

Responsive to determining that the leading case (e.g., first case 702A) is experiencing a leak and the trailing case (e.g., second case 702B) is experiencing a leak, the subsequent steps 20C-20D in the process 2000 are preformed to push the leading case (e.g., first case 702A) and the trailing case (e.g., second case 702B) through the outbound system 104 without removing the leading and trailing cases from the corresponding carriers (e.g., the first carrier 508A and the second carrier 508B).

As shown in FIG. 20C, the process 2000 proceeds to step 2000C, where the first case 702A inserted in the first carrier 508A and the second case 702A inserted in the second carrier 508B are transported away. For example, the controller 204 controls the lift conveyor 1002 and/or the outbound conveyor 1000 to convey the first case 702A inserted in the first carrier 508A and the second case 702B inserted in the second case 508B away such that the leaks associated with the first and second cases 702A, 702B can be handled. By leaving the first case 702A inserted in the first carrier 508A and the second case 702B inserted in the second carrier 508B as the first and second cases 702A, 702B move along the outbound conveyor 1000, operators can quickly and easily determine that leaks associated with the first and second cases 702A, 702B are occurring.

As further shown in FIG. 20C, as step 2000C, third and fourth cases 702C, 702D inserted, or disposed, in third and fourth carriers 508C, 508D are transported along the inbound conveyor 1202 towards the lift conveyor 1002. In some examples, the controller 204 controls the inbound conveyor 1202 to convey the third and fourth cases 702C, 702D inserted, or disposed, in third and fourth carriers 508C, 508D towards the lift conveyor 1002.

As shown in FIG. 20D, the process 2000 proceeds to step 2000D, where the third and fourth cases 702C, 702D inserted, or disposed, in third and fourth carriers 508C, 508D are transferred from the inbound conveyor 1202 onto the lift conveyor 1002. In the illustrated example of FIG. 20D, the third case 702C inserted in the third carrier 508C is transferred to the first position on the lift conveyor 1002 that is nearby, or within a sensing range of, the first leak sensor 1008A and the fourth case 702D inserted in the third carrier 508D is transferred to the second position on the lift conveyor 1002 that is nearby, or within a sensing range of, the second leak sensor 1008B. In some examples, the controller 204 can control one or more blade stops to raise through rollers in the lift conveyor 1002 when positioning the third and fourth cases 702C, 702D inserted in third and fourth carriers 508C, 508D near the first and second leak detection sensors 1008A, 1008B.

At the completion of step 2000D, new sensor data can be generated by the first and/or second leak sensors 1008A, 1008B. If the controller 204 determines, based on the newly generated sensor data received from the first and/or second leak sensors 1008A, 1008B, that no leaks associated with the third and/or fourth cases 702C, 702D are occurring, the controller 204 can proceed with implementing one or more of the carrier-to-case processes described herein (e.g., process 1200, process 1300, method 1400, etc.) to remove the third and fourth cases 702C, 702D from the third and fourth carriers 508C, 508D.

### Carrier Transfer System

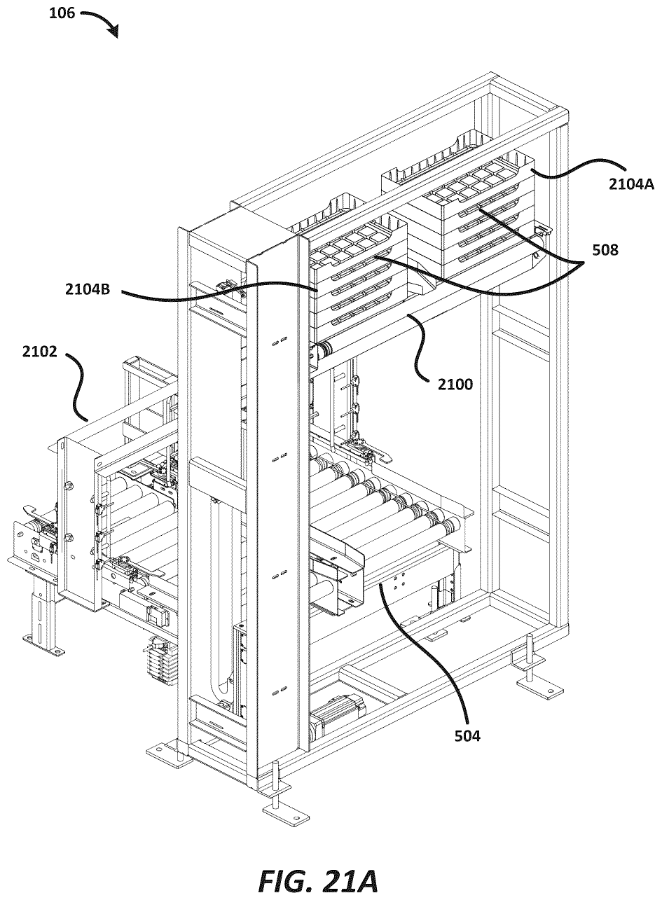

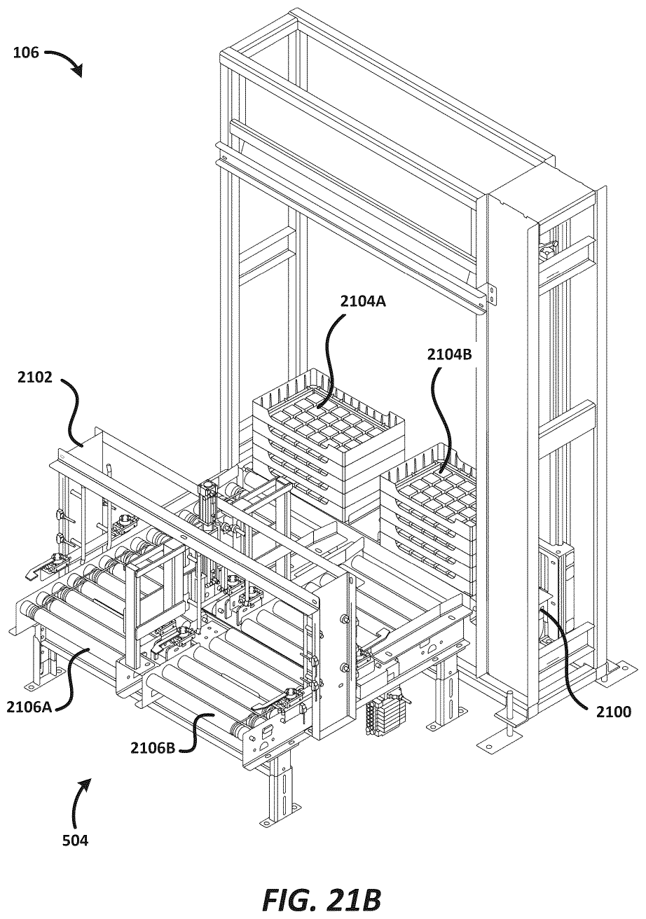

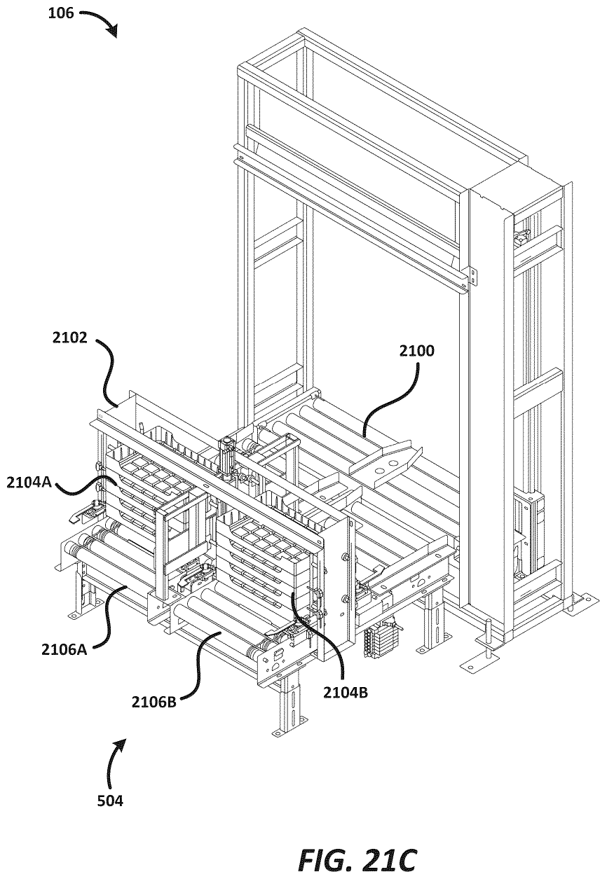

As described herein, the CHS 100 further includes a carrier transfer system 106 adapted to transfer carriers 508 from the outbound system 104 to the inbound system 102 for reuse. FIGS. 21A-21C illustrate various perspective views of the carrier transfer system 106, according to the present teachings.

With reference to FIG. 21A, the carrier transfer system 106 includes an elevator 2100 and a destacking system 2102. In addition, the carrier transfer system 106 can include and/or operate in conjunction with the carrier infeed conveyor 504 described herein with respect to the inbound system 102. Moreover, although not shown in the illustrated example of FIG. 21A, the carrier transfer system 106 can also include and/or operate in conjunction with the carrier transfer conveyor 1004.

As will be described in more detail herein, the elevator 2100 is adapted to be raised and lowered (e.g., via one or more motors, actuators, etc.) for transferring empty carriers 508 from the outbound system 104 to the inbound system 102. For example, the elevator 2100 can be raised to an elevated position (see FIG. 21A) to receive, via the carrier transfer conveyor 1004, one or more stacks of empty carriers 508 and lowered to a lowered position (see FIG. 21B) to deliver, via the carrier infeed conveyor 504 and/or the destacking system 2102, the empty carriers 508 to the inbound system 102.

In the illustrated examples of FIGS. 21A-21C, the elevator 2100 is shown to transfer first and second stacks 2104A, 2014B of empty carriers 508 from the outbound system 104 to the inbound system 102 at a given time. However, in some examples, the elevator 2100 may only transfer a single stack of empty carriers 508 from the outbound system 104 to the inbound system 102 at a given time. In other examples, the elevator 2100 can transfer more than two stacks of carriers 508 from the outbound system 104 to the inbound system 102 at a given time. Moreover, although the first and second stacks 2104A, 2104B are shown as including five carriers 508 each, in other examples, the first and second stacks 2104A, 2014B can include less than (e.g., 2, 3, or 4) or more than (e.g., 5, 6, 7, etc.) five carriers 508.

In some examples, the elevator 2100 can receive carriers 508 that are already arranged in stacks (e.g., the first and second stacks 2104A, 2104B). In other examples, the elevator 2100 can receive carriers 508 from the carrier transfer conveyor 1004 that have yet to be stacked (e.g., one at a time and/or two at a time).

When the elevator 2100 travels to the lowered position (see FIG. 21B) after receiving the first and second stacks 2104A, 2104B from the carrier transfer conveyor 1004, the elevator 2100 can transfer, or convey, the stack(s) of carriers 508 onto the carrier infeed conveyor 504. For example, the controller 204 can control the elevator 2100 to transfer a first stack 2104A of carriers 508 onto a first lane 2106A of the carrier infeed conveyor 504 and/or control the elevator 2100 to transfer a second stack 2104B of carriers 508 onto a second lane 2106B of the carrier infeed conveyor 504. Although the carrier infeed conveyor 504 is shown and described herein as including first and second lanes 2106A, 2106B, in some examples, the carrier infeed conveyor 504 includes only a single conveyor lane or can include more than two (e.g., 3, 4, 5, etc.) conveyor lanes.

With reference to FIG. 21C, after the first and second stacks 2104A, 2104B have been transferred onto the carrier infeed conveyor 504, the carrier infeed conveyor 504 can move, or convey, the first and second stacks 2104A, 2104B to the destacking system 2102. For example, the first lane 2106A conveys the first stack 2104A of carriers 508 to the destacking system 2102 and the second lane 2106B conveys the second stack 2104B of carriers 508 to the destacking system 2102.

As will be described in more detail herein, the destacking system 2102 is adapted to remove individual carriers 508 from the first and/or second stacks 2104A, 2104B and provide the individual carriers 508 to the inbound system 102. For example, the destacking system 2102 can remove a carrier 508 (e.g., the first carrier 508A) from the first stack 2104A and transfer, via the first lane 2106A of the carrier infeed conveyor 504, the carrier 508 onto the lift conveyor 502. Then, as described herein, the inbound system 102 can insert a case (e.g., the first case 702A) into the carrier 508. As another example, the destacking system 2102 can remove a carrier 508 (e.g., the second carrier 508B) from the second stack 2104B and transfer, via the second lane 2106B of the carrier infeed conveyor 504, the carrier 508 onto the lift conveyor 502. Then, as described herein, the inbound system 102 can insert a case (e.g., the second case 702B) into the carrier 508.

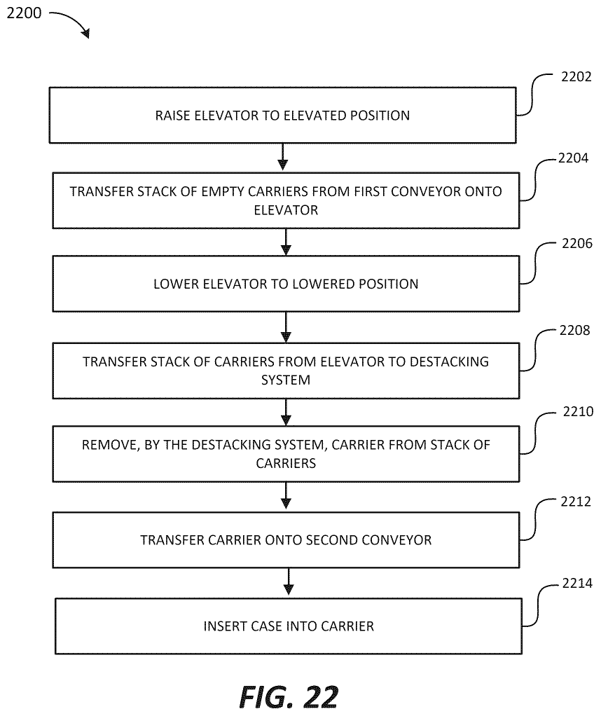

FIG. 22 is a flow diagram of method steps for an example carrier transfer process, according to the present teachings. Although the method steps are described in conjunction with the systems of FIGS. 1-21C, persons skilled in the art will understand that any system configured to perform the method steps, in any order, is within the scope of the present disclosure.

As shown, a method 2200 begins at step 2202, at which an elevator is raised to an elevated position. For example, the controller 204 controls the elevator 2100 to raise to an elevated position next to the carrier transfer conveyor 1004.

At step 2204, a stack of empty carriers is transferred from a first conveyor onto the elevator. For example, the controller 204 controls the carrier transfer conveyor 1004 to transfer a first stack 2104A of carriers 508 onto the elevator 2100.

At step 2206, the elevator is lowered to a lowered position. For example, the controller 204 controls the elevator 2100 to lower to a lowered position next to the carrier infeed conveyor 504.

At step 2208, the stack of empty carriers is transferred to a destacking system. For example, the controller 204 controls the first lane 2106A of the carrier infeed conveyor 504 to transfer a first stack 2014A of empty carriers 508 from the elevator 2100 to the destacking system 2102.

At step 2210, the destacking system removes a carrier from the stack of carriers. For example, the controller 204 controls the destacking system 2102 to remove a first carrier 508A from the first stack 2104A of carriers 508.

At step 2212, the first carrier is transferred onto a second conveyor. For example, the controller 204 controls the first lane 2106A of the carrier infeed conveyor 504 to transfer the first carrier 508A onto the lift conveyor 502 included in the inbound system 102.

At step 2214, a case is inserted into the carrier. For example, the controller 204 controls one or more components of the inbound system 102 to insert the first case 702A into the first carrier 508A positioned on the lift conveyor 502.

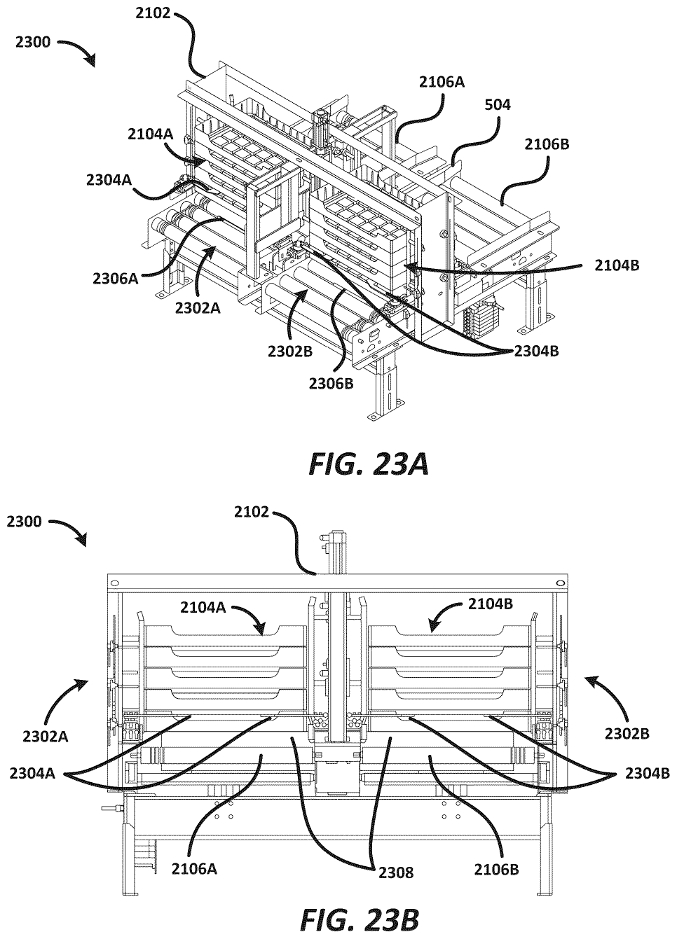

FIGS. 23A-27B illustrate an example destacking process implemented by the destacking system 2102, according to the present teachings. Although the steps in the destacking process are described in conjunction with the systems of FIGS. 1-27B, persons skilled in the art will understand that any system configured to perform the method steps, in any order, is within the scope of the present disclosure.

The destacking process begins with step 2300 shown in FIGS. 23A and 23B. FIG. 23A illustrates a perspective view of the destacking system 2102 during step 2300 and FIG. 23B illustrates a profile view of the destacking system 2102 during step 2300.

As shown in FIGS. 23A and 23B, the destacking system 2102 includes first and second destacking assemblies 2302A, 2302B that are adapted to destack, or remove carriers from, stacks of carriers 508 received via the carrier infeed conveyor 504. For example, the first destacking assembly 2302A is adapted to destack, or remove carriers 508 from, a first stack 2104A of carriers 508 received via the first lane 2106A of the carrier infeed conveyor 504. As another example, the second destacking assembly 2302B is adapted to destack, or remove carriers 508 from, a second stack 2104B of carriers 508 received via the second lane 2106B of the carrier infeed conveyor 504. As will be described in more detail herein, the first destacking assembly 2302A includes carrier arms 2304A and a blade stop 2306A and the second destacking assembly 2302B includes carrier arms 2304B and a blade stop 2306B. As shown in the FIG. 23B, the destacking system 2102 also includes a carrier stack lift 2308 that can be used by both the first and second destacking assemblies 2302A, 2302B. However, in some examples, each destacking assembly 2302 includes its own carrier stack lift 2308.

As shown in the illustrated examples of FIGS. 23A and 23B, when the destacking process begins, each of the first and second stacks 2104A, 2104B includes five carriers 508. However, in other examples, the first and second stacks 2104A, 2104B can include a different number of carriers 508 at the start of the destacking process.

At step 2300, the carrier stack lift 2308 moves to a middle position. While in the middle position, the carrier stack lift 2308 supports the bottom carrier 508 in each of the first and second stacks 2104A, 2104B. As further shown in FIGS. 23A and 23B, the carrier arms 2304A in the first destacking assembly 2302A rotate inward and are received in a slot formed between the bottom carrier 508 in the first stack 2104A and the carrier 508 that is second from the bottom in the first stack 2104A. Similarly, the carrier arms 2304B in the second destacking assembly 2302B rotate inward and are received in a slot formed between the bottom carrier 508 in the second stack 2104B and the carrier 508 that is second from the bottom in the second stack 2104B.

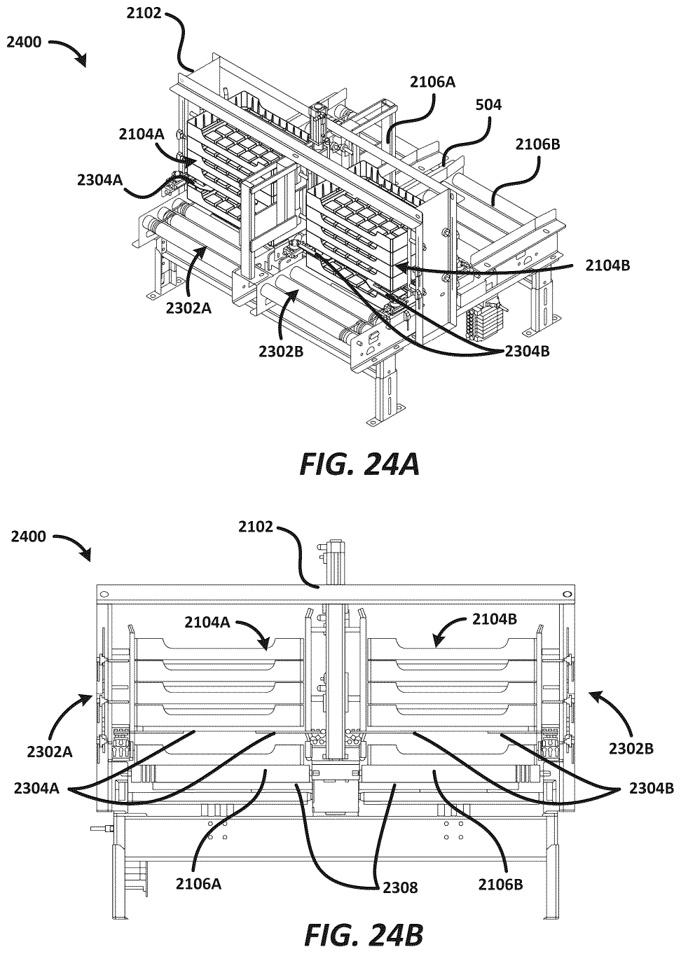

The destacking process continues with step 2400 shown in FIGS. 24A and 24B. FIG. 24A illustrates a perspective view of the destacking system 2102 during step 2400 and FIG. 24B illustrates a profile view of the destacking system 2102 during step 2400.

As shown in FIGS. 24A and 24B, at step 2400, the carrier stack lift 2308 lowers from the middle position to a bottom position. By lowering the carrier stack lift 2308 to the bottom position, the bottom carrier 508 in the first stack 2104A that is supported on the carrier stack lift 2308 is separated from the bottom of the first stack 2104A. As further shown in FIGS. 24A and 24B, at the conclusion of step 2400, the remaining carriers in the first stack 2104A (e.g., the carriers 508 positioned above the bottom carrier 508) are supported on the carrier arms 2304A above the bottom carrier 508 that was separated from the first stack 2104A. In some examples, step 2400 further includes lowering the blade stop 2306A.

Similarly, by lowering the carrier stack lift 2308 to the bottom position, the bottom carrier 508 in the second stack 2104B that is supported on the carrier stack lift 2308 is separated from the bottom of the second stack 2104B. As further shown in FIGS. 24A and 24B, at the conclusion of step 2400, the remaining carriers in the second stack 2104B (e.g., the carriers 508 positioned above the bottom carrier 508) are supported on the carrier arms 2304B above the bottom carrier 508 that was separated from the second stack 2104B. In some examples, step 2400 further includes lowering the blade stop 2306B.

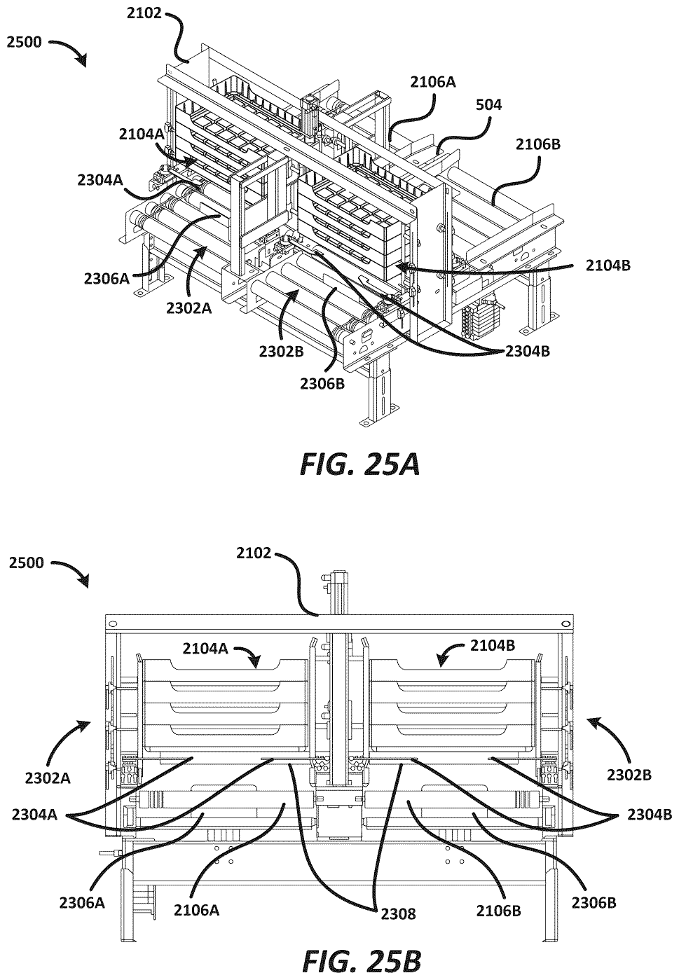

The destacking process continues with step 2500 shown in FIGS. 25A and 25B. FIG. 25A illustrates a perspective view of the destacking system 2102 during step 2500 and FIG. 25B illustrates a profile view of the destacking system 2102 during step 2500.

As shown in FIGS. 25A and 25B, at step 2500, the carrier 508 that was separated from the first stack 2104A in step 2400 is transferred from the first carrier destacking assembly 2302A onto the lift conveyor 502 of the inbound system 102. For example, following the lowering of the blade stop 2306A, the first lane 2106A of the carrier infeed conveyor 504 transfers, or conveys, the carrier 508 that was separated from the first stack 2104A onto the lift conveyor 502. Similarly, as shown in FIGS. 25A and 25B, at step 2500, the carrier 508 that was separated from the second stack 2104B in step 2400 is transferred from the second carrier destacking assembly 2302B onto the lift conveyor 502 of the inbound system 102. For example, following the lowering of the blade stop 2306B, the second lane 2106B of the carrier infeed conveyor 504 transfers, or conveys, the carrier 508 that was separated from the second stack 2104B onto the lift conveyor 502.

As further shown in FIGS. 25A and 25B, following the transfer of the carriers 508 separated from the first and second stacks 2104A, 2104B onto the lift conveyor 502, the carrier stack lift 2308 raises to a top position to lift the first and second stacks 2104A, 2104B off the carrier arms 2304A, 2304B. In that regard, at the conclusion of step 2500, the first and second stacks 2104A, 2104B are supported on the carrier stack lift 2308 positioned at the top position. In the illustrated example of FIGS. 25A and 25B, four carriers 508 remain in each of the first and second stacks 2104A, 2104B.

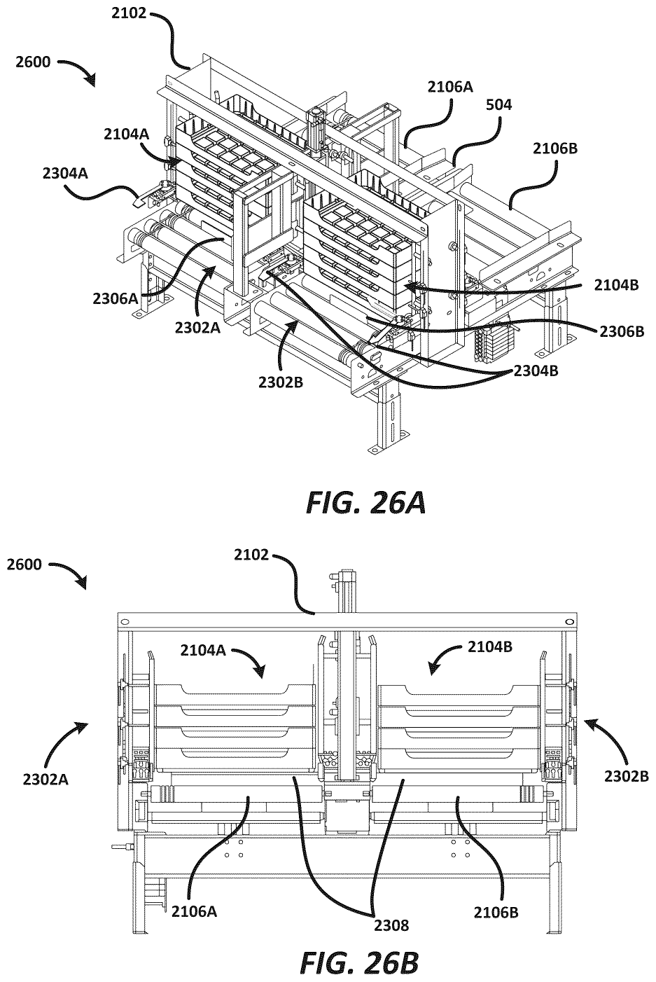

The destacking process continues with step 2600 shown in FIGS. 26A and 26B. FIG. 26A illustrates a perspective view of the destacking system 2102 during step 2600 and FIG. 26B illustrates a profile view of the destacking system 2102 during step 2600.

As shown in FIGS. 26A and 26B, at step 2600, the carrier arms 2304A, 2304B retract and the carrier stack lift 2308 lowers from the top position to the middle position. With the carrier arms 2304A, 2304B retracted, the lowering of the carrier stack lift 2308 from the top position to the middle position causes the first and second stacks 2104A, 2104B supported on the carrier stack lift 2308 to be lowered as well.

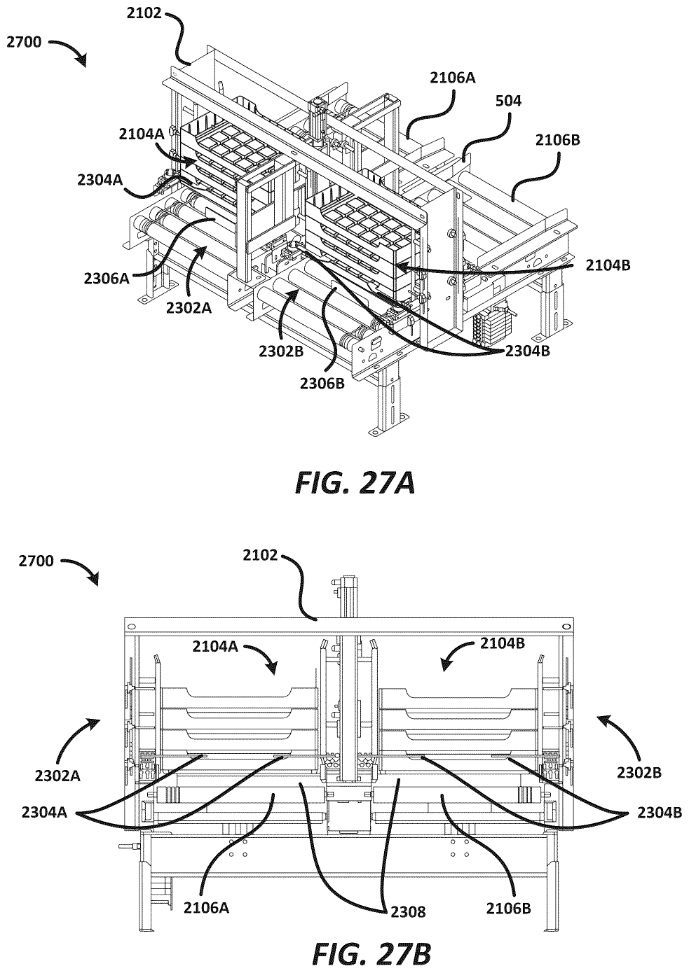

The destacking process continues with step 2700 shown in FIGS. 27A and 27B. FIG. 27A illustrates a perspective view of the destacking system 2102 during step 2700 and FIG. 27B illustrates a profile view of the destacking system 2102 during step 2700.

As shown in FIGS. 27A and 27B, at step 2700, the carrier arms 2304A in the first destacking assembly 2302A rotate inward and are received in a slot formed between the bottom carrier 508 in the first stack 2104A and the carrier 508 that is second from the bottom in the first stack 2104A. Similarly, the carrier arms 2304B in the second destacking assembly 2302B rotate inward and are received in a slot formed between the bottom carrier 508 in the second stack 2104B and the carrier 508 that is second from the bottom in the second stack 2104B. In that regard, at step 2700, the destacking process restarts with one less carrier 508 in each of the first and second stacks 2104A, 2104B. Following step 2700, one or more of the above-described steps can be repeated to continue destacking, or removing carriers 508 from, the first and second stacks 2104A, 2104B until the first and second stacks 2104A, 2104B are depleted of carriers 508.

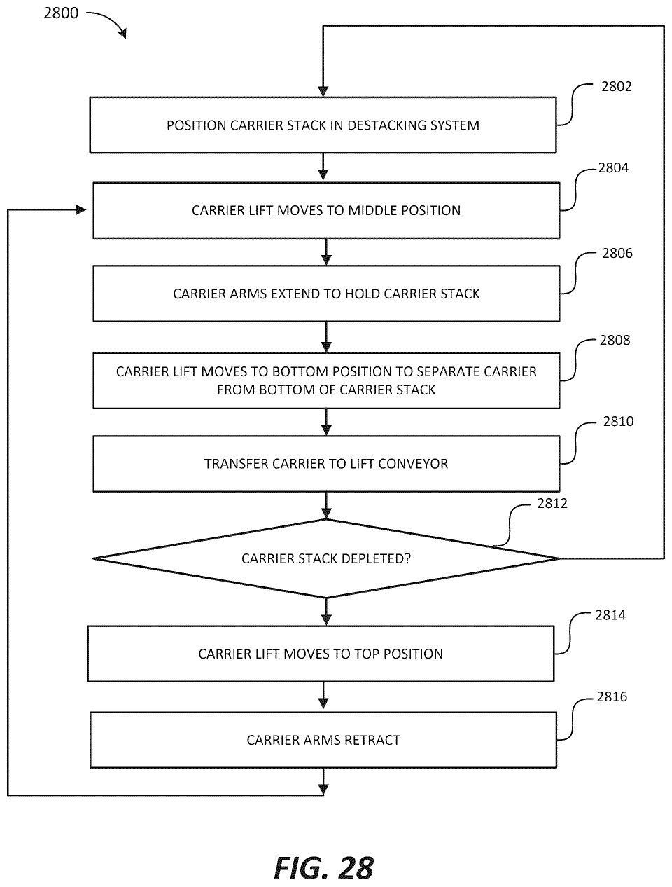

FIG. 28 is a flow diagram of method steps for an example destacking process, according to the present teachings. Although the method steps are described in conjunction with the systems of FIGS. 1-27B, persons skilled in the art will understand that any system configured to perform the method steps, in any order, is within the scope of the present disclosure. For example, although the method of FIG. 28 is described and illustrated as using a destacking system 2102 that includes first and second destacking assemblies 2302A, 2302B, in other examples, a destacking system 2102 that includes fewer or more than two destacking assemblies can be used.

As shown, a method 2800 begins at step 2802, at which a carrier stack is positioned in a carrier destacking system. For example, the controller 204 controls first lane 2106A of carrier infeed conveyor 504 to transfer, or convey, a first stack 2104A to a position in the first destacking assembly 2302A above the carrier stack lift 2308. The first stack 2104A can be, for example, delivered to the first lane 2106A using the elevator 2100.

At step 2804, the carrier lift is moved to a middle position. For example, the controller 204 controls the carrier stack lift 2308 to raise to a middle position, at which the carrier stack lift 2308 engages and supports the first stack 2104A.

At step 2806, carrier arms are extended to hold the carrier stack. For example, the controller 204 controls the carrier arms 2304A to extend, or rotate, into the slot formed between the bottom carrier 508 in the first stack 2104A and the carrier 508 second from the bottom in the first stack 2104A.

At step 2808, the carrier lift is moved to a bottom position to separate the bottom carrier in the carrier stack from the rest of the carrier stack. For example, the controller 204 controls the carrier stack lift 2308 to lower to a bottom position, thereby separating the bottom carrier 508 from the rest of the first stack 2104A being held by the carrier arms 2304A.

At step 2810, the carrier separated from the carrier stack at step 2808 is transferred onto a lift conveyor. For example, the controller 204 controls the first lane 2106A of the carrier infeed conveyor 504 to transfer, or convey, the carrier 508 separated from the first stack 2104A onto the lift conveyor 502 of the inbound system 102. As described herein, the inbound system 102 can then insert a case (e.g., the first case 702A) into the carrier 508.

At step 2812, it is determined whether the carrier stack is depleted. For example, the controller 204 determines whether any carriers 508 remain in the first stack 2104A. If, at step 2812, it is determined that the carrier stack is depleted, the method 2800 returns to step 2802 where a new carrier stack is positioned in the destacking system.

If, at step 2812, it is determined that the carrier stack is not depleted, the method proceeds to step 2814 where the carrier lift is moved to a top position to pick the carrier stack off the carrier arms. For example, the controller 204 controls the carrier stack lift 2308 to raise to a top position and pick up the first stack 2104A off the carrier arms 2304A.

At step 2816, the carrier arms are retracted. For example, the controller 204 controls the carrier arms 2304A to retract.

Following step 2816, the method 2800 returns to step 2804 where the carrier lift is moved to the middle position.

### Vacuum System

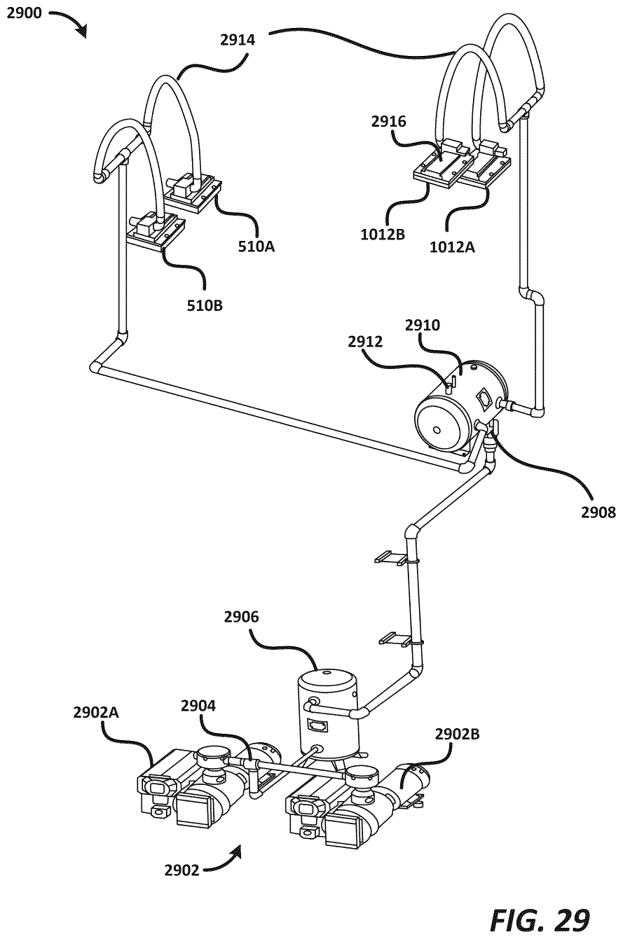

FIG. 29 illustrates an example vacuum system 2900 that can be implemented in conjunction with the CHS 100, according to the present teachings. The vacuum system 2900 can be, for example, implemented as the vacuum system 406 shown in and described with respect to FIG. 4.

As shown in FIG. 29, the vacuum system 2900 includes a central vacuum pump 2902 that is in fluid communication with vacuum pads 510A, 510B included in the inbound system 102 of the CHS 100 and the vacuum pads 1012A, 1012B included in the outbound system of the CHS 100. When the central vacuum pump 2902 is turned ON (e.g., by the controller 204), one or more of the vacuum pads 510A, 510B and/or 1012A, 1012B in fluid communication with the central vacuum pump 2902 can apply a suction, or gripping, force to case (e.g., first case 702A, second case 702B, etc.). For example, the central vacuum pump 2902 can be selectively turned ON and/or OFF by the controller 204 such that one or more vacuum pads 510A, 510B apply suction force to one or more cases during an inbound case-to-carrier process and/or such that one or more vacuum pads 1012A, 1012B apply suction force to one or more cases during an outbound carrier-to-case process.

In some examples, the central vacuum pump 2902 comprises first and second pumps 2902A, 2902B that are joined by a 3-way valve 2904. As shown in the illustrated example of FIG. 29, the vacuum system 2900 includes a 3-way valve 2904 that forms a pump junction between first and second pumps 2902A, 2902B included in the central vacuum pump 2902. With the dual pump configuration shown in FIG. 29, the central vacuum pump 2902 has two workable positions that can be toggled between using the 3-way valve 2904. In the first workable position, the first pump 2902A is connected to the vacuum pads 510A, 510B and/or the vacuum pads 1012A, 1012B. In the second workable position, the second pump 2902B is connected to the vacuum pads 510A, 510B and/or the vacuum pads 1012A, 1012B. In some examples, the position of the 3-way valve 2904 for the pump junction can be adjusted automatically by the controller 204. In other examples, the position of the 3-way valve 2904 can be adjusted manually.

In some examples, the central vacuum pump 2902 includes first and second vacuum pumps 2902A, 2902B for redundancy purposes. In such examples, each of the first and second vacuum pumps 2902A, 2902B is capable of independently supporting, or operating, the vacuum system 2900.

As further shown in FIG. 29, the vacuum system 2900 includes a vertical compressed air storage tank 2906. Both of the first and second pumps 2902A, 2902B can be plumbed directly to the vertical compressed air storage tank 2906. The vertical compressed air storage tank 2906 is adapted to accumulate vacated volume within the tank 2906, thereby providing a buffer of vacuum such that the vacuum system 2900 is not starved. The vertical compressed air storage tank 2906 may also be referred to as the central air storage tank 2096. Moreover, although the central air storage tank 2906 is shown in an upright, or vertical, position, the central air storage tank 2096 can also be arranged in a different orientation.

The vacuum system 2900 further includes a ball valve 2908 that comprises a lockable handle. The ball valve 2908 can be used to disconnect and/or connect the vacuum plumbing of the CHS 100 from the central vacuum pump 2902. For example, the ball valve 2908 can be used to connect and/or disconnect the horizontal compressed air storage tank 2910 from the central vacuum pump 2902, the vertical compressed air storage tank 2906, and/or the other vacuum connections in the CHS 100.

As further shown in FIG. 29, the vacuum pads 510A, 510B and 1012A, 1012B are connected to a horizontal compressed air storage tank 2910. Similar to the vertical compressed air storage 2906, the horizontal compressed air storage tank 2910 serves as a buffer to the vacuum pads 510A, 510B and 1012A, 1012B. Moreover, the horizontal tank 2910 serves as a connection point for the vacuum plumbing and vacuum pads 510A, 510B and 1012A, 1012B to the central vacuum pump 2902 and/or the vertical compressed air storage tank 2906. For example, as described above, a ball valve 2908 that comprises a lockable handle can be used to open and/or close the vacuum plumbing connection between the horizontal compressed air storage tank 2910 and the central vacuum pump 2902 and/or the vertical compressed air storage tank 2906. This setup allows the CHS 100 plumbing to be disconnected from the main system feed for lock out tag out. Moreover, this setup will allow safe maintenance access to the CHS 100 once the vacuum has been released to atmosphere.

The horizontal compressed air storage tank 2910 may also be referred to as the local air storage tank 2910. Moreover, although the local air storage tank 2910 is shown in a horizontal position, the local air storage tank 2910 can also be arranged in a different orientation.

The local storage tank 2910 is configured with a local storage tank ball valve 2912. Once the ball valve 2908 before the local tank 2910 is shut off, this valve 2912 that mounts directly onto the tank 2910 can be used to release the vacuum to atmosphere, creating a safe maintenance environment within the CHS 100.

The vacuum system 2900 further comprises a plurality of flexible vacuum hoses 2914 that mount directly to the vacuum pads 510A, 510B and 1012A, 1012B. The hoses 2914 are flexible to accommodate movement of the vacuum pads 510A, 510B and 1012A, 1012B during one or more of the process described herein. A flexible vacuum hose 2914 can, for example, tie galvanized hard vacuum plumbing pipes to the vacuum pads 510A, 510B and 1012A, 1012B.

Each vacuum pad 510A, 510B and 1012A, 1012B can be toggled, or turned, ON and OFF via a respective KRV valve 2916. A KRV valve 2916 is a pneumatically actuated valve that mounts directly to a vacuum pad. When the KRV valve 2916 is shut, the seal is broken between the vacuum pad and product case by venting to atmosphere.

In some examples, each vacuum pad 510A, 510B and 1012A, 1012B comprises a foam gripper pad that utilizes vacuum (e.g., supplied by the central vacuum pump 2900, the central air tank 2906, and/or the local tank 2908) to grip the top face of product cases to hold the product cases in position with the assistance of lateral grippers (e.g., clamps 512A, 512B and 1014A, 1014B). Check valves within the vacuum pads 510A, 510B and 1012A, 1012B can close off any perforations formed therein.

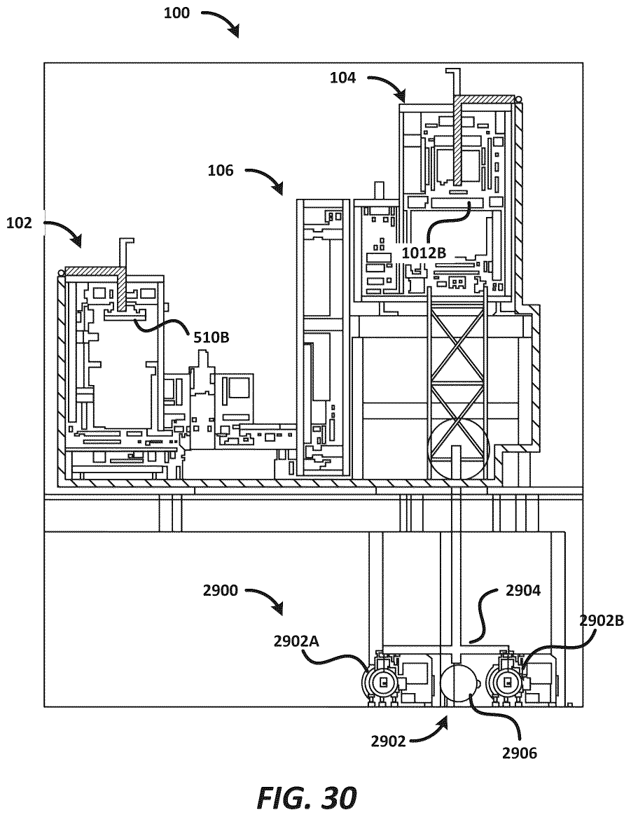

FIG. 30 illustrates a profile view in which the vacuum system 2900 is implemented in conjunction with the CHS 100, according to the present teachings.

In the illustrated examples of FIGS. 29 and 30, the vacuum system 2900 is implemented in conjunction with a single CHS 100. For example, the central vacuum pump 2902 is in fluid communication with vacuum pads 510A, 510B and 1012A, 1012B included in a single CHS 100. However, in other examples, the vacuum system 2900 can be expanded to be implemented in conjunction with more than one (e.g., 2, 3, 4, etc.) CHS 100.

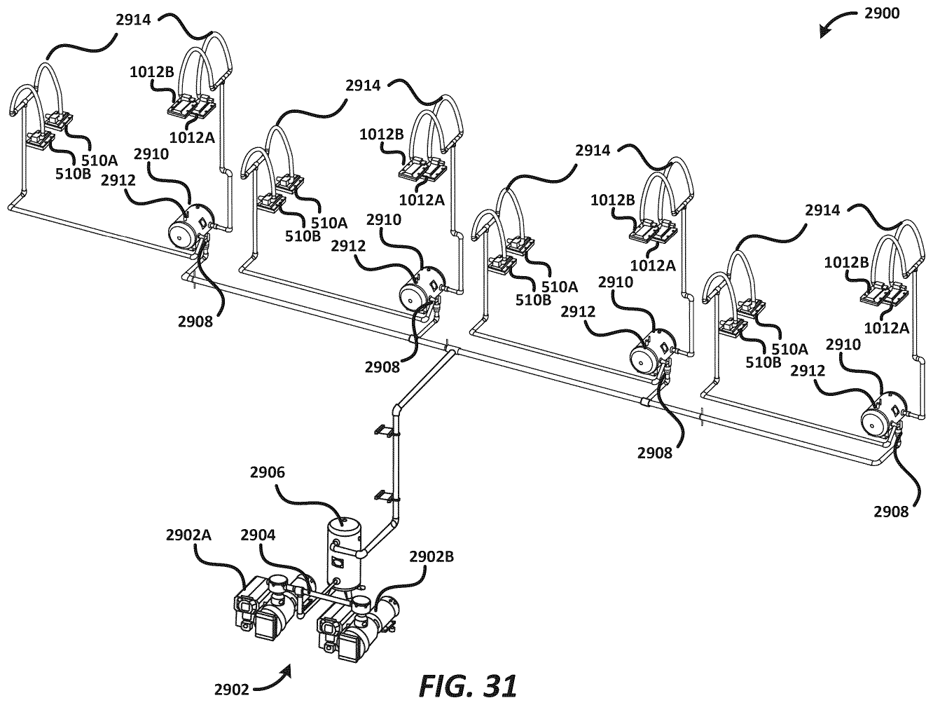

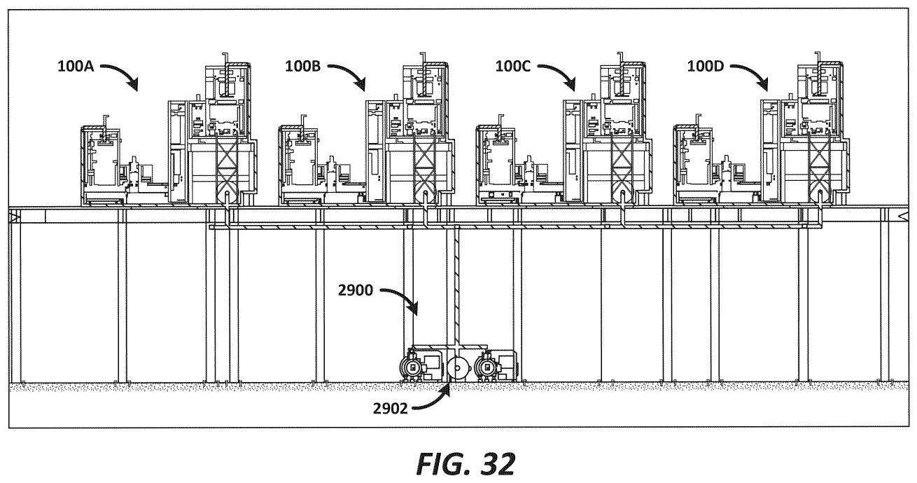

FIG. 31 illustrates an example in which the vacuum system 2900 is expanded to operate in conjunction with four CHS 100A-100D, according to the present teachings. In the illustrated example of FIG. 31, the vacuum system 2900 is in fluid communication with sixteen vacuum pads in total (e.g., four vacuum pads 510A, 510B and 1012A, 1012B in each CHS 100A-100D). Thus, in the illustrated example of FIG. 31, one central vacuum pump 2902 can drive the vacuum pads in four different CHS 100. FIG. 32 illustrates a profile view in which the vacuum system 2900 is expanded to operate in conjunction with four CHS 100A-100D, according to the present teachings.

Although certain aspects have been described with reference to certain examples, variations and modifications exist within the spirit and scope of one or more independent aspects. Various features and aspects are set forth in the following claims.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
receiving a first load disposed in a first carrier at a first position on a first conveyor;
receiving a second load disposed in a second carrier at a second position on the first conveyor;
receiving, from a sensor, sensor data indicative of a humidity level near the second position;
determining, based on the sensor data, that a leak associated with the second load has occurred;
responsive in part to determining that the leak has occurred, transferring the first load disposed in the first carrier to a staging area; and
transporting, via a second conveyor, the second load away from the first conveyor while the second load remains disposed in the second carrier.

2. The method of claim 1, wherein the first position is in front of the second position on the first conveyor.

3. The method of claim 1, wherein the first conveyor is positioned at a first height and the staging area is positioned at a second height.

4. The method of claim 3, wherein transferring the first load disposed in the first carrier to the staging area includes:
raising the first conveyor from the first height to the second height; and
transferring, via the first conveyor, the first load disposed in the first carrier onto the staging area.

5. The method of claim 4, wherein the second conveyor is positioned at the first height; and
wherein the method further includes lowering the first conveyor to the first height prior to transporting the second load away from the first conveyor.

6. The method of claim 5, further comprising:
after transporting the second load away from the first conveyor, raising the first conveyor to the second height; and
transferring the first load disposed in the first carrier from the staging area onto the first conveyor.

7. The method of claim 1, wherein determining that the leak has occurred includes determining that the humidity level near the second position exceeds a threshold.

8. The method of claim 1, further comprising:
receiving, from a second sensor, second sensor data indicative of a second humidity level near the first position;
determining, based on the second sensor data, that there is no leak associated with the first load; and
responsive in part to determining that there is no leak associated with the first load, removing the first load from the first carrier.

9. The method of claim 8, further comprising transporting, via the second conveyor, the first load away from the first conveyor.

10. A system, comprising:
a first conveyor;
a sensor disposed proximate the first conveyor and adapted to generate sensor data;
a staging area;
a second conveyor; and
a controller in electronic communication with the first conveyor, the sensor, and the second conveyor, the controller adapted to control operation of the system to:
move, via the first conveyor, a first load disposed in a first carrier to a first position on the first conveyor;
move, via the first conveyor, a second load disposed in a second carrier to a second position on the first conveyor;
receive, from the sensor, sensor data;
determine, based on the sensor data, that a leak associated with the second load has occurred;
responsive in part to determining that the leak has occurred, transfer, via the first conveyor, the first load disposed in the first carrier to a staging area; and
transport, via a second conveyor, the second load away from the first conveyor while the second load remains disposed in the second carrier.

11. The system of claim 10, wherein the first position is in front of the second position on the first conveyor.

12. The system of claim 10, wherein to transfer the first load disposed in the first carrier to the staging area, the controller is adapted to:
raise, using a motor, the first conveyor to a height of the staging area; and
transfer, via the first conveyor, the first load disposed in the first carrier onto the staging area.

13. The system of claim 12, wherein the controller is further adapted to lower, using the motor, the first conveyor to a second height of the second conveyor prior to transporting the second load away from the first conveyor.

14. The system of claim 13, wherein the staging area includes a buffer conveyor.

15. The system of claim 14, wherein the controller is further adapted to:
raise, using the motor, the first conveyor to the height of the staging area after transporting the second load away from the first conveyor; and
transfer, via the buffer conveyor, the first load disposed in the first carrier from the staging area onto the first conveyor.

16. The system of claim 10, further comprising an indicator in electronic communication with the controller;
wherein the controller is adapted to activate the indicator responsive to determining that the leak has occurred.

17. The system of claim 10, wherein the sensor is a humidity sensor.

18. A controller including a non-transitory computer readable medium and a processor, the controller including computer executable instructions stored in the computer readable medium for controlling operation of a system to:
move, via a first conveyor, a first load disposed in a first carrier to a first position on the first conveyor;
move, via the first conveyor, a second load disposed in a second carrier to a second position on the first conveyor;
receive, from a sensor, sensor data indicative of a humidity level near the second position;
determine, based on the sensor data, that a leak associated with the second load has occurred;
responsive in part to determining that the leak has occurred, transfer, via the first conveyor, the first load disposed in the first carrier to a staging area; and
transport, via a second conveyor, the second load away from the first conveyor while the second load remains disposed in the second carrier.

19. The controller of claim 18, wherein the controller includes a programmable logic controller.

20. The controller of claim 18, wherein the controller includes a server adapted to execute a warehouse execution system (WES) software engine.
